(19) United States
(12) Patent Application Publication
(10) Pub. No.: US 2021/0192668 A1
(43) Pub. Date: Jun. 24, 2021

(54) SYSTEM AND METHOD FOR CONDUCTING FANTASY SPORTS CONTESTS

(71) Applicant: Two Nine Sports Inc., Middletown, DE (US)

(72) Inventor: Jason Jaramillo, Scottsdale, AZ (US)

(73) Assignee: Two Nine Sports Inc., Middletown, DE (US)

(21) Appl. No.: 17/183,304

(22) Filed: Feb. 23, 2021

Related U.S. Application Data
(63) Continuation-in-part of application No. 16/900,801, filed on Jun. 12, 2020.
(60) Provisional application No. 62/860,636, filed on Jun. 12, 2019.

(51) Int. Cl. G06Q 50/34; G07F 17/32

(52) U.S. Cl. CPC G06Q 50/34; G07F 17/3276; G07F 17/3288; G07F 17/3244

(57) ABSTRACT

A non-transitory computer-readable medium comprising a computer software implemented system and method for operating a fantasy contest application and platform designed to enable contestants to enter fantasy contests against the house. A single contestant enters a solo, head-to-head contest against the house operated by the fantasy contest platform, and a winner is determined based on comparison of a contestant lineup fantasy scores to a house lineup fantasy scores, based on performance metrics of real-world competitors and competitions (e.g., football, chess, NASCAR). The house typically provides between three to ten different fantasy contest lineups, of between three to ten competitors depending on the type of competition or sport, at any time for selection by contestants. Contestants select competitors for contestant lineups based on a salary cap. Further the computer software is executed on a computer, including a user interface, in conjunction with processors, memory, bus elements and a network connection.

### CROSS REFERENCE TO RELATED U.S. PATENT APPLICATIONS

This application is a continuation-in-part of and claims the benefit under 35 U.S.C. § 120 of the earlier filing date of U.S. Nonprovisional application Ser. No. 16/900,801, filed on Jun. 12, 2020, which is hereby incorporated in entirety by reference.

### BACKGROUND

### 1. Field of the Invention

The present invention relates to fantasy sports and, in particular, to methods, systems, and software for managing fantasy sports contests, especially for providing to contestants unique capabilities for selecting real-world event competitors to build user fantasy sports contest rosters and unique fantasy contestant/user prize money payout structures for single- and multi-round competitive gameplay.

### 2. Description of Related Art

Fantasy sports contests and other fantasy contest events generate many billions of dollars annually. Casinos and online betting platforms, for example, are important attractions and destinations to prospective bettors. These betting arenas display the bets that a prospective bettor may make on various types of sporting events, competitions or other events. Bets are placed on most major sports including without limitation professional and college football, soccer, baseball, basketball, ice hockey, auto and horse racing, as well as cricket and rugby.

Further, fantasy contests are based on various sports tournaments, including without limitation the NCAA Men's and Women's Basketball Championships and World Cup Soccer. Also, fantasy contests may be based on other types of events including a selection of the winner of a reality television show (e.g., the Survivor reality show), election results (e.g., winner of the next United States Presidential election), weather events, when the first person lands on Mars, or any other type of event.

In general, gambling is the wagering, or betting, of money or something of material value on an event with an uncertain outcome with the primary intent of winning prize money and/or material goods. Typically, the outcome of the wager, or bet, is evident within a short period. The term “gaming” in this context typically refers to instances in which the activity has been specifically permitted by law. The two words are not mutually exclusive; i.e., a “gaming” company offers (legal) “gambling” activities to the public. This distinction is not universally observed in the English-speaking world, however.

For instance, in the UK, the regulator of gambling activities is called the Gambling Commission (not the Gaming Commission). Also, the word gaming is frequently used to describe activities that do not involve wagering, especially online. While almost any game can be played for money, and any game typically played for money can also be played just for fun, some games are generally offered in a casino setting. Gaming can also be accomplished for non-monetary prizes, such as credits, coupons or points, whether redeemable for money, merchandise or discounts and other promotional or recreational purposes.

Fixed odds betting and parimutuel betting frequently occur at many types of sporting events, and competitions of all sorts, including political elections. In addition, many bookmakers offer fixed odds on any number of non-sports related outcomes. For example, the direction and extent of movement of various financial indices, the winner of television competitions such as Big Brother, and election results are frequently the subject of wagers and bets.

Wagering may take place through parimutuel pools, non-parimutuel betting arrangements, or bookmakers may take bets personally. Parimutuel wagers, for example, pay off at prices determined by support in the wagering pools, while bookmakers pay off either at the odds offered at the time of accepting the bet; or at the median odds offered by track bookmakers at the time the race started.

Parimutuel betting (from the French language, Pari Mutuel or mutual betting) is a betting system in which all bets of a particular type are placed together in a pool, taxes and a house “take” or “vig” are removed by the gaming sponsor or organizer, and payoff odds are calculated by sharing the pool among all winning bets. In some countries, it is known as the Tote after the totalisator, which calculates and displays bets already made.

Parimutuel and/or non-parimutuel betting systems are utilized in gambling events, such as horse racing, greyhound racing, jai alai, etc., and most sporting events or competitions in which competitors finish in a ranked order. Betting on team sports has become an important service industry in many countries. For example, millions of Britons play the football pools every week.

In addition to organized sports betting, both legal and illegal, there are many side-betting games played by casual groups of spectators, such as NCAA Basketball Tournament Bracket Pools, Super Bowl Squares, Fantasy Sports Leagues with monetary entry fees and winnings, and in-person spectator games like Caber Tossing. One can also bet with another person as to whether a statement is true or false, or that a specified event will happen (a “back bet”) or will not happen (a “lay bet”) within a specified time.

Fantasy sports contests provide users or contest participants the ability to play in daily, weekly, quarterly, season-long and playoff fantasy leagues across various sports, including National Football League (NFL), Major League Baseball (MLB), National Basketball Association (NBA), the National Hockey League (NHL), NASCAR and the Pro Golf Tour. Generally, a fantasy sports league (hereafter, “fantasy league”) is established in connection with a particular real-world professional sports league (e.g., in the U.S., National Football League, Major League Baseball, Major League Soccer), and contestants in the fantasy league act as owners/managers of a fantasy sports team (hereafter, a “fantasy team”) that they create and manage within the fantasy league.

Each fantasy team is composed of real-world players, which are selected by the fantasy team owner from the real-world professional sports league (e.g., NFL, MLB, NBA, NHL, and the like), often regardless of their real-world team affiliations. Once a user or contest participant has selected a league, they select the real-world players (e.g., for NFL football, you may select one quarterback, one running back, two wide receivers, one tight end, and one kicker) from the available players in the selected league to be on the contestant's fantasy team.

Usually, the fantasy league season lasts for the length of the regular season of the real-world professional sports league to which it is associated. During the fantasy league season, the performance of the fantasy team is determined by the real-world performance (e.g., statistical performance, points scored, etc.) of the real-world players on the fantasy team.

Since real-world performance of an individual real-world player corresponds to player activity during real-world sports matches, during the fantasy league season, fantasy team owners actively manage their respective fantasy team rosters to maximize the performance their respective fantasy teams derive from the real-world sports matches that occur during the real-world regular sports season. At the end of the fantasy league season, the fantasy teams may be ranked (e.g., based on their respective overall performances) and one or more fantasy team owners may be declared winners of the league.

Unfortunately, traditionally formatted fantasy sports leagues provide little or no opportunity for alternative, more frequent fantasy gaming or contest opportunities, more attractive payout structures. Accordingly, there is a need in the present art for alternative fantasy contest structures and roster selections, as well as novel payout structures, to encourage more widespread participation in fantasy sports contests.

### BRIEF SUMMARY

The following summary of the present invention is presented to provide a basic understanding of some aspects of the invention and to facilitate an understanding of some of the innovative features unique to the disclosed embodiment, and it is not intended to be a full description. This summary is not intended to identify all key or critical elements of the invention or to delineate the entire scope of the invention. Its sole purpose is to present some concepts of the invention in a simplified form as a prelude to the more detailed description presented below. A full appreciation of the various aspects of the embodiments disclosed herein can be gained by taking the entire specification, claims, drawings, and abstract as a whole.

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

It is, therefore, one aspect of the disclosed embodiments to provide systems and methods that allow users of remote/network communications and display devices to compete on the outcomes of various sporting events, competitions and other events or outcomes occurring during those events, such as player performance metrics, using bi-directional communications platform on the remote devices to communicate with a server over a data communications network.

It is another aspect of the disclosed embodiments to provide for systems and methods that allow users of remote devices to access fantasy contest platforms with alternative entry fee pot splitting or sharing schemes and other more enticing payout structures.

The aforementioned aspects and other objectives and advantages can now be achieved as described herein. Methods and systems for conducting a fantasy contest within a gaming environment. One or more system users, or fantasy contestants, can be enabled to electronically access a gaming environment over a communication network.

In yet another embodiment, a system for operating a gaming environment can be provided. Such a system can include, for example, at least one processor; and a computer-readable medium, embodying computer program code, the computer-readable medium capable of communicating with the at least one processor, the computer program code comprising instructions executable by the at least one processor and configured for: implementing a pot splitting scheme and additional modified payout structures.

Various embodiments described herein provide systems and methods for fantasy contests relating to sports matches and, in particular, relating to fantasy sports associated with sports matches. The systems and methods described herein can improve the interest and enjoyment of sports fans, and the active participation of fantasy sports enthusiasts.

For some embodiments, the systems and methods described herein can provide a new format for playing fantasy sports for a fantasy sports season. Depending on the embodiment, this new format can take the place of, or be used in conjunction with, traditional forms of playing fantasy sports (e.g., operating a fantasy sports league).

In preferred embodiments, the present invention comprises a computer software implemented system designed to establish and operate a fantasy contest (e.g., fantasy sports) application platform designed to provide to one or a plurality of contestants an ability to participate in single or multi-round fantasy contests.

For embodiments including a plurality of contestants, a further objective of the present invention is to provide to one or more contestants of the plurality of contestants an ability to collectively agree to split a first entry fee pot, upon the remaining number of contestants falling below a set threshold, and to provide to one or more contestants of the plurality of contestants comprising round winners an ability to participate in round-payouts from a second entry fee pot, where the computer software is executed on a plurality of computers, including a user interface, in conjunction with processors, memory, bus elements and a network connection.

The system of the present invention also comprises code establishing a fantasy contest system configured to establish, operate and maintain one or more fantasy contests, where each fantasy contest includes one or a plurality of contestants, one or more contest rounds, each contest and round associated with a plurality of real-world competitors scheduled to compete in a set of real-world competition events, up to one or more contestant round winners per contest round, and up to one or more contestant winners of the entire fantasy contest.

The fantasy contest system of the present invention comprises a contest management module, configured to establish, or create and initialize, the one or more fantasy contests, inclusive of specifying and setting one or more fantasy contest parameters, such as type or category of fantasy contest, number of contestants, number of contest rounds, and amount of contest entry fee, a contestant management module, configured to enter contestants into the fantasy contest and manage contestant profiles, preferences and default settings, and a contestant or user account module, configured to establish, or create and initialize, and associate one of a plurality of contestant user accounts with each contestant of the one or plurality of contestants in a given fantasy contest of the plurality of fantasy contests being managed by the contest management module at any given time, and further configured to manage the plurality of user accounts associated with respective contestants in the plurality of fantasy contests, including maintenance of account balances for all user accounts associated with the plurality of contestants, crediting and deducting amounts from the user account balances based on contest entry fees, entry fee pots, and sets of round winners and/or contest winners determined for the fantasy contests.

The fantasy contest system of the present invention also comprises a contest entry fee module, configured to collect, receive and manage the contest entry fees and contestant selections of and any changes to selections of one or more real-world competitors selected for a fantasy contest team roster in a given fantasy contest by the one or plurality of contestants, and wherein once the set of real-world competition events begins, the competitor selections made by the one or plurality of contestants are locked.

The fantasy contest system may further comprise a contest entry fee pot module, configured to form one or more entry fee pots (e.g., a first entry fee pot and/or a second entry fee pot) for a given fantasy contest. For single contestant embodiments, the fantasy contest is conducted head-to-head against the house, and contests may be based on selection of team-independent fantasy sports player/competitor rosters (i.e., selecting players from multiple teams) or on selection of team-based fantasy sports player/competitor rosters (i.e., creating a lineup from a specific team's players). In such single contestant embodiments, the fantasy contest system may provide several fantasy competitor/sports player rosters fielded by the house, as options for the contestants to select the house roster against which the contest believes they have the best chance of winning.

For embodiments having a plurality of contestants and more than one entry fee pot, the contest entry fee module may further comprise at least first and second entry fee pots, wherein the first and second entry fee pots comprise respective portions of the total entry fees for the plurality of contestants, less some percent retained by the house, and wherein the second entry fee pot is further divided among the rounds of the fantasy contest, and then further subdivided among the round winners.

The fantasy contest system of the present invention further comprises a sports player performance module, configured to obtain a set of performance metrics results for the plurality of selected competitors from two or more independent sources of competitor performance metrics information, and a contest outcome module, configured to identify sets of one or more round winners and one or more contest winners upon conclusion of a respective round or contest, by reviewing and comparing sets of performance metrics results provided by the sports player performance module, and to determine one or more sets of contestant winners based on the contestant winners having a fantasy score higher than the house fantasy score for the given round or contest. Additionally, though various embodiments described herein are done so with respect to fantasy contests (e.g., fantasy sports contests), it will be understood that various embodiments need not be associated with real-world gambling. Indeed, various embodiments described herein can be readily utilized in conducting the fantasy contest between one or more contestants and the house without any need to pay an entry fees to enter the fantasy contest.

Some embodiments provide for a method that performs various steps and operations, described herein, or provide for a computer program product comprising a computer readable medium having computer program code (i.e., executable instructions) executable by a digital processor to perform various steps and operations described herein.

These and other aspects of the present invention are realized in an improved system and method designed to facilitate management of fantasy sports game and league play, as shown and described in the following figures and related description.

Additional features and advantages of the invention will be set forth in the detailed description which follows, which, taken in conjunction with the accompanying drawings, by way of example, together illustrate the features of the present invention, which will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention. The figures are provided for purposes of illustration only and merely depict typical or example embodiments. These drawings are provided to facilitate the reader's understanding and shall not be considered limiting of the breadth, scope, or applicability various embodiments.

Non-limiting and non-exhaustive features will be described with reference to the following figures, wherein like reference numerals within the detailed description refer to like parts throughout the various figures. The figures described below were not intended to be drawn to any precise scale with respect to size, angular relationship, or relative position. Various embodiments of the present invention are shown and described in reference to the numbered drawings wherein:

FIG. 1A illustrates a high-level block diagram of an exemplary terminal or client device, comprising a digital data processing and network communications device.

FIG. 1B illustrates an exemplary environment for operations and devices, which may include a digital data processing and network communications device, a data communications network and one or more servers.

FIG. 2A illustrates another exemplary embodiment of a network system that includes a fantasy contest system, a network, a fantasy sports system, and client devices.

FIG. 2B illustrates an exemplary fantasy contest system comprising a contest management module, a contest participant management module, a user account module, a contest entry fee module, a contest entry fee pot module, a sports player performance module, and a contest outcomes module.

FIG. 3 illustrates another exemplary digital data processing and network communications device, i.e., the client device, which may comprise a processor, a memory system, a storage system, a communication network interface, an I/O interface, and a display interface communicatively coupled to a bus.

FIG. 4A illustrates a flow diagram of an exemplary head-to-head fantasy contest method.

FIG. 4 B illustrates a flow diagram of an exemplary survivor pool fantasy contest method.

FIG. 5A illustrates a process flow diagram for a method applicable to both head-to-head and survivor pool embodiments that enables a user to sign up and log on to the fantasy contest platform, add funds, select contests and place and track fantasy contest entries.

FIG. 5B illustrates a survivor pool embodiment continuation of the process flow diagram of FIG. 5A, providing an option to “split the pot” when the number of remaining contestants has fallen below a set threshold.

FIG. 6A illustrates an exemplary process flow diagram for a head-to-head contest method enabling user registration, logon, profile management, contest selection, and placing and tracking of contest entries in a fantasy contest.

FIG. 6B illustrates an exemplary process flow diagram for a survivor pool contest method enabling user registration, logon, profile management, contest selection, and placing and tracking of contest entries in a fantasy contest.

FIG. 7A illustrates a second exemplary process flow diagram for a head-to-head contest method enabling user registration, logon, profile management, contest selection, and placing and tracking of entries in a fantasy contest.

FIG. 7B illustrates a second exemplary process flow diagram for a survivor pool contest method enabling user registration, logon, profile management, contest selection, and placing and tracking of entries in a fantasy contest.

FIG. 8 illustrates an exemplary submodule implementing contestant selection of contest types and competitor lineups for football.

FIG. 9 illustrates an exemplary submodule implementing contestant selection of contest types and competitor lineups for baseball, hockey, lacrosse, soccer, and basketball.

FIG. 10 illustrates an exemplary submodule implementing contestant selection of contest types and competitor lineups for golf and NASCAR.

FIG. 11 illustrates a table portraying the payout structure for an exemplary fantasy contest based on a baseball fantasy sports format. In this figure, contestants are referred to as players.

FIG. 12 illustrates a table portraying the payout structure for an exemplary fantasy contest based on a basketball fantasy sports format. In this figure, contestants are referred to as players.

FIG. 13 illustrates a table portraying the payout structure for an exemplary fantasy contest based on a golf fantasy sports format. In this figure, contestants are referred to as players.

FIG. 14 illustrates a table portraying the payout structure for an exemplary fantasy contest based on a based on a football fantasy sports format. In this figure, contestants are referred to as players.

FIG. 15 illustrates a screenshot depicting the ability to choose between various sports or types of real-world competitions. Highlighting may be used to depict the contestant selection.

FIG. 16 illustrates a screenshot depicting various house lineup selections offered for contests for a chosen sport, in this case football, and specifically the Superbowl. As shown, the contestant may select to “face this lineup”.

FIG. 17 illustrates a screenshot depicting contestant required competitor selections, in this case for playoff finals play including one MVP and five flex players.

FIG. 18 illustrates a screenshot depicting selections made based on a salary cap limit.

FIG. 19 illustrates a screenshot depicting a competitor selection confirmation function, after which the contestant selected lineup may be locked until the contest is conducted.

FIG. 20 illustrates a screenshot depicting the selection of a contest Prize and Entry Fee amounts.

FIG. 21 illustrates a screenshot depicting a prize and entry fee amount confirmation function, after which the prize and entry fee amounts are fixed and the user is entered into the fantasy contest as a contestant.

FIG. 22 illustrates a screenshot depicting a confirmation function verifying successful entry of the contestant into the contest.

FIG. 23 illustrates a screenshot depicting various house lineup selections offered for contests for a chosen sport, in this case basketball, specifically during regular season play. As shown, the contestant may select to “face this lineup”.

FIG. 24 illustrates a screenshot depicting contestant required competitor selections, in this case for including one MVP, a Center, a Guard, a Forward, and two (2) flex players.

FIG. 25 illustrates a screenshot depicting selections made based on a salary cap limit. Note that the house lineups may be indicated by a short suggestive name, in this case “Double Technical”.

FIG. 26 illustrates a screenshot depicting a competitor selection confirmation function, after which the contestant selected lineup may be locked until the contest is conducted.

FIG. 27 illustrates a screenshot depicting the selection of a contest Prize and Entry Fee amounts.

FIG. 28 illustrates a screenshot depicting a prize and entry fee amount confirmation function, after which the prize and entry fee amounts are fixed and the user is entered into the fantasy contest as a contestant.

FIG. 29 illustrates a screenshot depicting a confirmation function verifying successful entry of the contestant into the contest.

FIG. 30 illustrates a screenshot depicting various house lineup selections offered for contests for a chosen sport, in this case hockey, specifically during regular season play. As shown, the contestant may select to “face this lineup”.

FIG. 31 illustrates a screenshot depicting contestant required competitor selections, in this case for including one MVP, a Goalie, a Winger, a Center, a Defenseman and one (1) flex player.

FIG. 32 illustrates a screenshot depicting selections made based on a salary cap limit. Note that the house lineups may be indicated by a short suggestive name, in this case “Double Technical”.

FIG. 33 illustrates a screenshot depicting a competitor selection confirmation function, after which the contestant selected lineup may be locked until the contest is conducted.

FIG. 34 illustrates a screenshot depicting the selection of a contest Prize and Entry Fee amounts.

FIG. 35 illustrates a screenshot depicting a prize and entry fee amount confirmation function, after which the prize and entry fee amounts are fixed and the user is entered into the fantasy contest as a contestant.

FIG. 36 illustrates a screenshot depicting a navigation page enabling the user to select the ability to view one or more active contests in which they are contestants.

FIG. 37 illustrates a screenshot depicting a navigation page enabling the user to select from among active and previously concluded contests in which they are or were contestants to view the performance statistics associated with each contest.

FIG. 38A-38C illustrate screenshots depicting a scoreboard showing detailed performance statistics associated with an active contest and with each real-world competitor associated with the contest. In this case the contest is not yet underway, so no scores are shown.

FIG. 39 illustrates a screenshot depicting a scoring preview for an upcoming contest.

FIG. 40 illustrates a screenshot depicting a scoreboard for a contest that has been completed.

FIG. 41 illustrates a screenshot depicting a scoring preview for a contest that has been completed.

FIG. 42 illustrates an exemplary home screen or navigation page enabling the contestant to select from among different sports for the fantasy contest.

FIG. 43 illustrates an exemplary navigation screen enabling the contestant to select a contest type.

FIG. 44 illustrates an exemplary navigation screen enabling the contestant to select a specific contest.

FIG. 45 illustrates an exemplary navigation screen enabling the contestant to select a specific team.

FIG. 46 illustrates an exemplary fantasy sports team roster navigation screen enabling the contestant to build and submit a fantasy team roster for the fantasy contest.

FIG. 47 illustrates an exemplary sports player selection navigation screen enabling the contestant to select specific players from the roster of a sports team or other list of sports players.

FIG. 48 illustrates a first player selection as shown on the fantasy sports team roster navigation screen.

FIG. 49 illustrates an exemplary updated sports player selection navigation screen depicting an updated list of sports players that does not include the sports player(s) already selected. From this screen the contestant is enabled to select additional sports players for the fantasy sports team roster.

FIG. 50 illustrates an updated fantasy sports team player roster selection as shown on the fantasy sports team roster navigation screen.

FIG. 51 illustrates a further exemplary updated sports player selection navigation screen depicting an updated list of sports players that does not include the sports player(s) already selected. From this screen the contestant is enabled to select additional sports players for the fantasy sports team roster.

FIG. 52 illustrates a further updated fantasy sports team player roster selection as shown on the fantasy sports team roster navigation screen.

FIG. 53 illustrates screenshot depicting a contestant lineup submission confirmation screen.

FIG. 54 illustrates a screenshot depicting an entry fee submission screen.

FIG. 55 illustrates an exemplary user contests navigation screen enabling the contestant to view the various contests in which they are participating or in which they have participated.

FIG. 56 illustrates an exemplary contest status navigation screen enabling the contestant to view the status of a specific contest.

It will be appreciated that the figures are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. The figures are not intended to be exhaustive or to limit the embodiments to the precise form disclosed. It should be understood that various embodiments may be practiced with modification and alteration.

### DETAILED DESCRIPTION

The present invention is of a method, system, and computer software embodied on non-transitory computer-readable media for engaging in fantasy contests (e.g., fantasy sports). Various embodiments described herein provide systems and methods for establishing and managing a fantasy contest and, in particular, conducting fantasy contests in association with a plurality of real-world competitors (e.g., sports teams and players) scheduled to participate in real-world competitions (e.g., sports matches, such as exhibition games, regular season games, championships, and the like).

In particular embodiments, systems and methods manage or otherwise facilitate a fantasy contest, for one or more contest participants, where the fantasy contest is associated with and based on one or more real-world competitions (e.g., sports matches). The particular values and configurations discussed in these non-limiting examples can be varied and are cited merely to illustrate at least one embodiment and are not intended to limit the scope thereof. The embodiments will now be described more fully hereinafter with reference to the accompanying drawings, in which illustrative embodiments of the invention are shown.

The various embodiments of the invention will now be described more fully hereinafter with reference to the accompanying drawings, in which illustrative embodiments of the invention are shown so as to enable one skilled in the art to practice the present invention. These, and other, aspects and objects of the present invention will be better appreciated and understood when considered in conjunction with the following description and the accompanying drawings.

It should be understood, however, that the following description, while indicating preferred embodiments of the present invention and numerous specific details thereof, is given by way of illustration and not of limitation. The drawings and following description are exemplary of various aspects of the invention and are not intended to narrow the scope of the appended claims. Many changes and modifications may be made within the scope of the present invention without departing from the spirit thereof and the invention includes all such modifications.

The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Throughout the entirety of the present disclosure, use of the articles “a” or “an” to modify a noun may be understood to be used for convenience and to include one, or more than one of the modified noun, unless otherwise specifically stated.

As used herein, the term “set” may refer to any collection of elements, whether finite or infinite. The term subset may refer to any collection of elements, wherein the elements are taken from a parent set; a subset may be the entire parent set. The term proper subset refers to a subset containing fewer elements than the parent set.

As used herein, the terms “contestant”, “user”, “contest participant” and “participant” are used interchangeably and should be interpreted to have a common meaning, indicating a user of the fantasy contest platform services. Further, as used herein, the terms “sports player” and “competitor” are used interchangeable to indicate a competitor in a competition or other event, regardless of whether the event is a competitive sports event or other type of competition. Furthermore, as used herein, the terms “fantasy contest” and “contest” are used interchangeably to refer to fantasy contests between users or contestants and the fantasy contest platform house and should be interpreted to have a common meaning.

As utilized herein the term “module” generally refers to a collection of routines (and/or subroutines) and/or data structures that performs a particular task or implements a particular abstract data type. Modules usually include at least two parts: an interface, which lists the constants, data types, variables, and routines that can be accessed by other modules or routines; and an implementation, which is typically, but not always, private (accessible only to the module) and which contains the source code that actually implements the routines in the module. The term “module” may also refer to a self-contained component that can provide a complete function to a system and can be interchanged with other modules that perform similar functions.

Additionally, it will be appreciated that a “module” may comprise software, hardware, firmware, and/or circuitry. In one example one or more software programs comprising instructions capable of being executed by a processor may perform one or more of the functions of the modules described herein. In another example, circuitry may perform the same or similar functions.

Alternative embodiments may comprise more, less, or functionally equivalent modules and still be within the scope of present embodiments. For example, the functions of the various modules may be combined or divided differently. Various embodiments are described herein as examples. It will be apparent to those skilled in the art that various modifications may be made and other embodiments can be used.

As will be appreciated by one skilled in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.”

Furthermore, the present invention may take the form of a computer program product on a non-transitory computer-readable storage medium having computer-readable program code embodied in the medium. Any suitable computer readable medium may be utilized whether now known or hereafter devised, including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages, such as the “C” programming language or in a visually oriented programming environment, such as, for example, Visual Basic. The program code may execute entirely on the user's computer, as a stand-alone software package, partly on the user's computer and partly on a remote/networked computer or entirely on the remote/networked computer.

In the latter scenario, the remote/networked computer may be connected to a user's computer through a local area network (LAN) or a wide area network (WAN), wireless data network e.g., WiFi, Wimax, 802.xx, and cellular network, or the connection may be made to an external computer via most third party supported networks (for example, through the Internet using an Internet Service Provider).

The invention is described in part below with reference to flowchart illustrations and/or block diagrams of methods, systems, computer program products, and data structures according to embodiments of the invention. It will be understood that each block of the illustrations, and combinations of blocks, can be implemented by computer program instructions comprising computer software configured to implement the system and method of the present invention.

These computer program instructions may be provided to a processor of a general purpose computer, special purpose computer, or other programmable data processing apparatus to produce a machine, such that the instructions, which execute via the processor of the computer or other programmable data processing apparatus create means for implementing the functions/acts/tasks specified in the block or blocks.

These computer program instructions may also be stored in a computer-readable memory that can direct a computer or other programmable data processing apparatus to function in a particular manner, such that the instructions stored in the computer-readable memory produce an article of manufacture, including instruction means which implement the function/act/task specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts/tasks specified in the block or blocks.

Steps of the process, which may be stored as software code instructions within one or more non-transitory computer readable medium and performed by a processor connected thereto, as part of a method executed by one or more computer systems comprising an interlinked computer network, in a variety of different orders of operation, may include registering a user account by one or more contestants, setting up the user account profiles, selecting one or more contests based on type of sport or real world competition by the one or more contestants, establishing and configuring or setting up one or more contest and account triggers, selectings contest type (e.g., type of sport or other competition, as well as contest prize amounts, frequency of contest, number of contest participants, etc.), selecting teams and players, playing user/contestant selections against the house in a fantasy contest, for embodiments that involve multi-round, multi-contestant fantasy contests advancing contestants/users that beat the house to the next round and removing contestants/users that lose to the house from the fantasy contest, determining one or more contestant winners in one or more fantasy contests, signing out or logging out of a user account by a contestant, signing in or logging in to a user account, refreshing, checking and monitoring contestant/user stats, selecting one or more new fantasy contests, selecting new players or teams, and the process continues via any number of permutations for each respective user or contestant.

In some embodiments, the systems and methods of the present invention, i.e., the fantasy contest platform, may include, for example, a processor and a data bus coupled to the processor. Such a system may also include a computer-readable medium embodying computer code, the computer-readable medium being coupled to the data bus, the computer program code comprising computer software instructions executable by the processor.

Such instructions may be configured to, for example, electronically join or enter at least one fantasy contest with respect to at least one sports event or other type of competition, during an associated round of the fantasy contests; and manage and control the at least one fantasy contest entry during the particular round of the fantasy contest. In yet another embodiment, such instructions can be configured for managing and controlling via a microcontroller or other computer processor the at least one entry and entry fee on behalf of a user/contestant with respect to the at least one round of the fantasy contest.

The present invention further provides a method for conducting a fantasy contest via a fantasy contest software application and platform, within an online gaming environment, in accordance with a preferred embodiment. A method or process step or logical operation may be implemented to enable one or more (e.g., a plurality of) contestants to electronically access a gaming environment over a communication network (e.g., the Internet, wireless networks, etc.). The one or more contestants can be registered, to allow them access to the fantasy contest within the gaming environment.

A further step or logical operation can be implemented to determine at the conclusion of the fantasy contest at least one winner (e.g., one or more winners) based on an accumulation of fantasy points and total fantasy score for the one or more contestants during the fantasy contest. Note that in some embodiments, a step or logical operation can be implemented for authorizing at least one user among the one or more contestants to access the gaming environment upon electronic payment of an entry fee by and confirming the identity of the at least one user.

In another embodiment, a system for conducting a fantasy contest within a gaming environment can be implemented. Such a system can include, for example, at least one processor; and a computer-readable medium embodying computer program code, the computer-readable medium capable of communicating with the at least one processor, the computer program code comprising instructions executable by the at least one processor and configured for: enabling one or more contestants to electronically access a gaming environment over a communication network; registering the one or more contestants to allow access to a fantasy contest within the gaming environment; enabling each user among the one or more contestants to compete against the house by selecting from a set of at least two events displayed in the gaming environment one or more event outcomes; wherein a selection of at least two outcomes in the at least two events may require an entry fee of some fixed amount of money, points or credits, wherein each selection of an outcome increases a contestant's balance if the outcome occurs or decreases the contestant's balance if the outcome selected does not occur; and determining at a conclusion of the fantasy contest at least one winner based on a fantasy score derived from accumulation of fantasy points by the selected sports players by the fantasy contestant(s).

In yet another embodiment, a computer-implemented system for operating a gaming environment can be provided. Such a system can include, for example, at least one processor; and a computer-readable medium embodying computer program code, the computer-readable medium capable of communicating with the at least one processor, the computer program code comprising computer software instructions executable by the at least one processor and configured for: accessing a gaming environment by at least one contestant, wherein the one or more contestants compete against one another (for multi-contestant contests) and against the house (for both solo head-to-head contests between a single contestant and the house and for multi-contestant contests) in at least one fantasy contest provided in the gaming environment by entering at least one fantasy contest from among one or more fantasy contests; registering the at least one contestant with access to one or more fantasy contests; allowing the at least one contestant to enter contests based on the at least one event or at least one game; and determining at least one winner, among the one or more contestants and the house, based on an individual fantasy score derived from accumulation of fantasy points by the one or more selected sports players of the plurality of sports players.

With this approach an online fantasy sports contest can be provided, which allows users or contest participants to pay a contest entry fee and compete in a fantasy sports contest, against the house and/or other contest participants. At the end of the event or a series of events in which the contestant participates (or has the ability to participate), the fantasy points are added up to determine a total fantasy score for each contest participant and calculate and declare or announce winner(s) of the fantasy contest.

It will be appreciated that variations of the above-disclosed and other features and functions, or alternatives thereof, may be desirably combined into many other different systems or applications. For example, it can be appreciated that the fantasy contest approach disclosed herein does not have to be parimutuel but can also be implemented as a fantasy contest in which odds are set by a controller (e.g., sort of “house odds”). That is, “parimutuel” is just one particular betting approach, but not the only fantasy contest system or approach that can be utilized in accordance with the disclosed embodiments.

For a given fantasy contest, each contest participant may select one or more sports players (e.g., a quarterback) from a set of real-world sports players (e.g., a set of quarterbacks) that will be participating in a set of real-world sports matches scheduled to take place over a period of time associated with the given fantasy contest. Each contest participant may further pay entry fees based on their personal assessment that the selected competitors (e.g., sports players) will perform better than the others in the plurality of real-world sports players.

At the end of a given fantasy contest, based on the performance of their respective (selected) sports player(s), each contest participant that beats the house may win the head-to-head entry fee pot or a portion of the entry fee pot for contests having multiple contest participants in the final round capable of winning. For some embodiments, one or more ranked winners may be declared based on their respective total fantasy points or fantasy score at the end of a set of fantasy contests.

In some instances, each contest participant may pay a flat entry fee to enter the fantasy contest or set of fantasy contests and, in exchange for paying the entry fee, each contest participant is allowed to compete against the house and/or other contest participants. A contest participant may pay the entry fee into an entry fee pot of one or more fantasy contests prior to the commencement of the fantasy contests or the start of the real-world competition(s) or event(s) associated with a given fantasy contest.

Each contest participant may select one or more real-life sports players for each fantasy contest. For example, each contest participant may select one quarterback from a set of quarterbacks scheduled to play during the time period of the fantasy contest, may select one wide receiver from a set of wide receivers scheduled to play during the time period of the fantasy contest, or may select one kicker from a set of kickers scheduled to play during the time period of the fantasy contest. Contestants among the plurality of contest participants in any of the given plurality of fantasy contests may also comprise contest participants in one or more other fantasy contests being managed by the fantasy contest platform.

In some embodiments, each contest participant may select up to five (5) or more, e.g., up to ten (10) real-life sports players or other competitors as a roster for the fantasy contest—for instance, football embodiments may include one quarterback, one wide receiver, one tight end, one kicker and one running back. Depending on the embodiment, each contest participant selects the real-life sports players based on the contest participant's knowledge of the athlete and the athlete's anticipated performance.

For each fantasy contest, the one or plurality of contest participants may select one or more sports players (e.g., a quarterback) from a set of real-world sports players (e.g., a set of quarterbacks) that will participate in a set of real-world sports matches scheduled to take place over a period of time associated with the given fantasy contest.

In some embodiments, contestant selections are locked immediately upon confirmation of final selection or payment of an entry fee. In other embodiments, contestant selections may be changed up until the time of a first real-world sports event or competition (e.g., contestant selections may be made as soon as the house lineup selections are posted and may be changed up until the day or time of the contest, even up until the start time of at least one of the live games or matches).

Each contest participant may further use some of their money, points or credits (e.g., as available in their contestant user account) to pay entry fees to participate in a fantasy contest based on the selected sports teams and/or player(s) and based on the contestant's assessment or expectation of them to perform better than the other teams/players selected by the house from among the plurality of real-world sports events.

At the conclusion of each fantasy contest, contest participants may earn contest prize winnings (e.g., money, points or credits, etc.) or realize losses (e.g., forfeiting the entry fees paid) based on the performance of his or her lineup/roster during the fantasy contest.

For some embodiments, the systems and methods described herein establish and conduct one or more fantasy contests based on the performance of individual real-world sports players. Additionally, for some embodiments, the performance of an individual real-world sports player is determined using fantasy sports points (hereafter, fantasy points) attributed to the individual real-life sports player by one or more fantasy sports systems (or platforms), such as fantasy sports hosting sites offered by Yahoo®, ESPN®, CBS®, Fox Sports®, and the like.

As used herein, a fantasy sports score (hereafter, fantasy score) for an individual real-world sports player can represent the fantasy points that the individual real-world sports player has earned or produced based on their real-world performance during one or more sports matches.

In some embodiments, the systems and methods of the present invention enable system users or contestants to compete against the house based on selection of one or more real-world competitors (e.g., chess players, go competitors, and sports teams and/or players). In a base version of the present invention, a single contestant enters a solo, head-to-head contest against the ‘house’ operated by the fantasy contest platform/system, and a winner is determined based on a straightforward comparison of contestants' fantasy scores vs. fantasy scores achieved by the house selected competitors. The present invention further includes multi-contestant embodiments, discussed in greater detail elsewhere herein, where multiple contestants compete against the house and against each other to win.

In embodiments of the base head-to-head versions of the present invention, winner of fantasy contests between the contestant and the house takes the whole prize pot as the fantasy contest winnings. In all embodiments, the house may retain some portion or percentage of the entry fee pot as a fee for hosting the fantasy contest platform. For example, the house may retain up to ten percent (10%) or up to twenty percent (20%) of all wins and losses as the fantasy contest platform hosting fee.

In the head-to-head base version of the present invention, the house creates fantasy sports team lineups, e.g., a quarterback and some number of additional “flex” players who may hold different positions on a standard team roster. In this base version of the present invention, a contestant logs on to the fantasy contest platform and selects from a plurality of different sports and/or competitions (e.g., football, baseball, chess, checkers, go, etc.).

For each type of sport or competition, the house typically provides between three (3) to ten (10) different fantasy sports contest lineups at any one time that each contestant may choose to play against. The base version of the present invention further includes a salary cap requirement. Each lineup fielded by the fantasy contest platform house typically includes between three (3) to ten (10) players or competitors, depending on the type of sport or competition selected. For football the lineup may require inclusion of a quarterback, for baseball a pitcher may be required to be included in the lineup, for soccer and hockey, a goalie may be required in the lineup. For each new day of contest lineups, the house and players may select from any teams and/or players who are active that day.

The present invention also includes two alternative versions of the base embodiment of the invention, including a teams-based version and a player-based version. For the teams-based versions of the head-to-head embodiment, the house selects one or more teams (typically up to 5 teams, up to 8-10 teams, or even up to all teams competing on any given day in any given sport). Based on the house team selections, the house further selects one or more lineups per team to field for the fantasy contests, typically between 1-4 lineups per team, and usually not more than 5-6 lineups for a given team.

The teams-based versions of the head-to-head embodiment further integrate a point spread function, which may be a positive spread or a negative spread, with respect to the house team or lineup, whereby one of the teams or lineups has additional points added to or subtracted from the final tally of fantasy points for the given contest. For instance, the contestant selected team (e.g., Chicago Bears) may be +20 against a house selected team (e.g., the Kansas City Chiefs) or, conversely, the Chiefs may be −20 against a house selection of the Bears. In some embodiments, the point spread may depend on the specific players selected for a lineup.

For the players-based versions of the head-to-head base version, a salary cap for any given contest against a given lineup may be set at some arbitrary standard or may be based on a contestant selected buy-in or entry fee. In such alternative embodiments, several different buy-in amounts and corresponding salary caps may be offered for each lineup—e.g., for a particular lineup a salary cap of $50K may be offered for an entry fee of $50.00, a salary cap of $65K may be offered for a entry fee of $100.00, and a salary cap of $70K may be offered for an entry fee of $200.

Once the house selects and posts the lineups for the fantasy contests (typically posted up to a week in advance but as late as the day of the event or competition), contestants are enabled to select from one or more of the lineups to compete against, either teams-based and/or players-based lineups. After contestants select the lineup that they want to compete against, they select another team from a list of active, available teams to select the contestant's preferred team.

After contestants select their teams, they further select a contestant fantasy lineup, which may be required to have a specific position included (e.g., quarterback, pitcher, goalie, as previously discussed) or may be required to match the house lineup with respect to the positions fielded in the house fantasy lineup.

Further, for all versions of the head-to-head embodiments, each lineup fielded by the house comes with a set threshold value for the number of contestants or dollar amount allowed to be entered against that particular lineup. After the threshold is exceeded the fantasy contest system (and algorithms) will retire the current lineup and create a new lineup to field, for taking entry fees on a new fantasy contest lineup, based on available teams and players at the time the new lineup is required. Such threshold(s) may be based, at least in part, on the total volume of fantasy contest revenues transacted on the fantasy contest platform. Alternatively, a set of any number of lineups may be created in advance of the day of the contest(s) in question, and following the triggering of the dollar amount threshold for a particular lineup the next lineup in the queue is simply rotated into active contest status, while the prior lineup is retired.

Contestant lineups are not required to differ from house lineups by more than a single player. Importantly, in some embodiments, contestants may not select any lineup currently fielded by the fantasy contest platform, whereas in other alternative embodiments, contestants may play lineups identical to current house lineups, but only against other currently fielded house lineups.

Further, some embodiments of the present invention include selection or designation of an “MVP” for all lineups, house and contestant. The MVP designation for players or competitors may result in the use of some factor or multiplier (e.g., one and a half times (1.5×) points, two times (2×) or double points, three times (3×) or triple points, etc.) in calculating the individual fantasy scores for each of the players on a lineup. Furthermore, in some embodiments, the house only reveals one or more selections in a house fielded lineup to the contestants in advance of the day or time of the contest, e.g., the house may post one to three (1-3) selections of a five to ten (5-10) player lineup.

For some embodiments, one or more contest winners of one or more fantasy contests are declared based on their respective total fantasy score/points having beaten (i.e., accumulating a higher value than) the corresponding house total balance of fantasy score/points at the end of a given fantasy contest. A first plurality of sports players may comprise sports players of one or more sports teams and/or arbitrary positions within a given sports team or among the given sports teams, respectively. Alternatively, the first plurality of sports players may comprise sports players of a single sports team, of a specific squad or team in a sports team (e.g., receivers, running backs, special teams, etc.), or players of a particular position on the same sports team (e.g., kicker, center, quarterback, punter, etc.).

The systems or method steps form, for a given fantasy contest, an entry fee pot. For embodiments having multiple contestants in a given fantasy contest, the entry fee pot comprises entry fees paid by the plurality of contest participants to enter the given contest. Contest outcomes are based on performances of a first plurality of selected sports players, selected from the first plurality of sports players by the contest participants or contestants.

In some embodiments, each contest participant may only pay one entry fee per fantasy contest. In other embodiments, each contestant of the plurality of contest participants may pay more than one entry fee (i.e., to enter more than one fantasy contest, or, in multi-contestant, multi-round embodiments, to enter the same fantasy contest more than once). In further embodiments, in particular in winner-takes-all scenarios, contest participants may each pay multiple entry fees into the entry fee pot of a single fantasy contest (i.e., pay multiple entry fees to enter the same fantasy contest multiple times). The systems or method steps may receive a first plurality of performance metrics and or fantasy points relating to the first plurality of selected sports players, during or after expiration of a first time period associated with the (first or subsequent rounds) of the fantasy contest.

The first set of real-world sports matches may be associated with car racing, football, basketball, baseball, hockey, soccer, golf. Additionally, the first time period may comprise to a day, a week, a month, or a sports season.

When selecting from among the plurality of fantasy contests on offer, for each given contestant of the plurality of contest participants, the systems or method steps may receive a communication or other indication of one or more selected sports players chosen from among the first plurality of sports players, thereby including the one or more sports players as part of the first plurality of selected sports players comprising the fantasy contest roster of a respective contestant.

For each given contestant of the plurality of contest participants, the systems or method steps may receive from the given contestant an instruction to pay an entry fee to enter a given fantasy contest. The fantasy contest may be determined by comparison between the fantasy score of, or total fantasy points accrued by, the one or more sports players on the roster or lineup selected by the contestant and the lineup or roster selected by the house.

The instructions may further include directives for participation in a first round based on one or more sports players selected by the contest participant and monitored for performance metrics as part of the plurality of selected sports players (i.e., contestant lineup or roster selection triggers the fantasy contest platform to execute instructions to monitor and collect competitor performance metrics for the lineup of the respective contestant). The fantasy contest may comprise a single round or multiple rounds of competitive play. In all cases, the fantasy contest is based on one or more sports players or competitors selected by the contestant and monitored for performance metrics as part of the first plurality of selected sports players.

For each given contestant of the plurality of contest participants, the systems or method steps may transfer the money, points or credits paid by the contestant from the associated account of the given contestant into the entry fee pot. In preferred embodiments the entry fee amount paid by each contestant is a flat fee comprising the same cost or charge (e.g., money, points, credits, etc.) to each contest participant.

The systems or method steps may include identifying, from the plurality of contestants, a first set of contest winners for the fantasy contest(s) based on the first plurality of fantasy score/points and/or performance metrics (e.g., touchdowns, yards carried, or yards passed by a football player) for the lineups/rosters of each respective contestant. Contestant fantasy scores must beat the house fantasy score to win. In some embodiments the first set of contest winners may comprise a single contestant, and in other embodiments the first set of contest winners may comprise a plurality of contestants who have each beaten the house fantasy score for the given contest or round of the fantasy contest.

The systems or method steps may include updating the associated prize winnings (e.g., money, points, credits, etc.) of each contestant of the plurality of contest participants based on a first set of contest winners, the plurality of contest entries and entry fees, event outcomes, and balance of the entry fee pot.

The systems or method steps may include updating the associated account balance (e.g., money, points or credits winnings) of each contestant of the plurality of contest participants based on the first set of contest winners, the plurality of contest entries and entry fees, event outcomes, and the balance of the entry fee pot, by transferring money, points or credits, etc., between the entry fee pot and associated account of each contestant of the plurality of contest participants based on the plurality of contest entries logged by the plurality of contestants (i.e., delivering the appropriate money, points or credits winnings).

For some embodiments, the method is performed for each round of a fantasy contest in the plurality rounds of the fantasy contest. For instance, the systems or method steps may establish a fantasy contest having multiple rounds of competitive play associated with the plurality of contest participants and a second and subsequent (e.g., third, fourth, fifth, etc.) plurality of sports players scheduled to play in a second and subsequent (e.g., third, fourth, fifth, etc.) sets of real-world sports matches over a second and subsequent (e.g., third, fourth, fifth, etc.) time period.

For embodiments including multi-round fantasy contests, the systems or method steps may enable the contestants to form second and subsequent (e.g., third, fourth, fifth, etc.) fantasy sports team roster based on a second and subsequent (e.g., third, fourth, fifth, etc.) plurality of selected sports players chosen from the second and subsequent (e.g., third, fourth, fifth, etc.) plurality of sports players selected by the respective contestants.

The second plurality of sports players may comprise sports players of any sports team or any position within a sports team. Alternatively, the second plurality of sports players may comprise sports players of a single sports team, of a specific squad or team in a sports team (e.g., receivers, running backs, special teams, etc.), or players of a particular position on the sports team (e.g., kicker, center, quarterback, punter, etc.).

For embodiments including multi-round fantasy contests, the systems or method steps may form a second entry fee pot, comprising a portion of the entry fees collected from the plurality of contest participants or contestants. In some embodiments, the second entry fee pot is paid out in one or more round prizes over the course of the multi-round fantasy contest.

In preferred embodiments of the survivor-pool version of the present invention, the second entry fee pot may comprise a range from twenty percent (20%) to eighty percent (80%) of the total entry fees. In embodiments having a second entry fee pot, the contest pot becomes a first entry fee pot comprising the reciprocal portion or remainder of the total entry fees.

In preferred embodiments, the total entry fees of the contest participants (less some set percent taken as house commission for the fantasy contest) are split equally between the first and second entry fee pots, with the first entry fee pot reserved as prize winnings for, e.g., all contestants winning the final round of the fantasy contest, ranked winners of the final round of the fantasy contest, ranked winners of all rounds of the fantasy contest, special prizes and other purposes.

In some of these preferred embodiments, the second entry fee pot may further be reserved as prize winnings for, e.g., all contestants winning a round of the fantasy contest, unranked winners of a round of the fantasy contest, unranked winners of the final round of the fantasy contest, special prizes and other purposes.

In some embodiments, the second entry fee pot is divided equally among all rounds of the fantasy contest, and further divided equally among all winners of a given round of the fantasy contest. In other embodiments, the second entry fee pot is divided equally among all rounds of the fantasy contest, except for the final round, which does not receive a share of the second pot—this arrangement is useful for embodiments where the first entry fee pot is reserved as winning prizes for the final round.

A round prize may simply comprise an portion of the second pot divided equally by the number of rounds in the fantasy contest, further divided by the number of winning contestants in any given round. Alternatively, round prizes may be divided based on a ranked order, including larger money prizes for the highest ranked contestants, and an equal split of the remainder of the second entry fee pot round payout amongst the rest of the winning contestants who do not receive a ranking (but who have beaten the house).

The systems or method steps may receive a second (or subsequent) plurality of performance metrics and or fantasy points relating to the second plurality (or subsequent pluralities) of selected sports players, during or after expiration of a second (or subsequent) time period associated with the second (or subsequent) round(s) of the fantasy contest.

The systems or method steps may identify, from the plurality of contest participants, a second or subsequent (e.g., third, fourth, fifth, etc.) set of contest winners for the second or subsequent (e.g., third, fourth, fifth, etc.) rounds of the fantasy contest based on the second plurality of fantasy points and/or performance metrics. The systems or method steps may update the associated account balance (e.g., money, points or credits winnings) of each contestant of the plurality of contest participants based on a second or subsequent (e.g., third, fourth, fifth, etc.) set of contest round winners, event outcomes and the balance of the second entry fee pot.

Additionally, the second set of real-world sports matches may be associated with car racing, football, basketball, baseball, hockey, soccer, golf. Depending on the embodiment, the second time period may comprise to a day, a week, a month, or a sports season.

When forming the fantasy sports team rosters for a second and subsequent rounds (e.g., third, fourth, fifth, etc.), for each contestant of the plurality of contest participants, the systems or method steps may receive a communication or other indication of one or more selected sports players chosen from among the second or subsequent (e.g., third, fourth, fifth, etc.) plurality of sports players, thereby including the one or more sports players as part of the second or subsequent (e.g., third, fourth, fifth, etc.) plurality of selected sports players chosen by the respective contestant.

For each given contestant of the plurality of contest participants, the systems or method steps may receive from the given contestant an instruction for participation in a second and subsequent rounds (e.g., third, fourth, fifth, etc.), based on one or more sports players selected by the contestant and monitored for performance metrics as part of the second and subsequent (e.g., third, fourth, fifth, etc.) plurality of selected sports players.

In some embodiments, the set of performance metrics are based on or comprise one or more fantasy points relating to the second and subsequent (e.g., third, fourth, fifth, etc.) plurality of selected sports players. For example, the one or more fantasy points may be provided by one or more fantasy sport systems, which may be offered by Yahoo®, CBS®, ESPN®, and the like.

In embodiments having a second entry fee pot, for each given contestant of the plurality of contestants, the systems or method steps may transfer a portion of the money, points or credits paid by the contest participant as an entry fee to join the fantasy contest from the associated account of the given contest participant to the second entry fee pot.

The systems or method steps may pay contestants from the second entry fee pot before or after updating the associated account balance (e.g., money, credits, points, etc.) of each contest participant of the plurality of contest participants based on the set of winners of a particular fantasy contest round, the plurality of contest entries and entry fees, and the balance of the second entry fee pot.

When updating the associated account balances, the systems or method steps may identify a set of contest/round winners who have beaten the house and pay each winner from one or more of the first and second entry fee pots. Alternatively, the system and methods may identify a first place winner in the set of contest participants based on a first performance metric of the first plurality of performance metrics corresponding to the sports player(s) in the plurality of selected sports players selected by the first place winner.

The systems or method steps may update the first and/or second entry fee pots and the associated account balances of the winner(s) based on one or more contest entries from among the plurality of contestants corresponding to one or more sets of winner(s). Updating the associated account balances may further comprise identifying one or more winner(s) in the set of contest participants based on a cumulative total of one or more subsequent (e.g., second, third, further, fifth, etc.) performance metrics of the first plurality of performance metrics corresponding to a first (or additional, e.g., second, third, fourth, fifth, etc.) sports player(s) in the plurality of selected sports players selected by the winner(s).

Additionally, for some embodiments, a plurality of the contest participants having fantasy scores or fantasy points balances that have beaten the house score (e.g., 1st, 2nd, and 3rd highest points balances) are determined to be the winners of the fantasy contest. Conversely, if no contest participants score higher than the house, then there are no winners for the contest.

Further, in some embodiments, a winner is determined at the end of each fantasy contest based on the total balance of their fantasy score/points, or a set of winners is determined at the end of each fantasy contest based on their respective total fantasy score and fantasy points balance.

A unique method of sharing the pot further sets this invention apart from all others. It is convenient to offer split the pot at or below some maximum threshold percentage of contestants remaining. For instance, split the pot could be offered in the contest round following the percentage of remaining contestants falling below half or less than fifty percent (<50%).

However, in a preferred embodiment split the pot is not offered, in a given contest, until there are 10% or fewer contestants remaining, at which point they are all prompted to choose whether to end the contest early and split the pot.

Different versions of split the pot may include a majority or supermajority rules criteria, where, so long as some threshold percentage of the remaining contestants all vote in favor of splitting the pot, the pot will be split equally among the remaining contestants and the contest will end early. However, in a preferred embodiment all contestants must agree in unanimous consent for the function to work, otherwise the contest will proceed unabated to the next round.

Ideal duration for a round of gameplay may vary by sport to optimize the fantasy gameplay. For instance, a new round may start next day or the next week, depending on the type of the contest provided. After each round with less than ten percent (<10%) of users remaining, the system of the present invention will always prompt the users to collectively to end the contest early and split the pot.

Users are not obligated to accept this alternative end to a contest, and the split the pot option is provided as a means to increase users' chances of winning. For multi-round fantasy contests, contest rounds continue until there is either an outright winner at or before the expiration of a contest, multiple winners at the expiration of a contest, or multiple winners before the expiration of a contest when the remaining users decide to split the pot, e.g., under the ten percent (10%) condition.

When the remaining users decide to split the pot, some percent (e.g., one percent (1%)) of that split pot may be donated to a charity. This 1% charitable donation may be used to entice users to choose to split the pot. In some embodiments of the present invention, the split-pot winners may select the charity. In other embodiments of the present invention, the house selects the charity.

Additionally, in embodiments of the present invention that include winners or prospective winners choosing the charity, the (prospective) winners may be provided with a selection of at least two charities. The charity that receives most votes from the (prospective) winners will receive the charitable donation. However, in the event of a tie vote, the donation could be split between the two charities or a runoff vote could be held. These charitable donation scenarios may apply exclusively to pots split based on user selection.

In a preferred embodiment of the present invention, in the very first round of a fantasy contest, users or contestants will be able to select from two real world events by selecting a set of wild cards configured to enhance or degrade their point totals. In certain preferred embodiments, users will select either four or five (4 or 5) players from one or more additional teams. The house may display its selected wild card players.

In certain other preferred embodiments, wild card player selections are required only for the very first round and are not offered in subsequent rounds. The house may provide the contestants with a prepopulated list of available wild card players. In other preferred embodiments, the house provides users with a pre-selected list of choices of between 2 to 100 different wild card players. In some embodiments, contestants may be enabled to select multiple wild card players. In others, only a single wild card player selection is allowed. The house also picks the same number of wild card players from the pre-populated set of wild card player selections.

For multi-round, multi-contestant embodiments that require selection of a team, a wildcard is implemented in a first round of the fantasy contest that requires selection of a wild card sports player from a second team, different than the team selected as the competing team. In these embodiments, the wild card sports player's fantasy points are added to the fantasy score for the contestant to determine ultimate outcomes of the first fantasy contest round. In some other embodiments, wild card players may be employed in one or more subsequent rounds.

In certain preferred embodiments, the users must select a wild card player from a different team than the team of the players selected by the user for play in the particular round, i.e. in preferred embodiments, the first round. For football contests, the wild card players may be kickers, or special teams. For basketball, the wild card players may be top rated players and/or specific positions. For baseball, the wild card players may include top projected pitchers for the basic unit of fantasy contest time (e.g., daily, weekly, monthly, etc.)

Further, in another preferred embodiment of the present invention, the house may host an unlimited-entry, winner-takes-all, double-elimination survivor pool fantasy contest, e.g., at the beginning of every season for football. For baseball and basketball, the house may run an unlimited-entry, winner-takes-all, double-elimination survivor pool once every 30 days. Double elimination means each entry gets two chances to win. In successive rounds of double elimination play, the house may show fewer house player picks in each subsequent round.

For these preferred embodiment, winner-takes-all fantasy contest embodiments, the house may announce the prize total and unlimited number of user entries up front to entice more users to join the fantasy contest.

For versions of these preferred embodiment, winner-takes-all competitions that allow multiple entries per user, the house may possibly cap the number of entries per user at some reasonable number of entries (e.g., between 1 and 100 entries). Registration of new entries will be cut off at some buffer time period (e.g., 48 hours) prior to commencement of the fantasy contest. Play will continue until a single winner emerges, or multiple prospective winners remain at the conclusion of the fantasy contest, in which case the pot may be split in accordance with the number of prospective winning entries remaining.

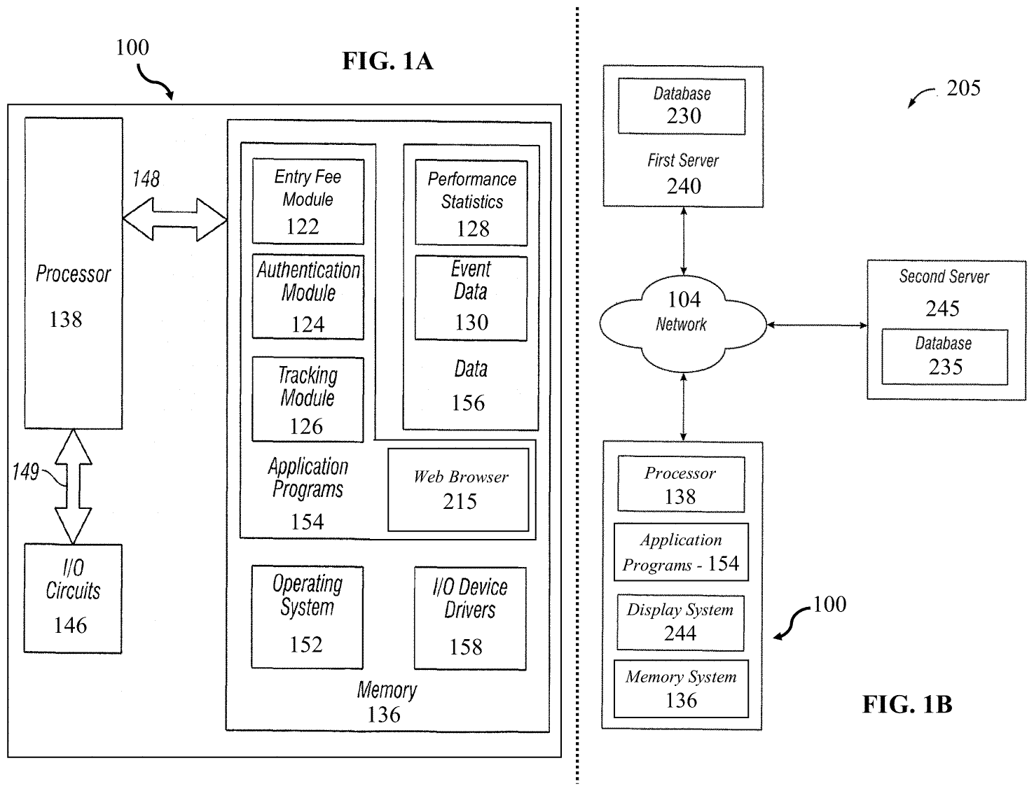

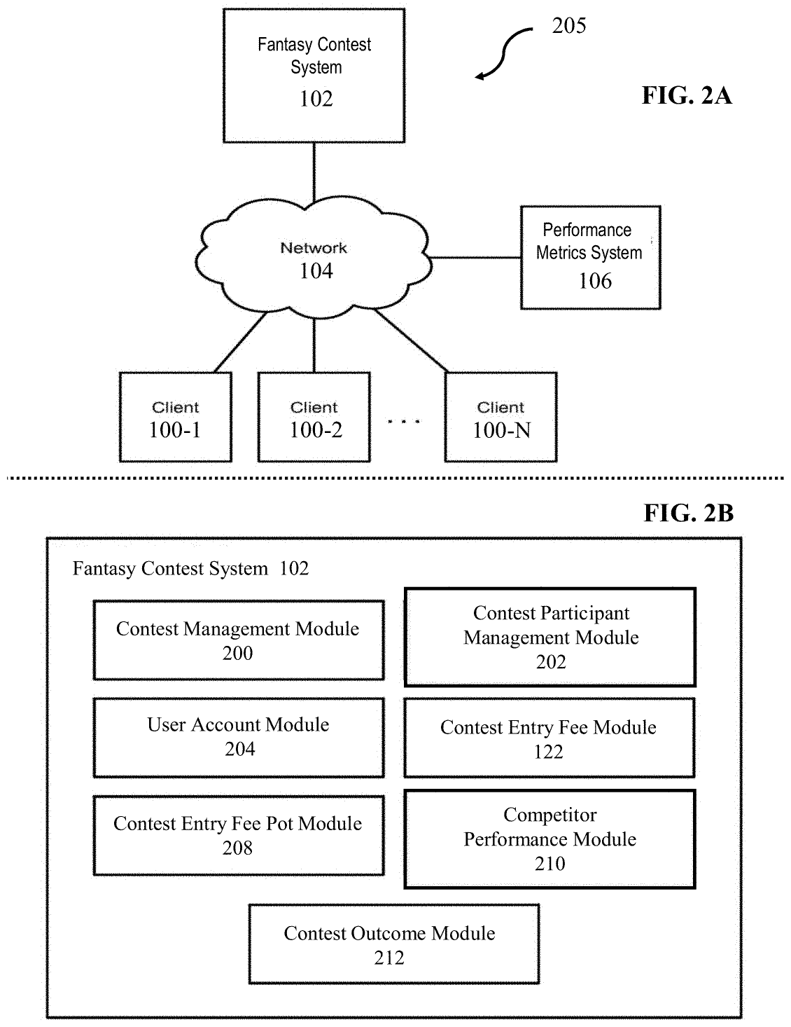

Referring now to FIG. 1A, an exemplary digital data processing and remote/network communications device 100, i.e., a terminal or client device (hereinafter the “user device”, “client device” or “client”), is shown. The client device 100 includes data processing systems and modules designed to provide access to a fantasy contest platform via an entry fee module 122 and database environment that may be implemented or included in devices operating in accordance with some embodiments of the present invention. As illustrated, the client device 100 includes a processor 138, a memory 136, and input/output circuits 146. The client device 100 may comprise or be incorporated in, for example, a personal computer, a portable wireless hand-held device (e.g., Smartphone, tablet, etc.), server, router, or the like.

The processor 138 communicates with the memory 136 via an address/data bus 148 and communicates with the input/output circuits 146 via an address/data bus 149. The input/output circuits 146 can be used to transfer information between the memory 136 and another computer system or a network using, for example, an Internet Protocol (IP) connection and/or wireless or wired communications. These components may be conventional components such as those used in many conventional data processing systems, which may be configured to operate as described herein.

In particular, the processor 138 can be any commercially available or custom microprocessor, microcontroller, digital signal processor or the like. The memory 136 may include any memory devices containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be, for example, a content addressable memory (CAM).

As further illustrated in FIG. 1A, the memory 136 may include several categories of software and data used in the client device 100: an operating system 152; application programs 154; input/output device drivers 158; and data storage system 156. As will be appreciated by those of skill in the art, the operating system 152 may be any operating system suitable for use with a data processing system, such as, for example, Linux, Windows XP, Mac OS, iOS, Android, Unix, etc.

The input/output device drivers 158 typically include software routines accessed through the operating system 152 by the application programs 154 to communicate with devices such as the input/output circuits 146 and certain memory system 136 components. The application programs 154 are illustrative of the programs that implement the various features of the circuits and modules according to some embodiments of the present invention. Finally, the data storage system 156 stores and represents static and dynamic data that can be used by the application programs 154, the operating system 152, the input/output device drivers 158, and other software programs that may reside in the memory 136.

As illustrated in FIG. 1A, the data obtained in and included in the storage system 156 may include, for example, performance statistics 128 (e.g., competitor—team and player—performance metrics and statistics) and event information/data 130 for use by the circuits and modules of the application programs 154 according to some embodiments of the present invention, as discussed further herein. The event information, for example, may include data associated with a particular event. Statistics may include, for example, not only statistical information related to a particular event, but also broader statistics, such as, for example, team history and sports scores.

In the embodiment shown in FIG. 1A, applications programs 154 can include, for example, an entry fee module 122, a security or authentication module 124, a tracking module 126, and so forth. The authentication module 124 verifies or confirms user or contestant identity, location, etc. The tracking module 126 tallies and tracks the contestant fantasy points, performance metrics of contestant selected competitors, and other data relevant to the contestant's contests, including whether an associated competition event has commenced, time elapsed in the real-world competition events, etc.

While the present invention is illustrated with reference to the entry fee module 122, the authentication module 124, and the tracking module 126 being application programs in FIG. 1A, as will be appreciated by those of skill in the art, other configurations fall within the scope of the present invention. For example, rather than being application programs 154, these modules may also be incorporated into the operating system 152 or other such logical division of the client or user device 100.

Furthermore, while the entry fee module 122, the authentication module 124, and the tracking module 126 are illustrated in a single data processing system, as will be appreciated by those of skill in the art, such functionality may be consolidated or distributed across one or more data processing systems. Thus, the present invention should not be construed as limited to the configuration illustrated in FIG. 1A and may be provided by other arrangements and/or divisions of functions between data processing systems. For example, although FIG. 1A is illustrated as having various circuits/modules, one or more of these circuits may be combined without departing from the scope of the present invention.

Referring now to FIG. 1B, an exemplary network environment 205 for operations and devices according to some embodiments of the present invention will be discussed. As illustrated in FIG. 1B, the network environment 205 may include a digital data processing and remote/network communications device (i.e., the client device 100), a data communications network 104, a first server 240, and a second server 245. It can be appreciated that additional servers may be utilized with respect to network 104.

It can also be appreciated that in some embodiments, only a single server, such as server 240 may be required. In general, the client device 100 allows a user of the client device 100 to enter fantasy contests, the results of which may depend on one or more of the performances of various sports players, outcomes of various sporting events, competitions and other events utilizing bi-directional client device 100 with one or more servers 235, 240, etc., over the data communications network 104.

As illustrated, the client device 100 illustrated in FIG. 1B may include the entry fee module or system 122 as part of the application programs 154, according to some embodiments of the present invention discussed above with respect to FIG. 1A. For example, the application programs 154 discussed with respect to FIG. 1A could include all or part of the entry fee module 122 of the client device 100. The client device 100 may be, for example, a laptop computer, a desktop computer, a personal data assistant (PDA), smartphone, tablet or other web or internet enabled mobile terminal or any device capable of communicating with the network 104.

The client device 100 may include, for example, a display system 244 that may comprise a graphical user interface, and which may be used to pay contest entry fees and enter fantasy contests according to some embodiments of the present invention, and a web browser 215 that may be accessed through the display system 244 and graphical user interface, according to some embodiments of the present invention. As discussed above, the entry fee system/module 122 may be configured to permit a user to pay entry fees and enter fantasy contests via the client device 100. The first server 240 may include a database 230 and the second server 245 may include a database 235.

The client device 100 may communicate over the network 104, for example, the Internet, through a wireless communications link, an Ethernet connection, a telephone line, a digital subscriber link (DSL), a broadband cable link, other wireless links, etc. The first and second servers 240 and 245 may also communicate over the network 104. Thus, the network 104 may convey data between the client device 100 and the first and second servers 240 and 245. The network 104 can be, for example, a wireless communications network, such as, for example, a cellular communications network or 802.11/WiFi network. The network 104 can also be a client-server network.

The client device 100 can be, for example, a desktop computer, a laptop computer, a set-top box, or portable wireless handheld devices such as a Smartphone and/or PDA. The client device 100 can also be, for example, a device such as an iPad type computing device.

The system and methods of the present invention may further include a process for performing logical operational steps to enable one or more users of remote/network client devices to enter fantasy contests via data network access to a gaming environment or fantasy contest platform (e.g., eSports, eGaming, Fantasy Sports, etc.), in accordance with the disclosed embodiments.

In general, a user of the client device 100 may enter one or more fantasy contests, the results of which may be determined based on one or more outcomes (discreet and cumulative) that result from the conduct of a sporting event, competition or other type of event, via access to network servers 235 and/or 240, etc. over the data network 104.

The system and methods of the present invention may further include a process for performing logical operational steps to enable authentication of a user of a client device 100, in accordance with the disclosed embodiments. A secure identification can be established to permit a user of the client device 100 access to one or more of the servers 240, 245, etc., through the network 104 via the authentication module 124. User or contestant identity authentication and validation may be provided as a third-party service (e.g., SaaS). Next, the user/authorized party is provided with secure and remote/network access to one or more of the servers 240, 245, etc., for entering fantasy contests via the client device 100.

The user of the client device 100 can then enter his or her secure identification via the client device 100. Remote/network access can then be granted to the user if his or her identification information is confirmed. Remote/network access can be provided to one or more of the servers 240, 245, etc., via the network 104 includes, for example, access to statistics and event data. Such information can be utilized by the user in consideration for entering a fantasy contest and selecting specific teams and players via the client device 100.

Fantasy contests can be joined or entered by remote/network client device users any time before the fantasy contest has started. However, once the fantasy contest or associated real-world competition (e.g., sports event) has started, contest participants are not allowed to enter or leave the fantasy contest.

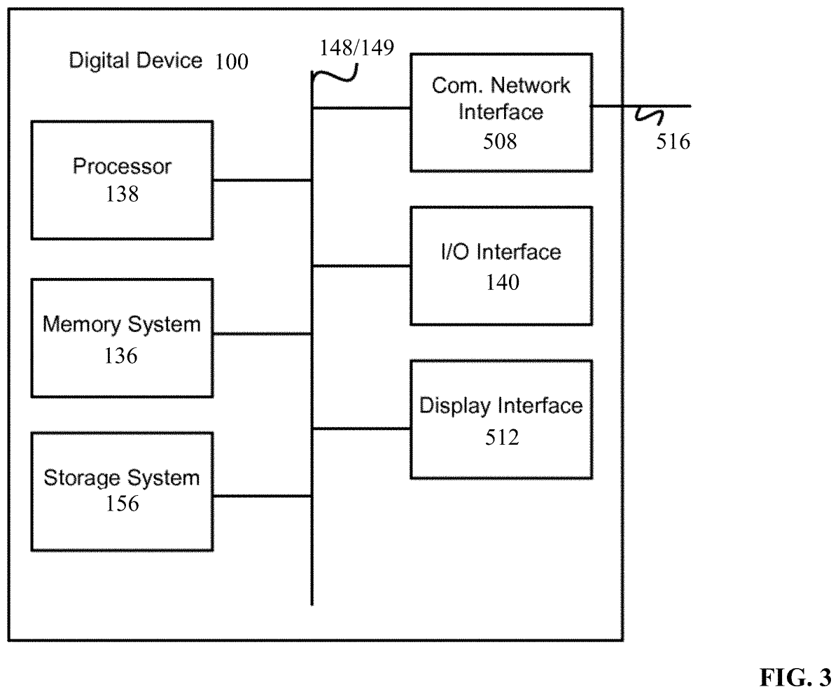

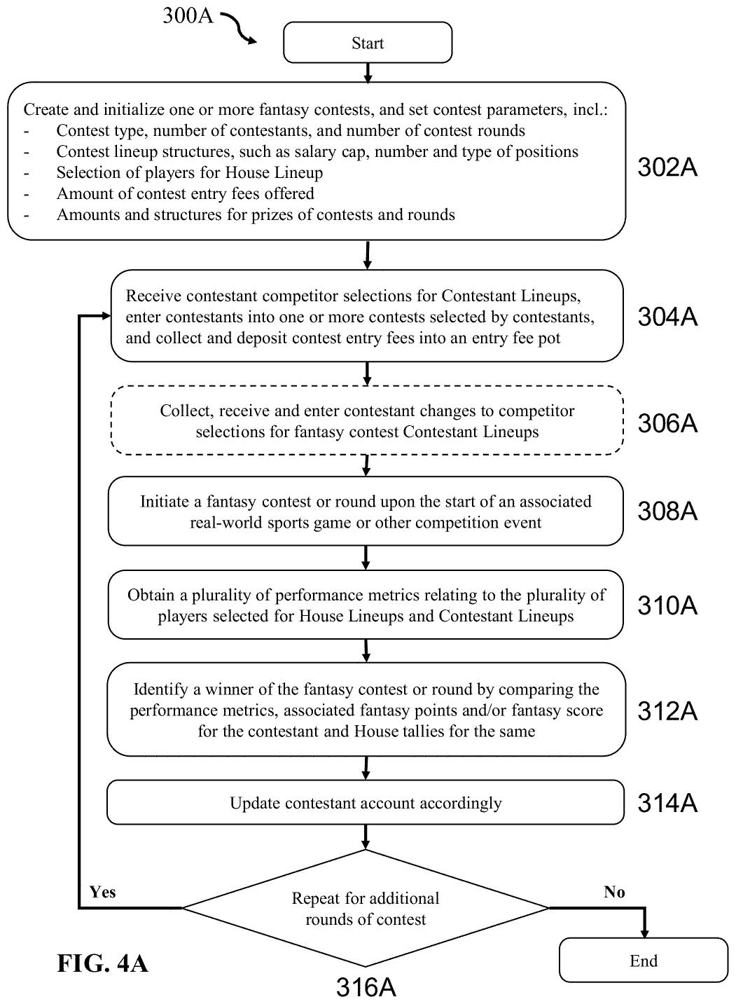

FIG. 2A is a block diagram illustrating another example of a network system 205 that includes a fantasy contest system 102 in accordance with some embodiments. As shown, the example network system 205 comprises a fantasy contest system 102, a network 104, a competition/competitor performance metrics system 106, and client devices or digital data processing and remote/network communications devices 100-1 through 100-N (hereafter collectively referred to as clients or client devices 100, i.e. user devices or user terminals).

For some embodiments, the network 104 may facilitate data communication between one or more of the fantasy contest system 102, the competitor performance metrics system 106, and the client devices 100. Accessibility to one or more of the fantasy contest system 102 and the competitor performance metrics system 106 by the client devices 100 may be implemented via the data network 104 (FIG. 2A).

Additionally, one or more of the fantasy contest system 102 or the competitor performance metrics system 106 may comprise one or more servers (see first and second servers FIG. 1B), which may be operating on or implemented using one or more cloud-based services (e.g., System-as-a-Service [SaaS]).

The fantasy contest system 102 may be configured to implement the functions and features of various embodiments described herein. For example, the fantasy contest system 102 may facilitate the establishment, and subsequent maintenance, of one or more fantasy contests. Each fantasy contest may involve one or a plurality of contest participants and a plurality of real-world sports players scheduled to play in a set of real-world sports matches (e.g., NASCAR, football, basketball, baseball, hockey, soccer, or golf, etc.) over a set time period.

The plurality of sports players may comprise players of any sports team or any position within a sports team or, alternatively, the plurality of sports players may comprise sports players of a particular sports team, of a specific team in a sports team (e.g., special teams), or playing a particular position on the sports team. The fantasy contest system 102 may form, for the fantasy contest, an entry fee pot comprising a plurality of entry fees submitted by the plurality of contest participants on a plurality of selected sports players that are selected from the plurality of sports players.

In some embodiments of the present invention the contestants must select teams and subsequently select players on or belonging to those teams. In other embodiments, the contestants may be enabled to select sports players for their fantasy team rosters independent of real-life team affiliation.

In further embodiments where contestants are enabled to select one or more sports players, one of the one or more sports players may be selected for a “captain” role (double points) within the fantasy sports team roster. For instance, contestants may be allowed to pick between three (3) to five (5) sports players and one (1) captain, to make for four (4) to six (6) sports player total selected by each contestant. In embodiments related to football, the captain may be required to always be a quarterback. For embodiments related to other sports the position of the captain may be unrestricted.

It should be appreciated that any number of players may be selected for the standard player roles, and in addition, more than one captain may be allowed, per fantasy contest, or per fantasy contest round. Once a player has been selected as a captain by a contestant, that contestant may be prohibited from selecting that sports player again during the fantasy contest.

In embodiments that require selection of a team, the contestants are further prohibited from selecting the same team as the house. For embodiments that do not require selection of a team, where contestants are allowed to build a fantasy sports team roster independent of real-life team affiliation of the players, the contestants may pick up to two of the same players as the house. In some embodiments, contestant lineups may share only up to one player with the house lineup, whereas in other embodiments the contestant lineups must differ from the house lineup by at least one player.

In some further embodiments of the present invention, a fantasy sports team roster salary cap may be employed to ensure parity amongst lineups and to prevent contestants from simply choosing only the top players. The total salary cap applied may depend on the number of players required to be selected for the particular fantasy contest. The fantasy contest may set a salary cap to which the contestants must adhere in building their respective fantasy sports team rosters.

For example, if each contestant receives a salary cap of $50,000 and selects a first sports player costing $15,000 (as set by the fantasy contest platform), then $35,000 remains for the contestant to select additional sports players for the contestant's fantasy sports team roster, and so on following each additional selection. In preferred embodiments employing a salary cap, contestants are enabled to choose players from any team, independent of real-life team affiliation.

In additional embodiments of the present invention, the contestants may be prohibited from choosing the same team or the same players in subsequent rounds as already fielded in previous rounds of a multi-round fantasy contest. In some of these embodiments, the contestants may be prohibited from choosing the same player lineup twice, meaning the contestants may be allowed to choose some specific number of same players on a fantasy sports team roster (e.g., no more than up to one to five players, preferably in a range of 1-2 players on a fantasy sports team roster may have been previously fielded by the same contestant) or allowed to fill specific positions with prior fielded players (e.g., quarterback, kicker, pitcher, catcher).

In certain alternative embodiments, the fantasy contest house selection may also be likewise limited, disallowing selection of the same teams or players in subsequent rounds. House selections may be made automatically via computational algorithm or may be selected by humans.

Each fantasy contest entry of the plurality of contest entries may correspond to one contestant of the plurality of contest participants and correspond to one or more sports teams and sports players, in the plurality of sports players selected by the one contestant. The fantasy contest system 102 may receive, at or after expiration of the time period, a plurality of final performance metrics relating to the plurality of selected sports players.

The fantasy contest system 102 may identify, from the plurality of contest participants, a (set of) contest winner(s) for the (set of) respective fantasy contest(s) based on the total fantasy points accumulated by each contestant as accrued based on the performance metrics (e.g., touchdowns, yards carried, or yards passed by a football player) achieved by the player(s) selected by the contestant.

The fantasy contest system 102 may update the associated fantasy points and total fantasy score of each contestant of the plurality of contest participants. The time period for the fantasy contest may comprise to a day, a week, a month, or a sports season.

For some embodiments, when the fantasy contest system 102 forms the lineup for the fantasy contest, the fantasy contest system 102 may receive a selection of the one or more sports players from the first plurality of sports players from each given contestant of the plurality of contest participants, thereby forming the plurality of selected sports players.

For each given contestant of the plurality of contest participants, the fantasy contest system 102 may receive from the given contestant an instruction for selection by a contestant of one or more sports players in the plurality of selected sports players.

Before one or more fantasy contests begin, the fantasy contest system 102 may initialize each of associated contestant by charging a set fee (i.e., an entry fee, some set amount of money, points or credits) to each of the plurality of contest participants with a predetermine amount (e.g., initial balance), such that each contest participant in the fantasy contest starts with equal standing (i.e., each contestant in a single contest contributes the same amount to participate in the contest), before the fantasy contests and the associated plurality of sports matches commence.

By accessing the fantasy contest system 102, each contest participant effectively pays the entry fee for contests based on contestant selections of one or more sports players for the given fantasy contest.

Eventually, the fantasy contest system 102 receives for a given fantasy contest the set of performance metrics/statistics 128 (e.g., from the competition/competitor performance metrics system 106) associated with the plurality of selected competitors or sports players of the fantasy contest. Based on the set of performance metrics/statistics 128, the fantasy contest system 102 can determine a set of contest winners (i.e., one or more contest winners) for the given fantasy contest. The (set of) contest winner(s) is determined based on selected sports players' competition performance statistics and overall fantasy score.

Subsequently, the fantasy contest system 102 can update the account balances of the associated accounts of the plurality of contest participants according to the plurality of fantasy contests, and the respective entry fees and entry fee pot, and the set of contest winners. During the account balance update, credits, points or money winnings may be transferred from the entry fee pot to the respective associated account balances of contest winners, and the amounts transferred to each contest winner may depend on their ranking in the set of contest winners and which round of the contest each respective contestant survived through.

The performance metrics system 106 may be configured to provide, with respect to a fantasy contest managed by the fantasy contest system 102, a set of actual performance results (e.g., performance metrics and statistics) for one or more real-world sports players that are participating in real-world sports matches associated with the fantasy contest. In particular embodiments, the performance metrics system 106 provides the fantasy contest system 102 with the set of actual performance results and statistics for real-world sports players in the form of one or more fantasy sports scores for the real-world sports players.

The performance metrics system 106 may provide the fantasy contest system 102 with the set of performance results for the sports players at or near real-time and may provide the set of performance results as a data stream of information. In certain embodiments, the performance metrics system 106 provides a news feed that the fantasy contest system 102 can use to determine the set of performance results for the sports players.

For example, where an entry fee pool is associated with a plurality of sports matches (e.g., series of baseball games), the performance metrics system 106 may provide the fantasy contest system 102 with a sports news feed with a set of performance results (e.g., performance statistics 128) for the sports players participating in those baseball sports matches. Depending on the embodiments, the set of performance results for the sports players can relate to player statistics or performance of the sports team on which the sports player is a member (e.g., team statistics).

One or more components of the performance metrics system 106 may be implemented by one or more third-party services (e.g., news services) provided in commonly used data formats (e.g., RSS feeds, web services, JSON objects, etc.).

The clients devices or user terminals 100 may be any form of computing device capable of receiving user input (e.g., configured to facilitate interaction between a contestant and the fantasy contest system 102), capable of displaying a client user interface (e.g., a graphical user interface configured to facilitate a contestant to access the fantasy contest system 102), and capable of communicating with the fantasy contest system 102 over one or more of the communication connections over the network 104.

Such computing devices may include a mobile phone, a tablet computing device, a laptop, a desktop computer, personal digital assistant, a portable multi-media player, or any other type of network accessible user device known to those of skill in the art.

Each of the client devices 100 may be configured to communicatively connect with the fantasy contest system 102 and access various functionalities provided by the fantasy contest system 102. For example, by way of one of the client devices 100, a user (e.g., as a fantasy contest administrator) may enter a fantasy contest associated with a plurality of real-world competitors or sports players scheduled to participate in real-world competitions or sports matches, upon payment of an entry fee.

For some embodiments, a user joins the fantasy contest by paying an entry fee (e.g., the buy-in for the fantasy contest). Through one or more of the client devices 100, a contest participant may submit entry fee payments for one or more fantasy contests from a set of fantasy contests offered by the fantasy contest platform, choose one or more competitors and play contests based on the selected competitors or sports players.

FIG. 2B is a block diagram illustrating an example fantasy contest system 102 in accordance with some embodiments. In FIG. 2B, the fantasy contest system 102 comprises a contest management module 200, a contest participant management module 202, a user account module 204, a contest entry fee module 206, a contest entry fee pot module 208, a competitor performance module 210, and a contest outcome module 212.

Those skilled in the art will appreciate that the composition of the fantasy contest system 102 may vary between different embodiments. For some embodiments, one or more of the components of the fantasy contest system 102, such as the contest management module 200, are implemented using the client device 100.

The contest management module 200 may be configured to establish, maintain, or manage one or more fantasy contests, where fantasy contests may involve one or a plurality of contest participants and a plurality of real-world sports players scheduled to play in a set of real-world sports matches (e.g., NASCAR, football, basketball, baseball, hockey, soccer, or golf, etc.) over a set time period. The contest management module 200 may enable a contest administrator (e.g., by accessing the fantasy contest system 102 via one of the client devices 100) to initiate the creation of a fantasy contest to be maintained by the fantasy contest system 102, and to enter the specific parameters of the fantasy contest. Alternatively, the fantasy contest platform may act as contest administrator to initiate and maintain a plurality of fantasy contests.

Examples of parameters that may be entered for a fantasy contest can include, without limitation, a name of the fantasy contest, a real-world sports or real-world sports league to be associated with the fantasy contest, parameters of selecting real-world sports players (e.g., sports players from only certain sports teams, or sports players playing a certain position on their respective sports team), a set of real-world sports matches in which the real-world sports players will be participating, a plurality of contest participants to be associated with the fantasy contest (i.e., which users can/may join the fantasy contest or set of fantasy contests), the time period (e.g., duration) for the fantasy contest, initial account balance for each contest participant, how one or more winners are selected at the end of the fantasy contest time period, entry fee settings (e.g., minimum entry fees, required participation, etc.), settings relating to how contest participants can interact with the fantasy contest, and the like.

As noted herein, the set of real-world sports players that a contest administrator can select to associate with the fantasy contest may be predetermined by the fantasy contest system 102. The plurality of contest participants that the contest administrator associates with the fantasy contest may be permitted to join when they access the fantasy contest system 102 (e.g., via one of the client devices 100), and may further receive a message (e.g., via e-mail, direct text or other application) from the fantasy contest system 102 to inviting them to join the fantasy contest.

For some embodiments, joining the fantasy contest involves collecting information from candidate contest participant, such as contact information, login information, user preferences, and like, before the candidate contest participant becomes an enrolled contest participant.

The contest participant management module 202 may be configured to facilitate management of contest participants with respect to a fantasy contest. Functions performed by the contest participant management module 202 may include processes relating to contest participants joining the fantasy contest, sending invitations to individuals to join the fantasy contest (e.g., based on the contest administrator's settings), and management of contest participant's preferences.

A contest participant's preferences may assist the fantasy contest system 102 in determining (e.g., auto-generating), for the contest participant, a sports player selection for a fantasy contest when, for example, the contest participant fails to submit their selection before the commencement of the fantasy contest. Likewise, the contest participant's preferences may assist the fantasy contest system 102 in determining (e.g., auto-generating), for the contest participant, a contest for the selected sports player for the fantasy contest when, for example, the contest participant fails to submit their selection before the commencement of the fantasy contest.

The contest participant's preferences may indicate a default sports player (e.g., always select Peyton Manning) to be selected by the fantasy contest system 102 for fantasy contests when the contest participant fails to provide one, and may indicate a default selection (e.g., teams and/or players) or authorized entry fee amount(s) when the contest participant otherwise fails to provide specific input.

The user account module 204 may be configured to manage a plurality of user accounts associated with contestants participating in a fantasy contest. In particular, the user account module 204 may maintain a user account balance (e.g., money, points, credits, etc.) in each user account associated with a contest participant and may credit or deduct amounts from the user accounts based on entry fee amounts, entry fee pots, and sets of contest winners determined for a fantasy contest.

Such credits and deductions of amounts may occur as the before the time period of a fantasy contest commences, or after the time period of a fantasy contest expires and a set of contest winners is determined. In accordance with some embodiments, where a given contest participant is involved more than one fantasy contest, a contest participant's user account may include a unique entry or record for each fantasy contest in which the contest participant is involved.

With respect to a given fantasy contest, the user account module 204 is responsible for establishing, initializing, and associating a user contestant account with each contest participant that is associated with the given fantasy contest.

The contest entry fee module 206 may be configured to manage for a contest participant their selection of sports players and their contests based on selected sports players selected for fantasy contests. In particular, the contest account module 204 may collect and receive sports player selections, sports player selection changes, and entry fees, for a given fantasy contest, and may receive such submissions before the given real-world event begins.

When a contest participant submits an entry fee for the given fantasy contest, the contest entry fee module 206 may limit such contestant from entering fantasy contests based on the current account balance associated with that contestant/user, and may further limit entering new fantasy contests based on the contest participant's ratio of available account balance to total amount of entry fees already committed to other fantasy contests.

The sports player performance module 210 may be configured to obtain or otherwise receive a set of performance results for contestant selected sports players associated with a given fantasy contest. For some embodiments, the sports player performance module 210 obtains or receives the set of performance results for the selected sports players from two or more different information sources.

Examples of information sources can include, without limitation, news feeds, sports new feeds, blogs, organization web sites, social media (e.g., Facebook® or Twitter®), and the like. The sports player performance module 210 may use different information sources for based on the type of sports, sports matches, or sports players associated with the fantasy contest.

The contest outcome module 212 may be configured to identify a set of contest winners (i.e., one or more contest winners) when a given fantasy contest has concluded. To do so, the contest outcome module 212 may access and review a set of performance results provided by the sports player performance module 210, and determine a set of contest participant winners based on the parameters of the particular fantasy contest (e.g., a solo contestant, single round, head-to-head contest against the house, whether team-based or player-based, or a multi-contestant or multi-round competitions, as defined through the contest management module 200).

For some embodiments, the contest outcome module 212 identifies (e.g., declares) a set of one or more contest participant winners of the fantasy contest who have beat the house. Alternatively, contest outcome module 212 may identify one or more contest participants as ranked winners (e.g., 1st, 2nd, and 3rd place winners). The contest outcome module 212 may further provide a ranking of contest participants at the conclusion of the fantasy contest, which may be utilized in distributing winnings from a entry fee pot of a given fantasy contest.

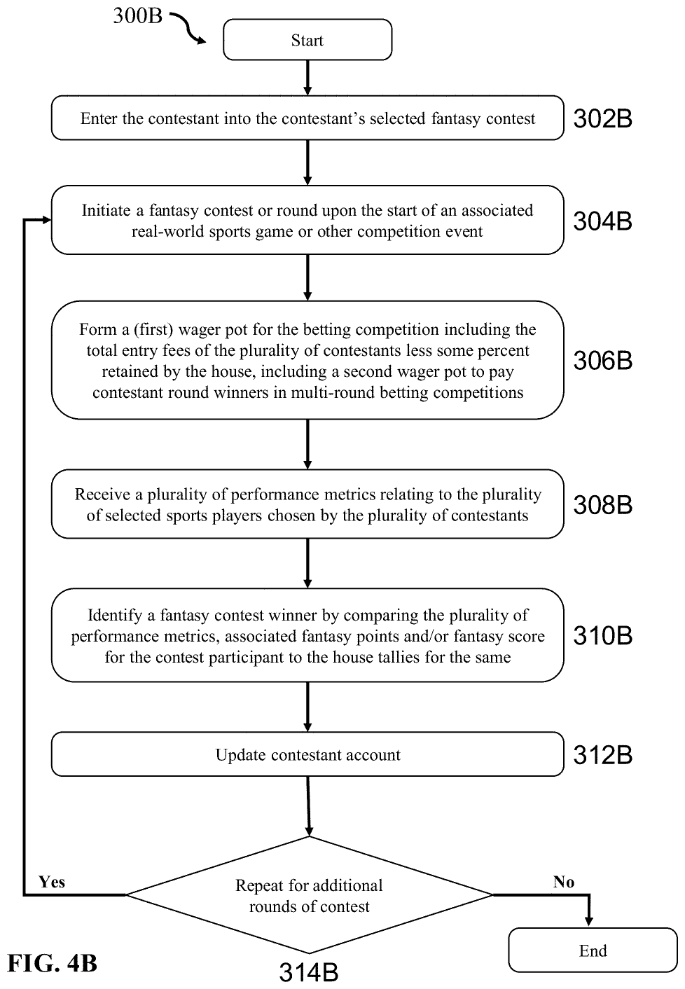

FIG. 3 is a block diagram illustrating an example digital data processing and remote/network communications device 100 (the “client device”) according to some embodiments. The client device 100 may comprise a processor 138, a memory system 136, a data storage system 156, a communication network interface 508, an I/O interface 140 (i.e., for managing I/O circuits 146, and I/O device drivers 158), and a display interface 512 communicatively coupled to a bus 148/149. The processor 138 may be configured to execute executable instructions (e.g., software application programs). In some embodiments, the processor 138 comprises circuitry or any processor capable of processing the executable instructions.

The memory system 136 is any memory configured to store data. Some examples of the memory system 136 are storage devices, such as RAM or ROM. The memory system may comprise the RAM cache. In various embodiments, data is stored within the memory system 136. The data within the memory system may be cleared or ultimately transferred to the storage system 156.

The storage system 156 is any storage configured to retrieve and store data. Some examples of the storage system 156 are flash drives, hard drives, optical drives, or magnetic tape. In some embodiments, the client device 100 includes a memory system 136 in the form of RAM and a storage system 156 in the form of flash data. Both the memory system 136 and the storage system 156 comprise computer readable media that may store instructions or programs that are executable by a computer processor including the processor 138.

The communication network interface (com. network interface) 508 may be coupled to a data network 104 via the link 516 (e.g., a wireless or wired link). The communication network interface 508 may support communication over an Ethernet connection, a serial connection, a parallel connection, or an ATA connection, for example. The communication network interface 508 may also support wireless communication (e.g., 802.11 a/b/g/n, WiMAX). It will be apparent to those skilled in the art that the communication network interface 508 may support many wired and wireless standards.

The optional input/output (I/O) interface 140 may be any device that receives input from the user and output data. The optional display interface 512 may be any device that may be configured to output graphics and data to a display system 244 and graphical user interface. In one example, the display interface 512 may be a graphics adapter that may include a graphical processing unit.

It will be appreciated by those skilled in the art that the client device 100 may comprise more or less hardware elements than those depicted. Further, hardware elements may share functionality and still be within various embodiments described herein. In one example, encoding or decoding may be performed by the processor 138 or a co-processor located on a GPU.

One or more functions may be stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

In another embodiment, such instructions can be configured for electronically submitting the at least one entry fee with respect to the at least one event during the round of the fantasy contest via a wireless or remote terminal or digital data processing and remote/networked communications device (i.e., the client device 100) and a communications network 104.

Additionally, as indicated herein, the client device 100 can be, for example, a Smartphone (e.g., iPhone, Android Phone, Blackberry), another hand held device such as, for example, a PDA (Personal Digital Assistant), a tablet computing device (e.g., iPad, etc.), a personal computer such as a desktop computer, a laptop computer, etc.

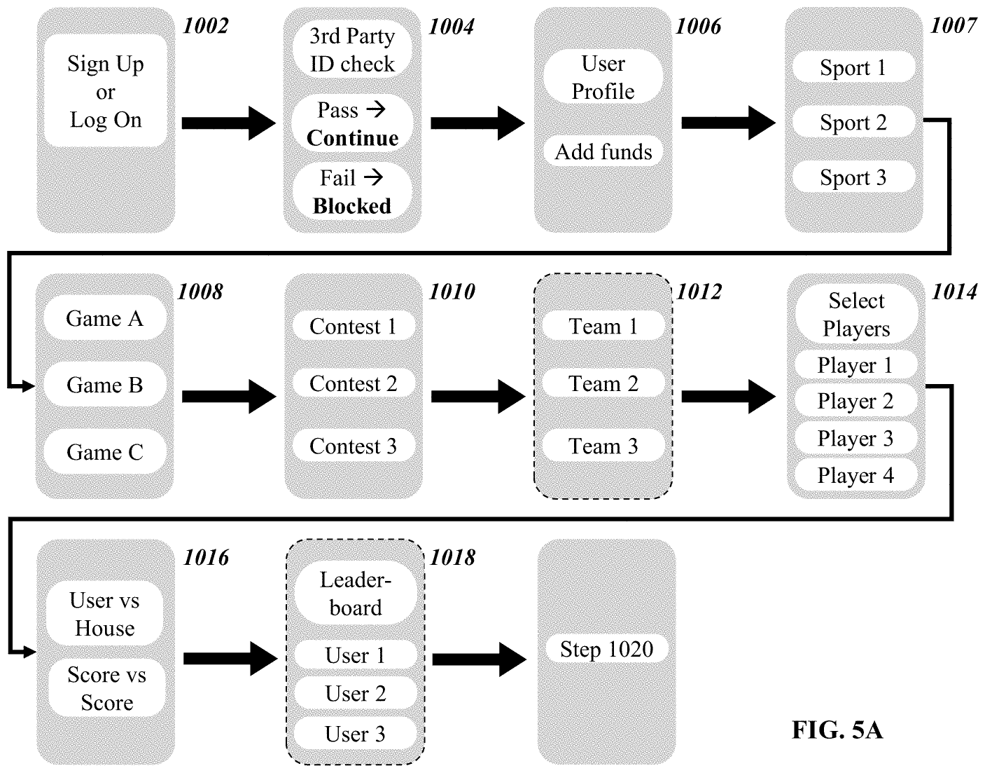

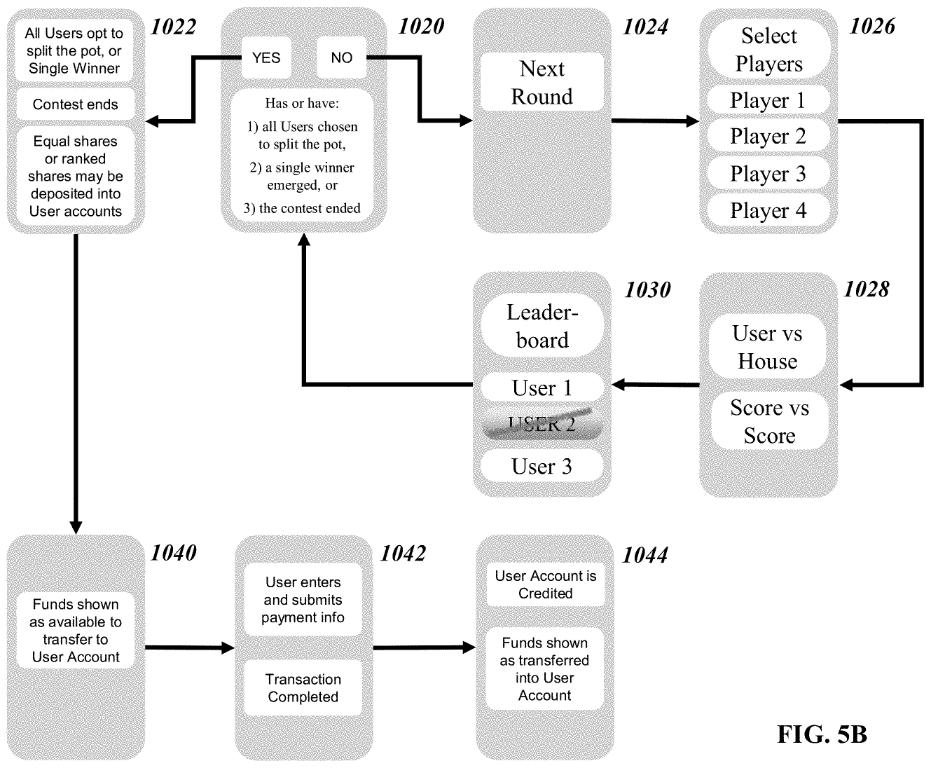

FIG. 4A is a flow diagram illustrating an exemplary embodiment of a fantasy contest method 300A in accordance with some head-to-head, contestant against the house or fantasy platform versions of the present invention. The method 300A begins at step 302A with creating and initializing one or more fantasy contests (e.g., via the contest management module 200) and setting various contest parameters, including 1) contest type, number of contestants, and number of contest rounds, 2) contest lineup structures, such as salary cap, number and type of positions, 3) selection of players for House Lineups, 4) amount of contest entry fees offered, and 5) amounts and structures for prizes of respective contests and rounds.

Next, in step 304A, the fantasy contest platform receives contestant competitor/sports player selections for Contestant Lineups, enters contestants into one or more contests selected by contestants, and collects and deposits contest entry fees into an entry fee pot (e.g., via the entry fee module 122 and entry fee pot module 208). In step 306A, the fantasy sports platform may further collect, receive and enter contestant changes to competitor selections for fantasy contest Contestant Lineups, for versions where the initial Contestant Lineup is not immediately locked in upon selection and entry into the contest—but in no instance later than the start of an associated real-world competition.

In step 308A, the fantasy sports platform initiates or commences a given fantasy contest upon the start of an associated real-world sports game or other competition event. Following the start of the fantasy contest, the fantasy contest platform obtains a plurality of performance metrics/statistics 128 relating to the plurality of competitors/sports players selected for the Contestant Lineups and House Lineups, in step 310A.

In step 312A, the fantasy contest platform identifies a winner of the fantasy contest or round (e.g., via the fantasy contest outcome module 212) by comparing the performance metrics 128, associated fantasy points and/or fantasy score for the contestant and house tallies of the same. In step 314A, the fantasy contest platform updates the user account accordingly (i.e., deposits prize winnings if the user is a contestant winner, or makes no deposit if the user is a contestant loser).

For multi-round embodiments, the fantasy contest platform determines additional rounds remain in step 316A and returns to step 304A to receive competitor selections from contestants, obtain performance metrics for respective lineups (310A), and determine round/contest winners (312A). For single-round embodiments, and for the final round of multi-round embodiments, the fantasy contest platform determines in step 316A that no additional rounds of contest play remain, and proceeds to end the present contest.

FIG. 4B is a flow diagram illustrating an exemplary embodiment of a fantasy contest method 300B in accordance with some survivor pool versions of the present invention. The method 300B begins at step 302B with the user account module 204 authorizing participation of and entering each contestant of a plurality of contest participants into the fantasy contest by paying the entry fee, or other charge required to enter the contest (e.g., via the entry fee module 122 and entry fee pot module 208).

For some embodiments, a fantasy contest is associated with a plurality of contest participants, and each contest participant in the plurality of contest participants is associated with a user account. Depending on the embodiment, the money, points or credits associated with a given contest participant may be maintained in a user account associated with the given contest participant.

At step 304B, the contest management module 200 may establish a set of fantasy contests in association with the plurality of contest participants, where each fantasy contest may be associated with a plurality of sports players scheduled to play in a set of sports matches over a time period. At step 306B the contest entry fee pot module 208 may form an entry fee pot for (e.g., in association with) a given fantasy contest in the set of fantasy contests (e.g., for at least one of the fantasy contests in the set).

For some embodiments, one or more separate entry fee pots are formed (i.e., established or created) for each fantasy contest in a set of fantasy contests. A given entry fee pot may be formed before the commencement of the fantasy contest to which it is associated. Once formed, the contest entry fee pot may include a plurality of entry fees, paid by the plurality of contest participants, to play in fantasy contests based on a plurality of selected sports players in the plurality of sports players.

At step 308B, for the given fantasy contest, the sports player or competitor performance module 210 may receive or otherwise obtain a plurality of competitor performance metrics 128 relating to the plurality of selected sports players or competitors associated with the given fantasy contest. Depending on the embodiment, the plurality of competitor performance metrics 128 may be received in one or more separate data transfers, and each data transfer may include the performance metrics of sports players not included in the plurality of selected sports players.

For some embodiments, the plurality of competitor performance metrics 128 is received in the form of fantasy points associated with a sports player, and such fantasy sports may be received (or otherwise obtained) from more than one fantasy sports source or system (e.g., Yahoo®, ESPN®, NFL.com, etc.).

At step 310B, for the given fantasy contest, the contest outcome module 212 may identify from the plurality of contest participants a set of contest winners based on the plurality of performance metrics received (or obtained) at step 308B. At step 312B, for the given fantasy contest, the user account module 204 may update the account balance (i.e., the money, points or credits) associated with each contest participant of the plurality of contest participants based on the determined set of contest winners (e.g., multiple contest winners of solo contestant, single round head-to-head contests against the house and/or multiple contest winners of multi-contestant fantasy contests), based on the plurality contest entries, and based on the entry fee pot.

For example, based on respective fantasy scores the contest outcome module 212 may determine the set of contestant winners that have beaten the house, or, e.g., the top three contest winners (e.g., 1st, 2nd and 3rd place winners), based on the performance metrics of their respective selected sports players. For unranked classes of winners in multi-contestant, multi-round embodiments, the contest winners may all receive an equal portion of the entry fee pot.

For ranked classes of winners in multi-contestant, multi-round embodiments, the top three contestants/users may collect winnings from the entry fee pot according to their respective rankings. In particular, the first place winner may collect from the entry fee pot a maximum amount, the second place winner a second most amount, and the third place winner a third most amount, with all other winners that have beat the house receiving an equal share of a remaining pot.

Importantly, in a preferred embodiment of the present invention, if all contestants in a multi-contestant, multi-round fantasy contest lose to the house, the house pays all contestants of the final round ranked shares or an equal share of one or more of the first and second pots.

At step 314B, if there are additional rounds in the fantasy contest, some or all of the steps 306B-312B may be repeatedly performed with respect to each of those additional fantasy contest rounds. It will be understood that for some embodiments, the steps of method 300A and 300B may be performed in parallel with respect to different fantasy contest rounds, such as when a first round is established and a second round may be established before the first round has ended.

Though the steps of the method 300A and 300B may be depicted and described in a certain order, those skilled in the art will appreciate that the order in which the steps are performed may vary between different embodiments. Additionally, those skilled in the art will appreciate that the components described above with respect to the method 300A and 300B are merely examples of components that may be used with the method 300A and 300B, and that other components may also be utilized in some embodiments.

The mobile application described herein provides users a unique way to play in fantasy sports contests based on their favorite sports, day after day, week after week. Some fantasy contests may take only a few hours and some fantasy contests may take days or even weeks or months to complete (e.g., multi-round fantasy contest embodiments, such as multi-week survivor pool embodiments in football, baseball, basketball, hockey, etc.).

When one or more users or contest participants survive the entirety of a multi-contestant, multi-round contest, they shall receive one or more prizes the entry fee pot (e.g., money, points or credits). The entry fee pot comprises the total amount of all entry fees, the sum of money, points or credits that equals the total number of entrants multiplied by the entry fee less some percent (e.g., 10%-25%) retained by the house.

Users can view their profiles, current funds available and add more funds functionality, past contests, personal scores, winnings and other stats, as compared to competitors on a leaderboard or as compared house stats, competitors' scores and winnings.

Users that survive a given round move on to the next round, until they are eliminated or become a winner. In certain preferred embodiments of the present invention, users may only use a team and its players once in each contest. Teams already used will be either greyed out or crossed out. The process then repeats until there is a winner. In preferred embodiments of the present invention ties with the house will lose. In some embodiments, ties with the house may win.

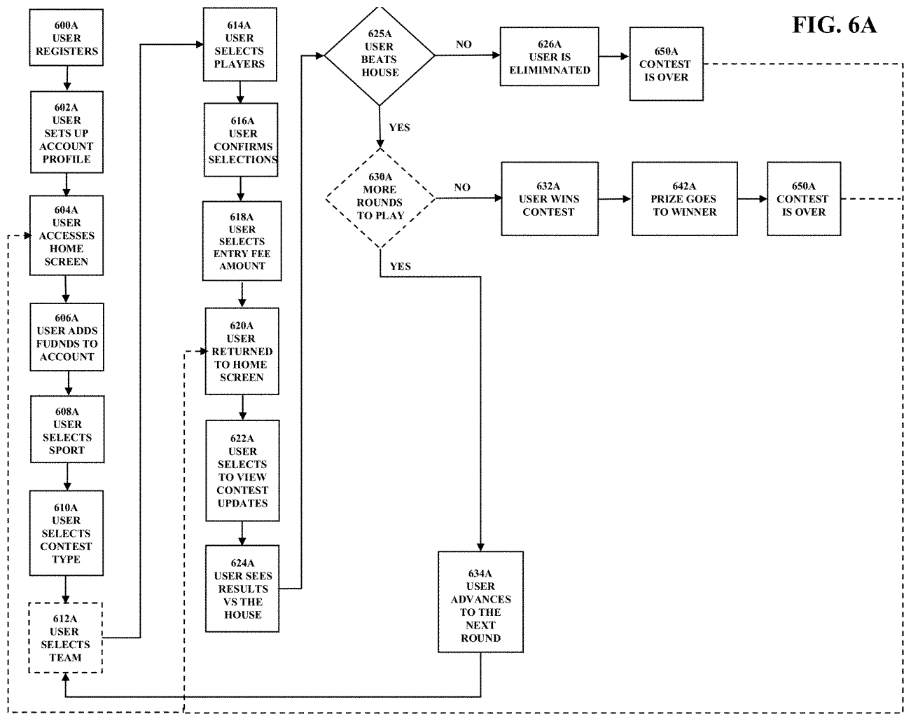

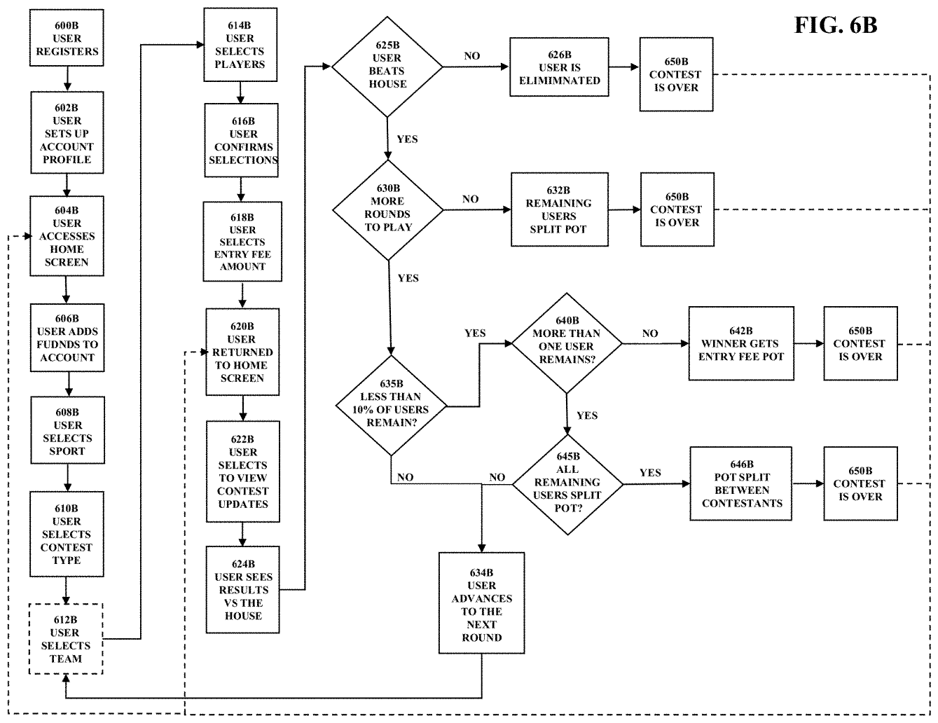

FIG. 5A depicts the process flow of a method for enabling a user to sign up and log on to the fantasy contest platform, add funds, select contests and enter and track fantasy contests. The process flow of FIG. 5A depicts a universal process for both single contestant and multi-contestant, single round and multi-round gameplay.

Specifically, step 1002 illustrates user signup or login into the fantasy contest platform.

Step 1004 illustrates user identity verification, e.g., by a third-party service provider. Upon successful registration or login and passing a 3rd party ID check, the user or contest participant is enabled to edit their user profile and update their account balance.

Step 1006 illustrates access to the user profile, and the ability to add more funds to a user or contest participant account.

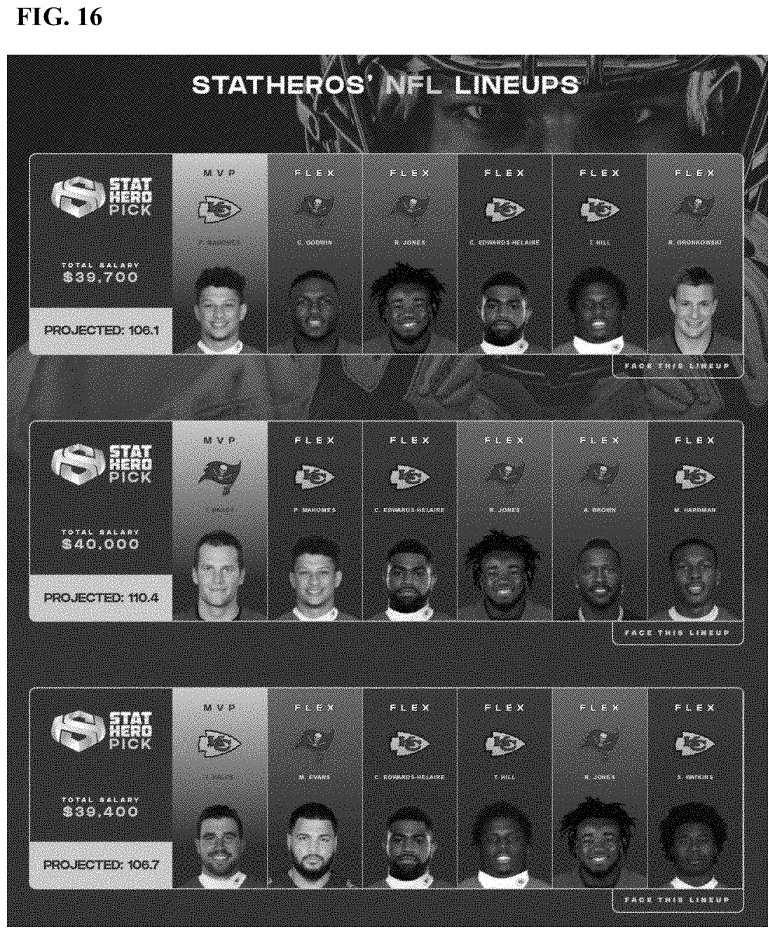

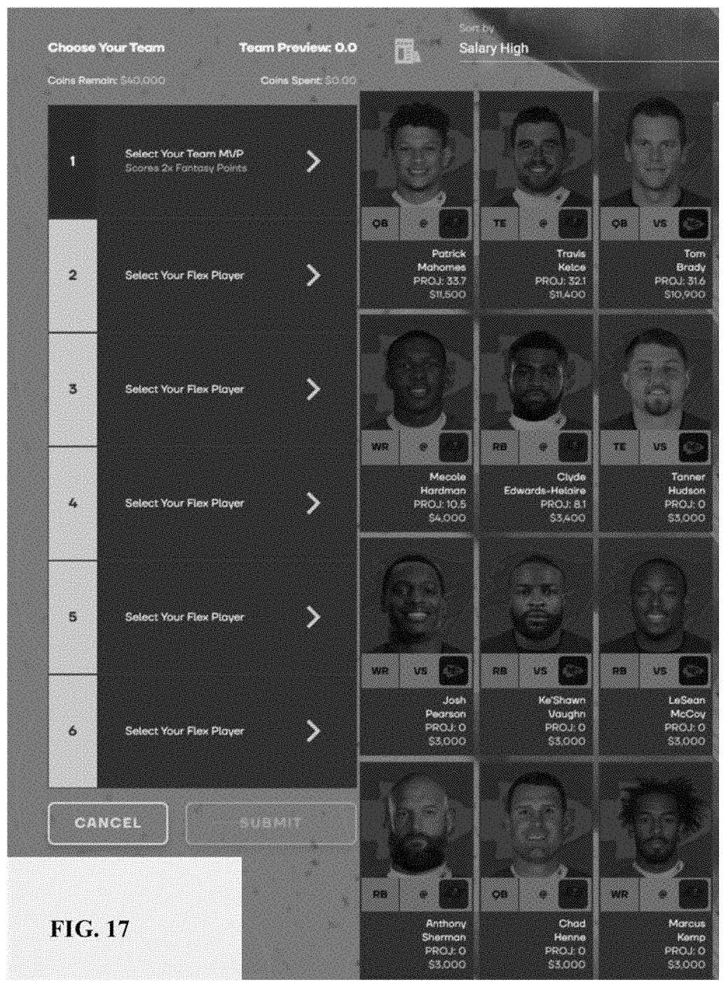

Step 1007 illustrates user access to the StatHero navigation screen (e.g., a home screen from which the user may select type of contest to enter, for example based on which sports or fantasy contests are of interest to them—see FIGS. 14-15).

Step 1008 illustrates a screen enabling a user to choose from several different game types, each with its own rules (e.g., potential games may be centered on the National League conference of the MLB, or possibly the AFC teams in the NFL). Yet further options include half-season contests, weekly and monthly contests, and even daily contests for sports or competitions with appropriate event schedules. The mobile application will accommodate a variety of user tastes and preferences for contest structures. Once users select the type of sports game or other competition they want to play, they are enabled to choose specific fantasy contests.

Step 1010 illustrates a screen enabling a user to select specific fantasy contests, which are typically set apart by the number of entrants allowed to enter and entry fee amounts.

Step 1012, depicted with a dotted line border to indicate the step is an optional step implemented for embodiments that require contestants to select a specific team for team-based gameplay embodiments, illustrates a screen enabling a user to select the specific team they think has the best players that will score the most fantasy points, as compared to the team and/or players selected and posted by the house.

Step 1014 illustrates a screen enabling a user to select three or more players from the same team they have just selected.

Step 1016 illustrates a screen enabling a user to view their player fantasy scores and their fantasy score totals, in real-time versus the house selections.

Step 1018 illustrates a screen providing an alternate view for users to track where everyone stands in a given fantasy contest.

FIG. 5B depicts a process flow extension to the process flow depicted in FIG. 5A for multi-contestant, multi-round gameplay embodiments. As shown in FIG. 5B, step 1020 illustrates a screen providing the “split the pot” option scenario, where the system or method steps evaluate whether the remaining number of contest participants has fallen below some threshold, e.g., less than fifty percent (50%), less than ten percent (10%), etc. If the number of contest participants remaining in a given fantasy contest has fallen below the set threshold, the system or methods evaluate whether a single winner has emerged.

If a single winner has emerged, the winner is declared, the contest is ended and the winner's account balance is updated accordingly. If the remaining number of contest participants is below the threshold, but a single winner has not emerged, the remaining contestants, those still standing and participating in the contest, receive a prompt (e.g., an auto alert in app, in an email, text or other appropriate mode of communication) to provide those remaining contestants with the option to split the pot, thereby ending the contest early and dividing the contest winnings accordingly (e.g., equally among all contestants or according to ranking or total fantasy point score of the contestants, etc.), in step 1022.

In step 1020, where the remaining number of contestants has fallen below the threshold level, each contest participant makes their respective selection of whether to participate in a “split the pot” scenario or to remain in the contest. The group decision of whether to split the pot may be made by consensus, super-majority, or majority.

If the number of contest participants remaining in the contest is greater than the set threshold at step 1020, the system evaluates whether the contest has ended. If a contest proceeds to conclusion, without an affirmative decision by the contest participants to split the pot, and before a single winner emerges, then the remaining contestants are declared winners of the fantasy contest.

The contestants may be ranked by place (e.g., first, second, third, etc.) based upon the total number of fantasy points accrued by all of the sports players selected by each of the respective contestants, with amount of payment to winning contestant account balances depending upon their respective rankings. Alternatively, all remaining contestants may receive an equal share of the winnings.

As depicted in FIG. 5B, at step 1020, if the contest has not ended and no single winner has emerged, the contest proceeds to the next round of the fantasy contest, in step 1024, leading through steps 1026-1030, correlating respectively to steps 1014-1018 (FIG. 5A).

Steps 1024-1030 illustrate that the contest continues to the next round, unless all remains users agree to spit the pot, a single winner emerges, or multiple winners are left at the end of a contest. After falling below the remaining-users threshold, the process repeats each round with the possibility to split the pot, until the contest concludes.

Steps 1022-1044 illustrate what happens when all users agree to split the pot, a winner emerges, or there are multiple winners left at the end of a contest. The contest has ended, and accounts are credited with the winnings split evenly among those remaining.

Step 1040: Illustrates a screen showing funds as available to transfer to the account balance of a contest participant, upon winning.

Step 1042: Illustrates a screen enabling a user to enter payment details, and processing of the funds transfer or payment transaction to the contest participant account.

Step 1044: Illustrates a screen indicating funds credited and transferred into the contestant's account.

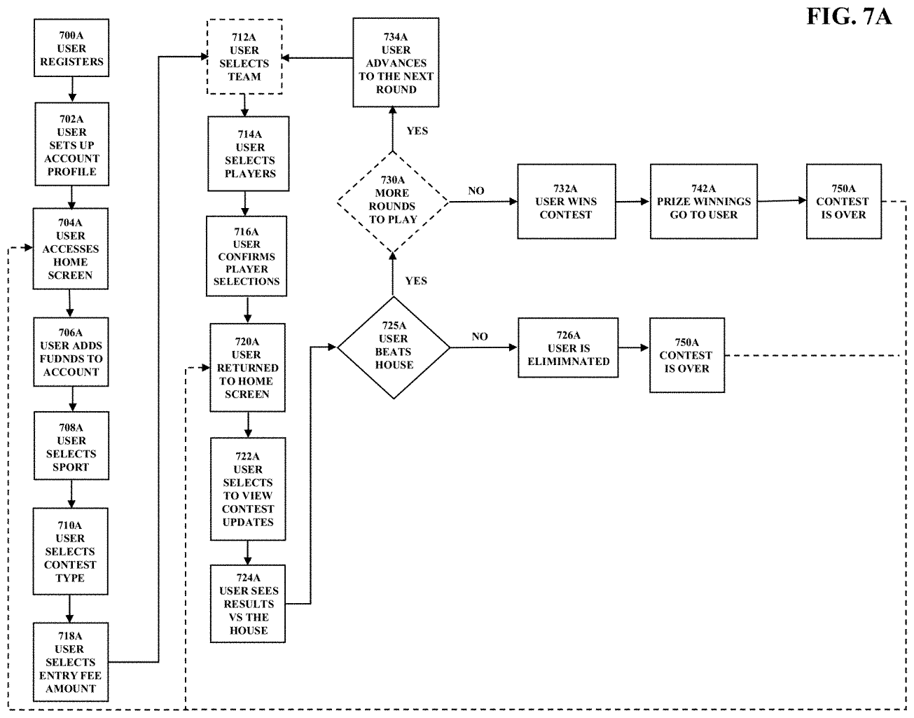

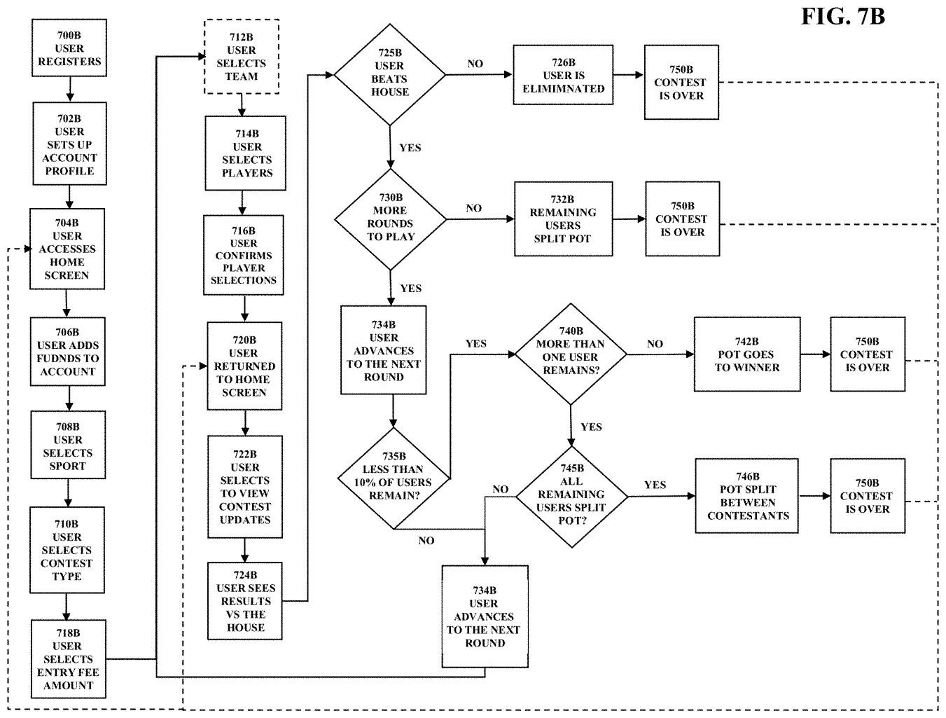

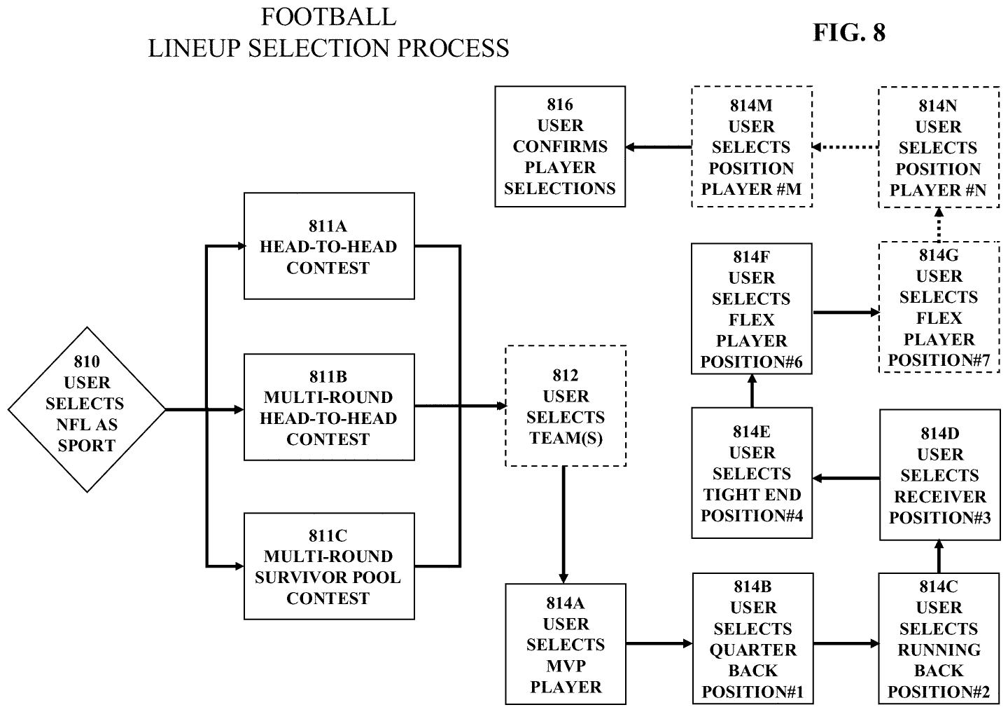

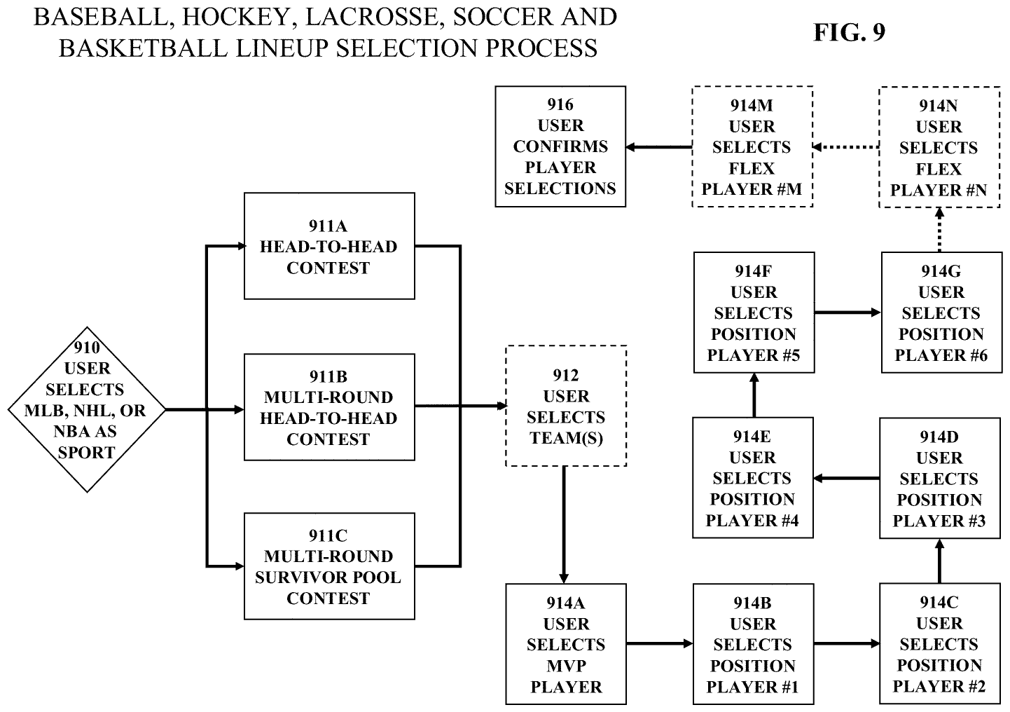

FIG. 6A and FIG. 7A illustrate an exemplary process flow diagram for a method enabling user registration, logon, profile management including updating account balance, and selection and tracking of head-to-head fantasy contests, between the contestant and the house of the fantasy contest platform. As depicted in FIG. 6A and FIG. 7A, at step 600A/700A, the system or methods provide for user registration. In step 602A/702A, the user sets up their account profile, including payment information.

At step 604A/704A, the user accesses the fantasy contest platform navigation page (e.g., home page), where the user is then enabled to add funds to their account balance (step 606A/706A) and to select a head-to-head contest type, e.g., single-round or multi-round in step, 608A/708A. In step 610A/710A, the user selects the sport or type of competition.

In step 612A/712A, the user may be enabled to select one or more specific sports teams (for embodiments that are not based solely on selection of sports players and include a team selection requirement). In step 614A/714A, the user may be enabled to select one or more competitors or sports players. In embodiments including team selection, the user or contestant will be limited to select players associated with the specific team(s) selected in 612A/712A. In step 616A/716A, the user may be prompted to confirm player selections.

In step 618A/718A, the user may further be enabled to select amount of contest the entry fee. The primary distinction between FIG. 6A and FIG. 7A is that in FIG. 7A, step 718A has been moved to occur between steps 710A and 712A, rather than in numerical order.

In steps 620A-624A (steps 720A-724A), the user is subsequently returned to the navigation page (e.g., home page) (step 620A/720A), enabled to select to view contest status updates (step 622A/722A), and also enabled to view status or results of the fantasy contest between the contestant and the house (624A/724A).

In step 625A/725A, the systems or method steps of the present invention evaluate whether a user or contestant has beat the house (e.g., via the contest outcome module 212). If the user has not beat the house, the contestant loses and is eliminated from the fantasy contest (step 626A/726A) and the contest is concluded (step 650A/750A). If the contestant/user successfully beats the house in step 625A/725A, for single round fantasy contests, the contestant wins and the contest is over (step 650A/750A).

For multi-round fantasy contests where the contestant beats the house in step 625A/725A, the systems or method steps of the present invention evaluate, in step 630A/730A, whether there are more rounds to play in the fantasy contest. If no rounds of play remain, the contestant wins, step 632A/732A and receives the prize winnings (step 642A/742A), and the contest is concluded in step 650A/750A.

Following conclusion of a given contest in step 650A/750A, the contestant is enabled to return to their current contests, and re-enters the process in step 620A/720A or 604A/704A, at the navigation screen (e.g., home page), where the user/contestant may select specific contests to view status updates (step 622A/722A) or add funds (step 606A/706A) and select new contests from step 608A/708A, respectively.

In step 630A/730A, optionally included in multi-round embodiments, if the system or method steps of the present invention determine that additional rounds of play remain in the present fantasy contest, contestant advances to the next round of play in step 634A/734A and is enabled to select new teams and/or competitors or sports players for the next round of contest play (steps 612A/712A and 614A/714A, respectively). This process continues until the contest finally concludes (step 650A/750A).

FIG. 6B and FIG. 7B illustrate an exemplary process flow diagram for a method enabling user registration, logon, profile management including updating account balance, and selection and tracking of multi-contestant survivor pool fantasy contests, as between the contestants and the house of the fantasy contest platform. As depicted in FIG. 6B and FIG. 7A, at step 600B/700B, the system or methods provide for user registration. In step 602B/702B, the user sets up their account profile, including payment information.

In step 604B/704B, the user is enabled to add funds to their account balance. At step 606B/706B, the user accesses the fantasy contest platform navigation page (e.g., home page), where the user is enabled to select a sport, in step 608B/708B. In step 610B/710B, the user selects the type of contest (e.g., number of contest rounds).

In step 612B/712B, the user may be enabled to select one or more specific sports teams (for embodiments that are not based solely on selection of sports players and include a team selection requirement). In step 614B/714B, the user may be enabled to select one or more competitors or sports players. In embodiments including team selection, the user or contestant will be limited to select players associated with the specific team(s) selected in 612/B/712B. In step 616B/716B, the user may be prompted to confirm player selections.

In step 618B/718B, the user may further be enabled to select amount of the entry fee. The primary distinction between FIG. 6B and FIG. 7B is that in FIG. 7B, step 718B has been moved to occur between steps 710B and 712B, rather than in numerical order.

In steps 620B-624B (steps 720B-724B), the user is respectively returned to the navigation page (e.g., home page) (step 620B/720B), enabled to select to view contest status updates (step 622B/722B), and also enabled to view status or results of the fantasy contest between the contestant and the house or between the contestant and other contestants (624B/724B).

In step 625B/725B, the systems or method steps of the present invention evaluate whether a user or contestant has beat the house (e.g., via the contest outcome module 212). If the user has not beat the house, the contestant loses or is eliminated from play in the fantasy contest (step 626B/726B) and the contest is concluded for that contestant/user (step 650B/750B).

If the contestant/user successfully beats the house in step 625B/725B, the systems or method steps of the present invention then evaluate, in step 630B/730B, whether there are more rounds to play in the fantasy contest. If no rounds of play remain, the remaining users split the pot, or in the case of a single winner, the contestant wins the entire entry fee pot, step 632B/732B, and the contest is concluded in step 650B/750B.

In step 630B/730B, if the system or method steps of the present invention determine that additional rounds of play remain in the present fantasy contest, contestants/users advance to step 635B/735B, where the system or method steps of the present invention evaluate whether the remaining number of contest participants has fallen below some set threshold value (e.g., less than fifty percent (50%), less than ten percent (10%), etc.).

If the threshold is met, the systems and methods of the present invention next determine whether more than one contestant remains in step 640B/740B. If only one contestant remains, that contestant wins and the prize from the entry fee pot is transferred to the winning contestant (step 642B/742B) and the contest is concluded in step 650B/750B. If more than one contestant remains in the fantasy contest, the process continues to step 645B/745B, where all remaining contest participants are prompted with the option to split the pot or continue in the fantasy contest.

If all (consensus) or some portion (supermajority or majority) of the remaining contestants choose to split the pot, the entry fee pot will be split amongst the remaining contestants (step 646B/746B) and the contest is concluded (step 650B/750B). In such cases, the entry fee pot may be split equally among the winning contestants or may be shared (i.e., amounts paid out) according to rank or place of the respective contestants.

In step 645B/745B, if the threshold of contestants required to result in a “split the pot” scenario is not met, then the contestants/users are advanced to the next round (step 634B/734B), and are enabled to select new teams and/or competitors or sports players for the next round of contest play (steps 612B/712B and 614B/714B, respectively). This process continues until the contest finally concludes (step 650B/750B), by elimination of the contestant in question, the contestant in emerges as the sole winner of the contest, or the threshold number of contestants selecting a “split the pot” scenario is met.

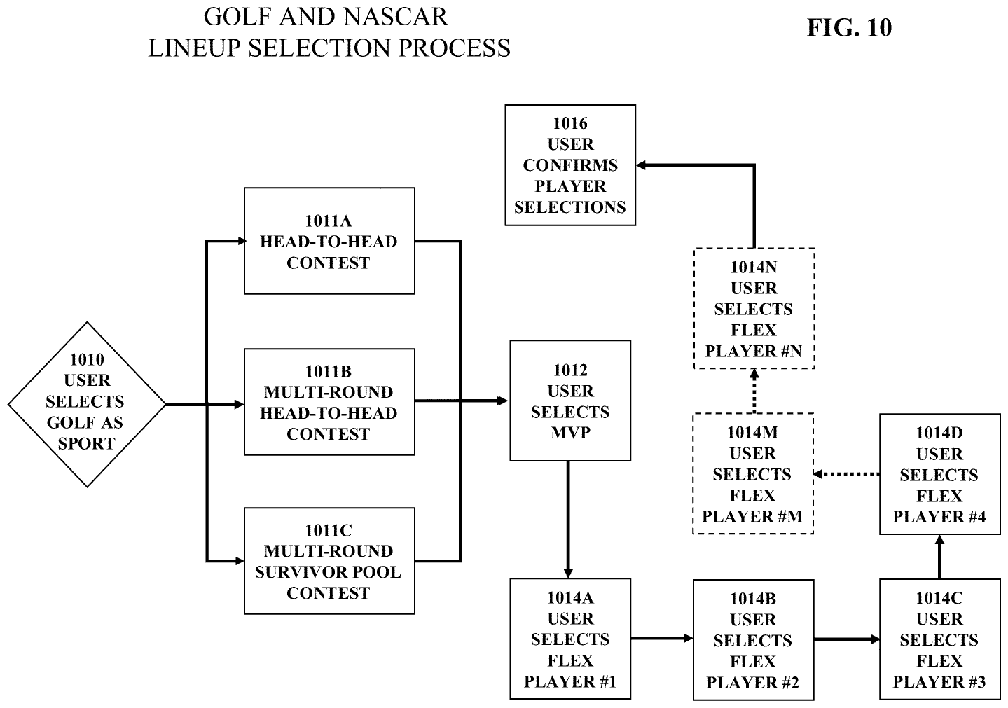

FIGS. 8-10 depict examples of submodules implementing contest types for football, baseball, hockey and basketball, and golf, respectively. Steps 811A, 811B, and 811C of FIG. 8 depict examples of the different types of contests that may be selected for football in steps 610A, 610B, 710A and 710B, of FIGS. 6A, 6B, 7A and 7B, respectively. Optional step 812 includes selecting a team, for team-based embodiments. The number of competitors selected for lineups include one or more players, typically between one to ten players, preferably between two to eight players, and most preferably between three to six players.

In steps 814A-814G, for regular season gameplay the contestant may be required to select an MVP competitor, whose fantasy points are doubled for purposes of calculating a contestant's fantasy score, and one or more of a quarterback, a running back, a receiver, a tight end and one or more flex player positions (see steps 814M-814N), respectively. Alternatively, in playoff or finals gameplay, the contestant may be required to select an MVP competitor and at least two flex player positions, and up to 5 to 10 flex player positions (see steps 814M-814N). For multi-round contests, the number of rounds will never exceed the number of teams or, in the cases of individual competitor competitions, the number of individuals that compete in the real-world competitions.

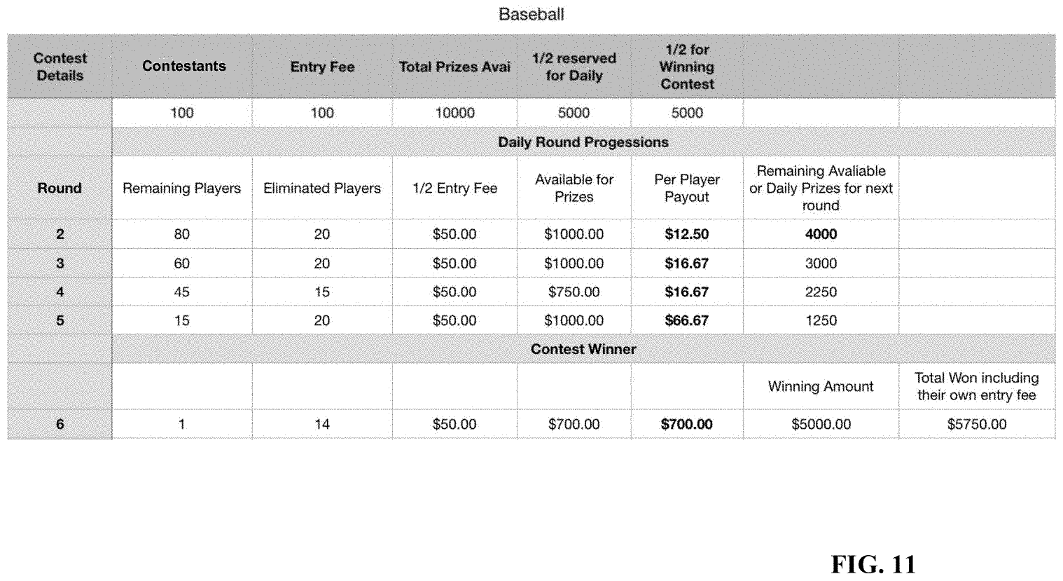

Steps 911A, 911B, and 911C of FIG. 9 depict examples of the different types of contests that may be selected for baseball, hockey and basketball in steps 610A, 610B, 710A and 710B, of FIGS. 6A, 6B, 7A and 7B, respectively. Optional step 912 includes selecting a team, for team-based embodiments. The number of competitors selected for lineups include one or more competitors, typically between one to ten competitors, preferably between two to eight competitors, and most preferably between three to six competitors.

In steps 914A for regular season gameplay the contestant may be required to select an MVP competitor, whose fantasy points are doubled for purposes of calculating a contestant's fantasy score. In addition to the MVP, for steps 914B-914G 1) in basketball, the contestant may be required to select one or more of a Forward, a Guard, a Center and one or more flex player positions (see steps 914M-914N), 2) in baseball, the contestant may be required to select one or more of a Pitcher, a Catcher, two (2) infielders, two (2) outfielders, and one or more flex player positions (see steps 914M-914N), and 3) for hockey, lacrosse and soccer, the contestant may be required to select one or more of a Center, a Winger, a Goalie, a Defense position, and one or more flex players (see steps 914M-914N), respectively.

Alternatively, in playoff or finals gameplay, the contestant may be required to select an MVP competitor and at least two flex player positions, and up to 5 to 10 flex player positions (see steps 914M-914N). For multi-round contests, the number of rounds will never exceed the number of teams or, in the cases of individual competitor competitions, the number of individuals that compete in the real-world competitions.

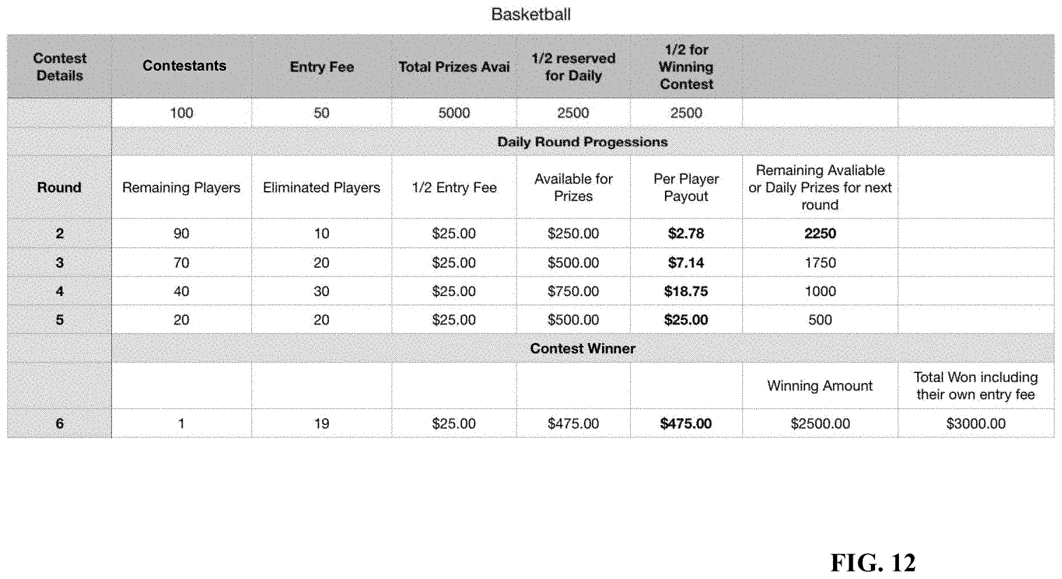

Steps 1011A, 1011B, and 1011C of FIG. 10 depict an example contest type that may be selected for golf, racing (e.g., NASCAR) and for any other single/individual competitor-based competitions, in steps 610A, 610B, 710A and 710B, of FIGS. 6A, 6B, 7A and 7B, respectively. The number of competitors selected for lineups include one or more competitors, typically between one to ten competitors, preferably between two to eight competitors, and most preferably between three to six competitors. In step 1012, the contestant selects an MVP. In addition to the MVP, for steps 1014A-1014D, the contestant may be required to select one or more flex players, up to any number of flex players (see steps 1014M-1014N).

For instance, with golf or NASCAR, fantasy contests may be based on the tournaments (e.g., PGA), with each day of a tournament potentially comprising a round in the fantasy contest for multi-round versions. For each day, the house may pick five golfers and the contestants may pick five golfers. In subsequent rounds, only two golfers may be the same as the contestant's prior selections, and the same rule applies to the house.

In each of these examples, contestants may select one or more sports players. In certain embodiments, the sports players may be required to be selected from a single team. In certain other embodiments, the sports players chosen may be selected from two or more sports teams. In certain further embodiments, the sports players chosen may be selected from a primary sports team with a single player selected as a ‘wild card’ from a second sports team or from an arbitrary list of sports players permissible to select as a wild card (e.g., kickers).

For multi-round, survivor pool embodiments, payout structures for rounds and contests may differ significantly from the more simplistic payouts implicated in head-to-head contests, which are solely and directly conducted between a single contestant and the house of the fantasy contest platform. For instance, consider the following examples of survivor pool, multi-round contest payout structures:

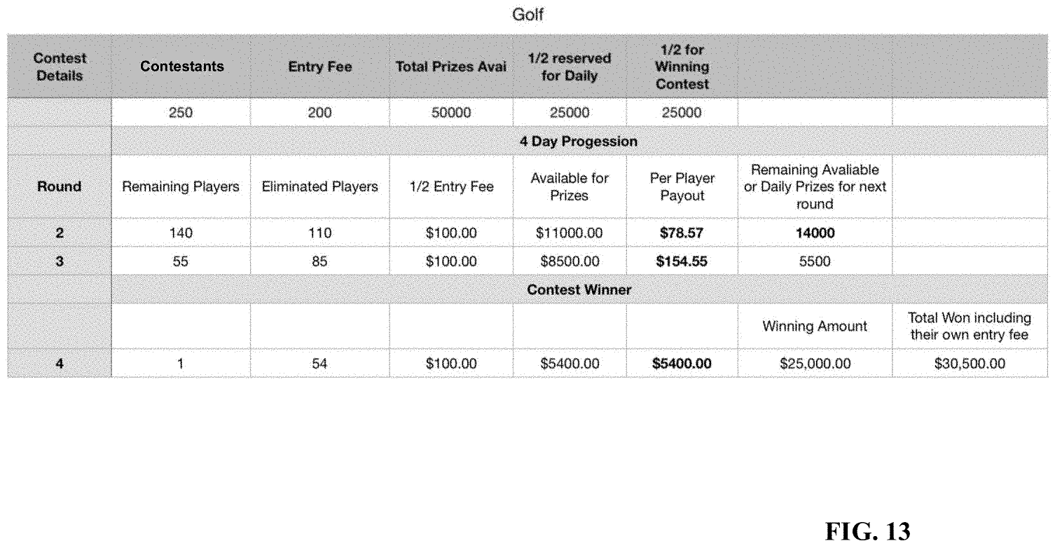

FIG. 11 depicts a table portraying the payout structure for an exemplary fantasy contest based on a baseball fantasy sports format. In this figure, contestants are referred to as players.

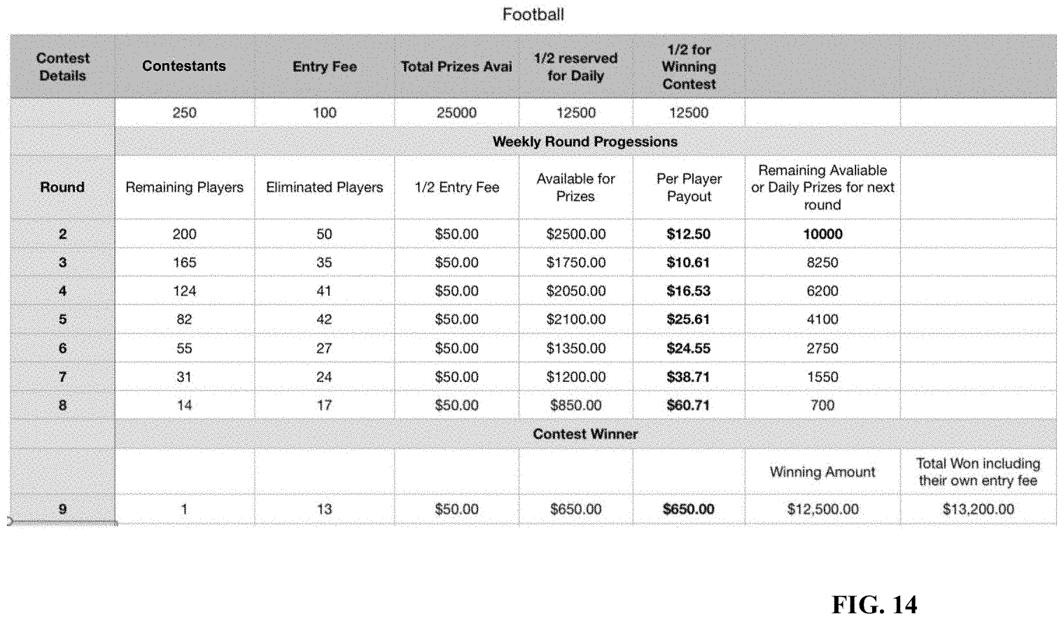

FIG. 12 depicts a table portraying the payout structure for an exemplary fantasy contest based on a basketball fantasy sports format. In this figure, contestants are referred to as players.

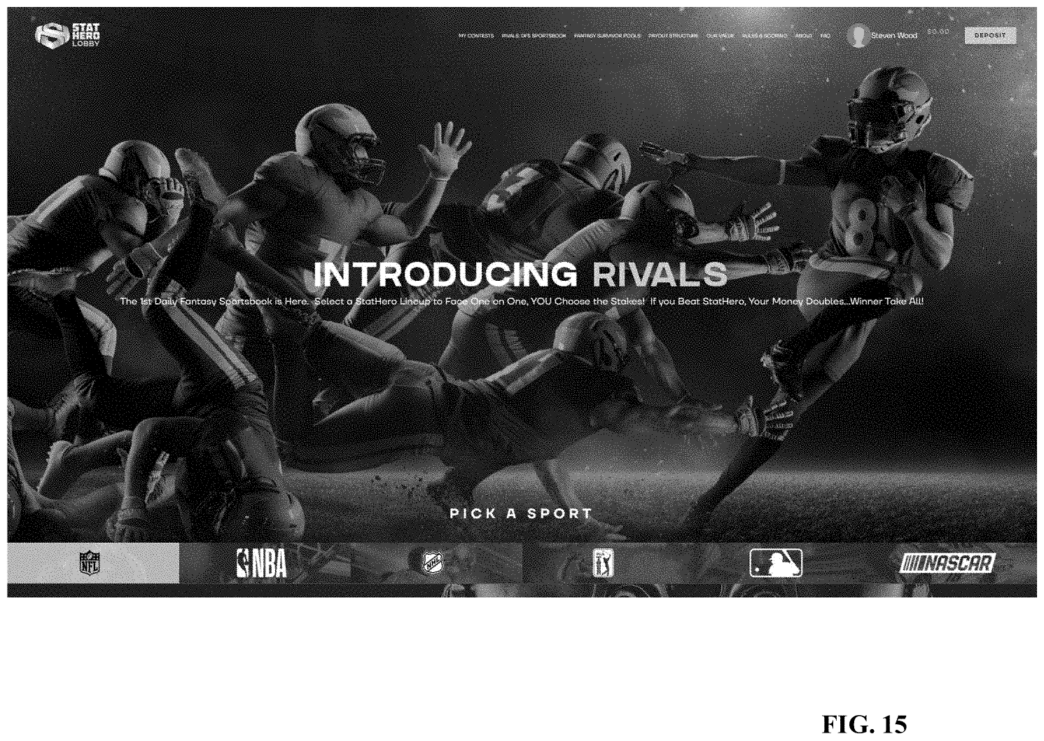

FIG. 13 depicts a table portraying the payout structure for an exemplary fantasy contest based on a golf fantasy sports format. In this figure, contestants are referred to as players.

FIG. 14 depicts a table portraying the payout structure for an exemplary fantasy contest based on a based on a football fantasy sports format. In this figure, contestants are referred to as players.

As a further example, consider 50 entrants in a contest with a fifty-dollar ($50.00) entry fee would net a total available pool in the entry fee pot of one thousand eight hundred seventy-five dollars (USD $1,875.00). To demonstrate, 50×$50.00=$2,500.00.25%=0.25. 0.25×$2,500.00=$625.00. $2,500.00−$625.00=$1,875.00.

In addition to a unique pot splitting structure, the present invention also comprises a unique payout scheme, whereby the surviving contestants of any given fantasy contest or fantasy contest round receive some minimum payout, irrespective of whether the users elect to participate in an early termination of the fantasy contest and a multi-way split payout.

For example, assuming a first exemplary fantasy contest includes 100 users, each paying a $100 contest entry fee. That totals $10,000.00. Say the house takes $2,500.00 for operating the fantasy contest. We have a total pot of $7,500.00 that can be paid out to the users in any number of various ways.

In one embodiment of the present invention, the $7,500.00 total pot of this first exemplary fantasy contest may be split in half for a “prize pot” of $3,750.00, to be paid out to one or more winners, and a “multi-round payout pot” of $3,750.00 to be paid out to every user surviving some arbitrary round, such as the first round, second round or third round, etc., and potentially including additional payout in one or more subsequent rounds.

In a preferred embodiment of the present invention, the pro-rata value of the multi-round payout pot is set at the start of the first round of this first exemplary fantasy contest. $3,750.00 of the multi-round payout pot, divided by 100 users in the fantasy contest, equals $37.50 ($3,750.00/100=$37.50) per user.

Then, say that 30 users are eliminated at the completion of the first round of this first exemplary fantasy contest. According to the novel payout scheme of the present invention, 30 times $37.50 equals $1,125.00 (30×$37.50=$1,125.00) for the round payout pot that is paid out to the first round ‘winners’ or surviving users. With 70 users beating the house, the round payout is $1,125.00 divided by 70, and equals $16.07 ($1,125.00/70=$16.07) per user.

Then, let's say that in this first exemplary fantasy contest, after the second round 50 users are eliminated, leaving only 20 users remaining. The same math would apply, with 50 times $37.50 equal to $1,875.00 (50×$37.50=$1,875.00) for the round payout pot. Dividing by 20, we get $93.75 per surviving user. This can continue until the multi-round payout pot is exhausted or the fantasy contest concludes with one or more winners splitting the remainder of the multi-round payout pot as well as the prize pot.

As another example of the novel payout scheme of the present invention, let's say in this second exemplary fantasy contest that we have 1,000 users who have paid a $100.00 contest entry fee. That totals $100,000.00. Say the house takes $25,000.00 for operating the fantasy contest. We have a total pot of $75,000.00 that can be paid out to the users in any number of various ways.

In one embodiment of the present invention, the $75,000.00 total pot of this second exemplary fantasy contest may be split in half for a “prize pot” of $37,500.00, to be paid out to one or more winners, and a “multi-round payout pot” of $37,500.00 to be paid out to every user surviving some arbitrary round, such as the first round, second round or third round, etc., and potentially including additional payout in one or more subsequent rounds.

In a preferred embodiment of the present invention, the pro-rata value of the multi-round payout pot is set at the start of the first round of this second exemplary fantasy contest. $37,500.00 of the multi-round payout pot, divided by 1,000 users in the fantasy contest, equals $37.50 ($37,500.00/1000=$37.50) per user.

Then, say that 900 users are eliminated at the completion of the first round of this second exemplary fantasy contest. According to the novel payout scheme of the present invention, 900 times $37.50 equals $33,750.00 (900×$37.50=$33,750.00) for the round payout pot that is paid out to the first round ‘winners’ or surviving users. With only 10 users beating the house, the round payout is $33,750.00 divided by 100, and equals $337.50 ($33,750.00/100=$337.50) per user.

Then, let's say that in this second exemplary fantasy contest, after the second round 5 users are eliminated, leaving only 5 users remaining. The same math would apply, with 5 times $37.50 equal to $187.50 (5×$37.50=$187.50) for the round payout pot. Dividing by 5, we get $37.50 ($187.50/5=$37.50) per surviving user. This can continue until the multi-round payout pot is exhausted or the fantasy contest concludes with one or more winners splitting the remainder of the multi-round payout pot as well as the prize pot.

Using the same starting numbers for a third exemplary fantasy contest, let's say that 200 users are eliminated at the completion of the first round of this third exemplary fantasy contest. According to the novel payout scheme of the present invention, 200 times $37.50 equals $7,500.00 (200×$37.50=$7,500.00) for the round payout pot that is paid out to the first round ‘winners’ or surviving users. With 800 users beating the house, the round payout is $7,500.00 divided by 800, and equals $9.375 ($7,500.00/800=˜$9.38) per user.

Then, let's say that in this third exemplary fantasy contest, after the second round 750 users are eliminated, leaving only 50 users remaining. The same math would apply, with 750 times $37.50 equal to $28,125.00 (750×$37.50=$28,125.00) for the round payout pot. Dividing by 50, we get $562.50 ($28,125.00/50=$562.50) per surviving user.

Then, let's say that after a third round of this third exemplary fantasy contest, 35 users are eliminated, leaving only 15 users remaining. The same math would apply, with 35 times $37.50 equal to $1,312.50 (35×$37.50=$1,312.50) for the round payout pot. Dividing by 15, we get $87.50 ($1,312.50/15=$87.50) per surviving user.

This can continue until the multi-round payout pot is exhausted or the fantasy contest concludes with one or more winners splitting the remainder of the multi-round payout pot as well as the prize pot.

FIG. 15 illustrates a screenshot depicting the ability to choose between various sports or types of real-world competitions. Highlighting may be used to depict the contestant selection.

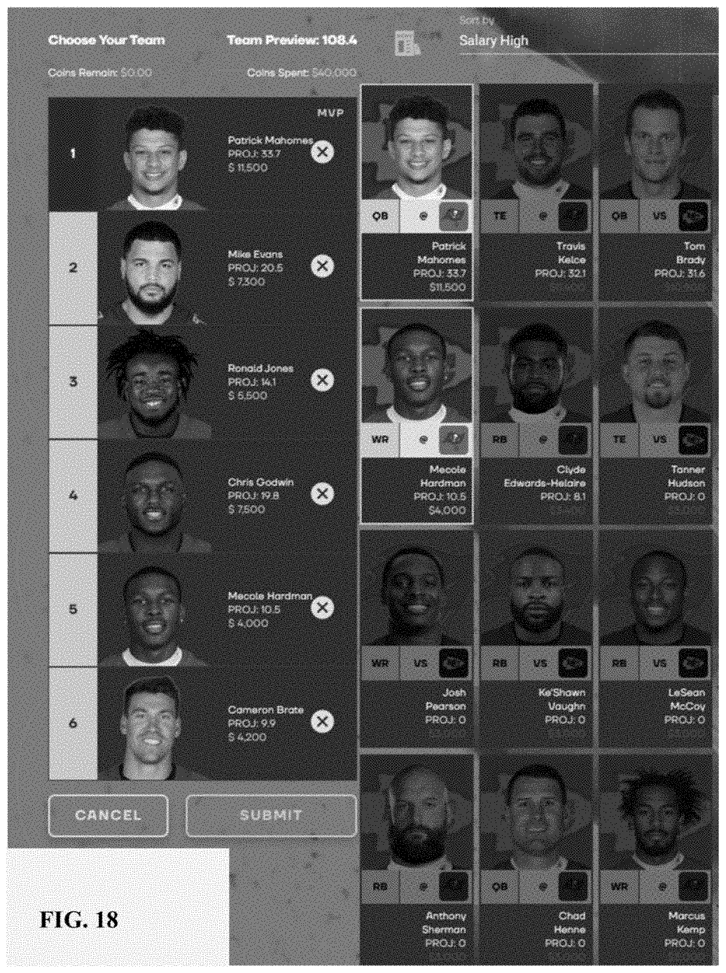

FIG. 16 illustrates a screenshot depicting various house lineup selections offered for contests for a chosen sport, in this case football, and specifically the Superbowl. As shown, the contestant may select to “face this lineup”.

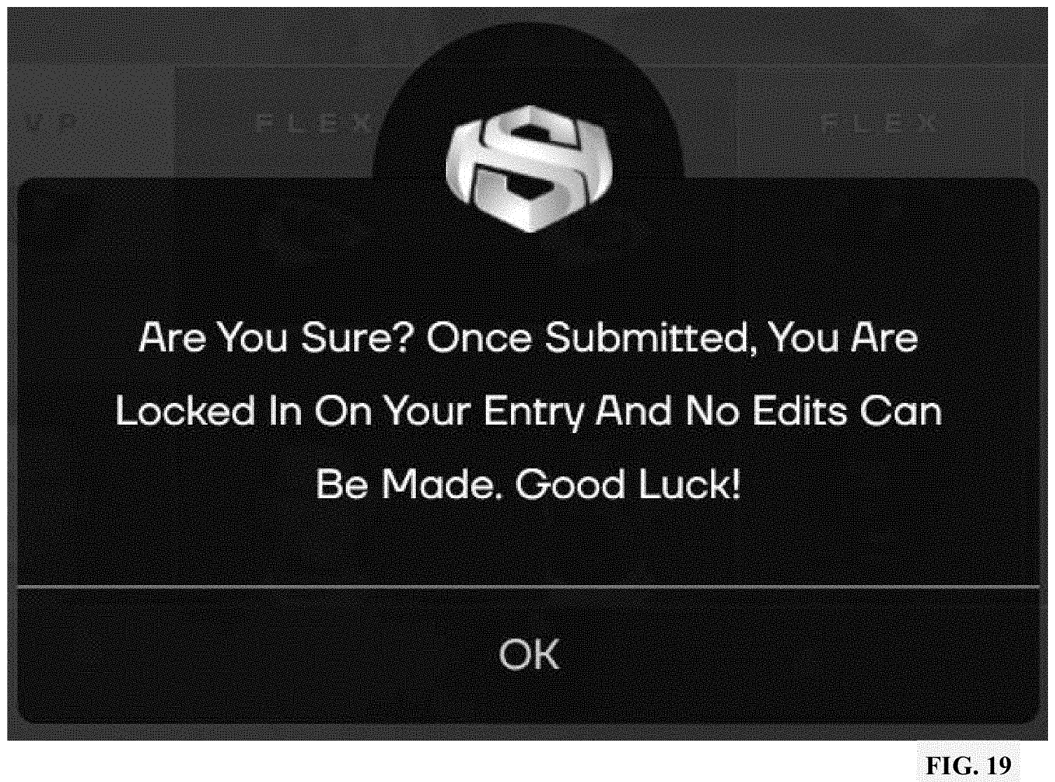

FIG. 17 illustrates a screenshot depicting contestant required competitor selections, in this case for playoff finals play including one MVP and five flex players.

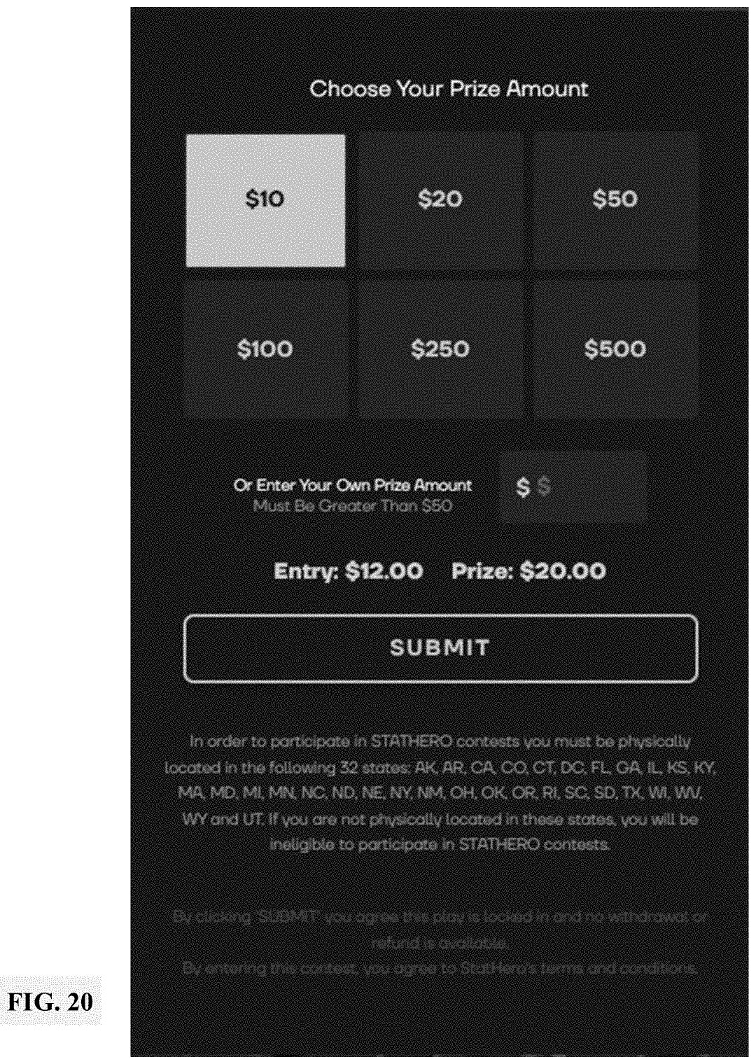

FIG. 18 illustrates a screenshot depicting selections made based on a salary cap limit.

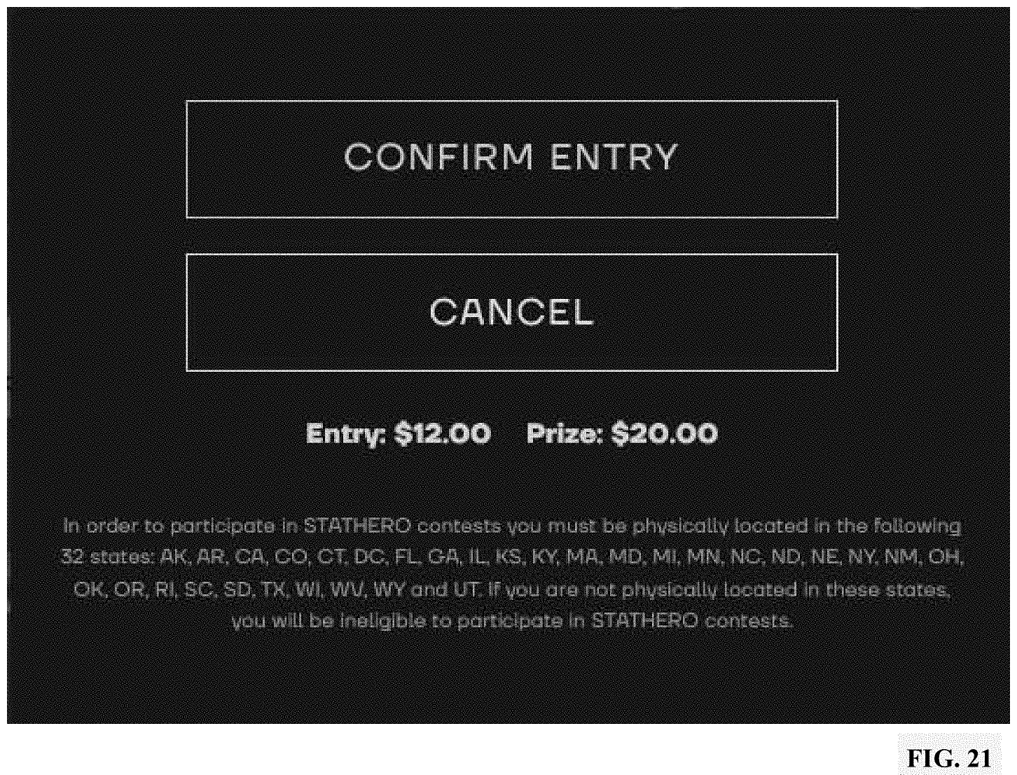

FIG. 19 illustrates a screenshot depicting a competitor selection confirmation function, after which the contestant selected lineup may be locked until the contest is conducted.

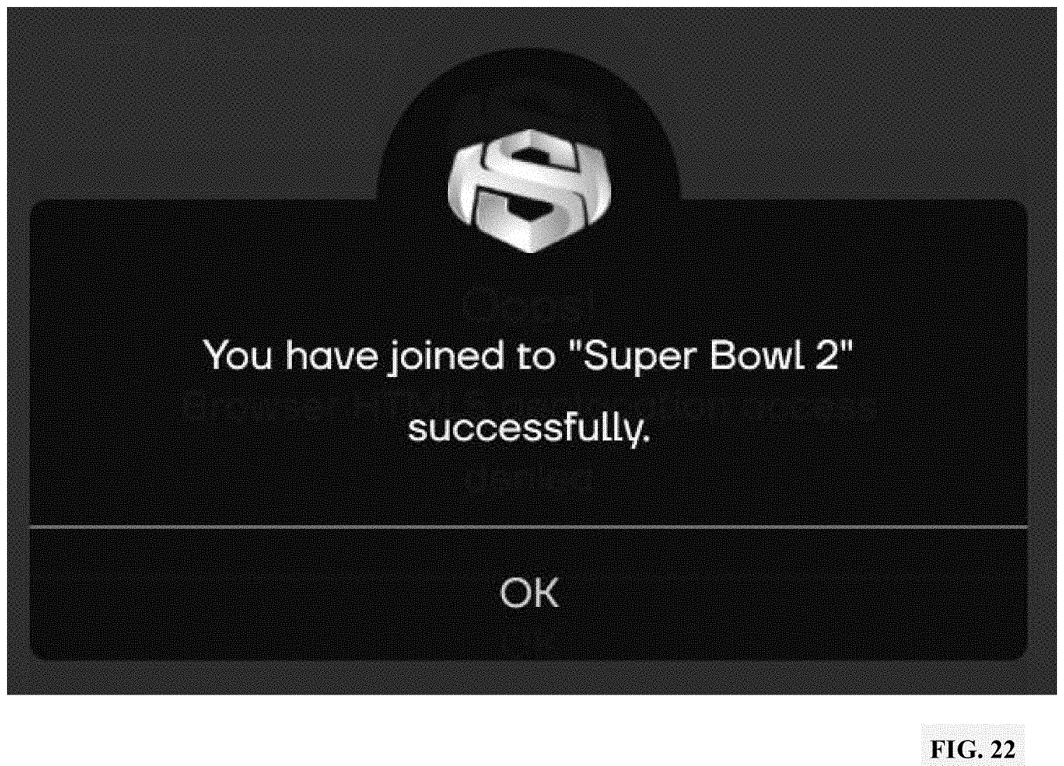

FIG. 20 illustrates a screenshot depicting the selection of a contest Prize and Entry Fee amounts.

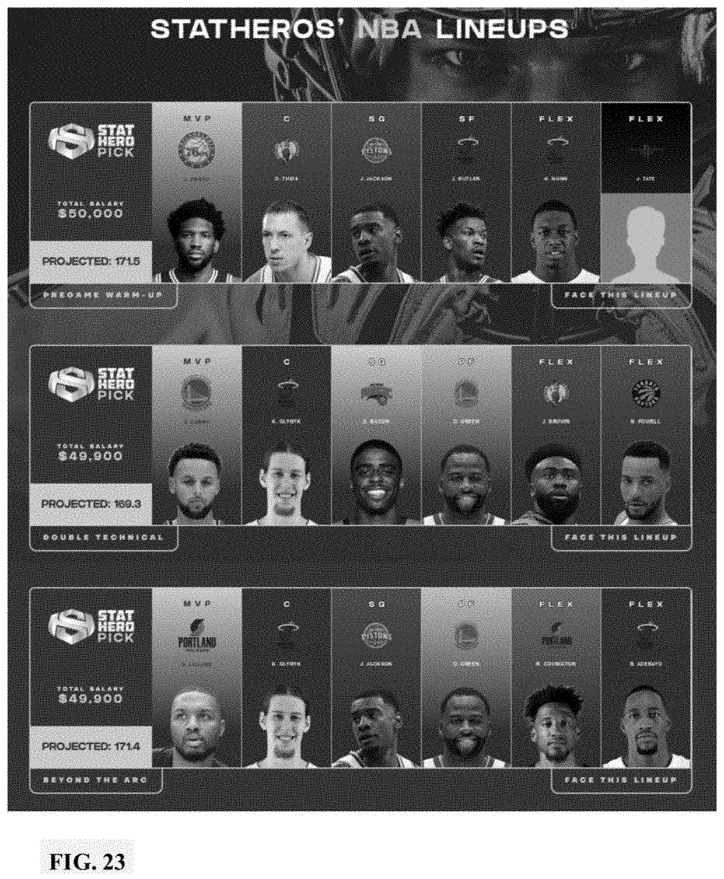

FIG. 21 illustrates a screenshot depicting a prize and entry fee amount confirmation function, after which the prize and entry fee amounts are fixed and the user is entered into the fantasy contest as a contestant.

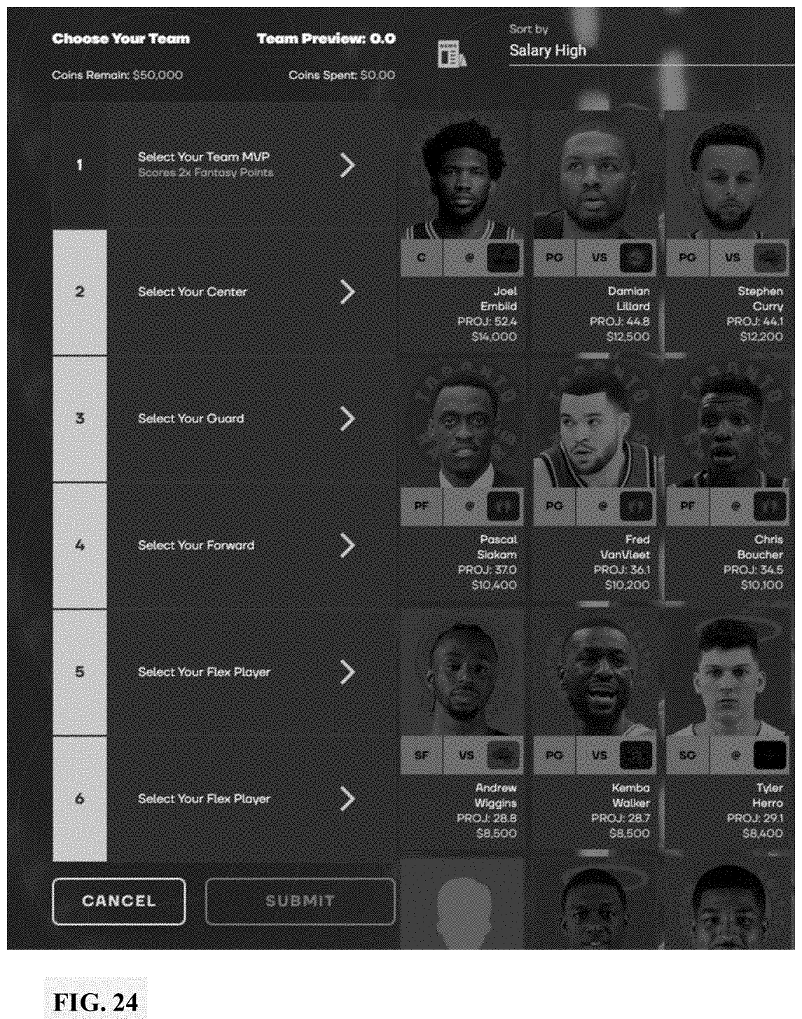

FIG. 22 illustrates a screenshot depicting a confirmation function verifying successful entry of the contestant into the contest.

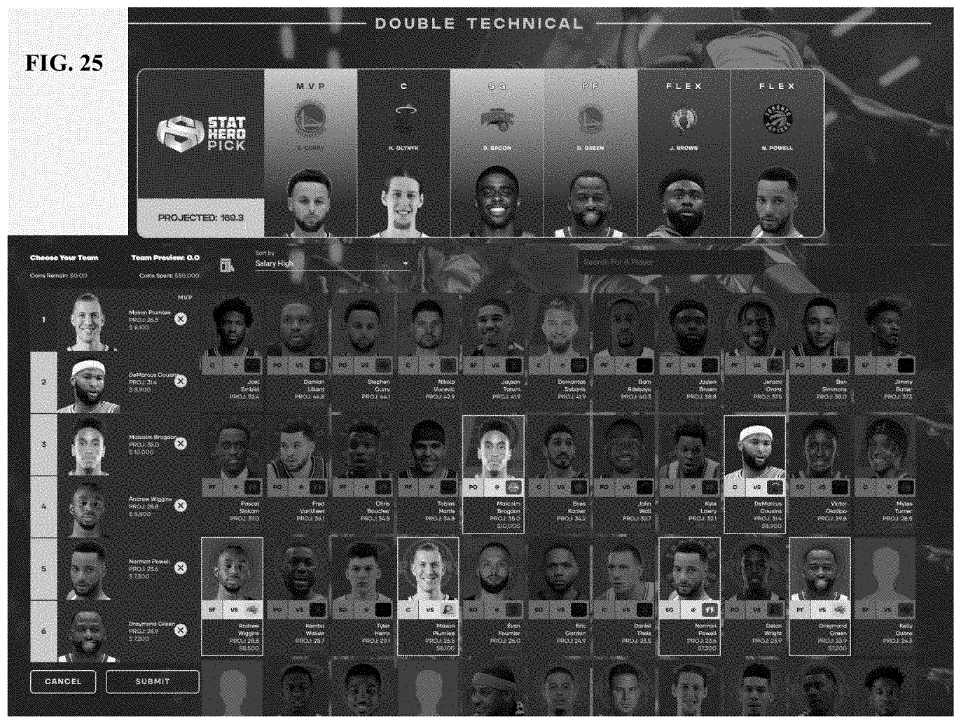

FIG. 23 illustrates a screenshot depicting various house lineup selections offered for contests for a chosen sport, in this case basketball, specifically during regular season play. As shown, the contestant may select to “face this lineup”.

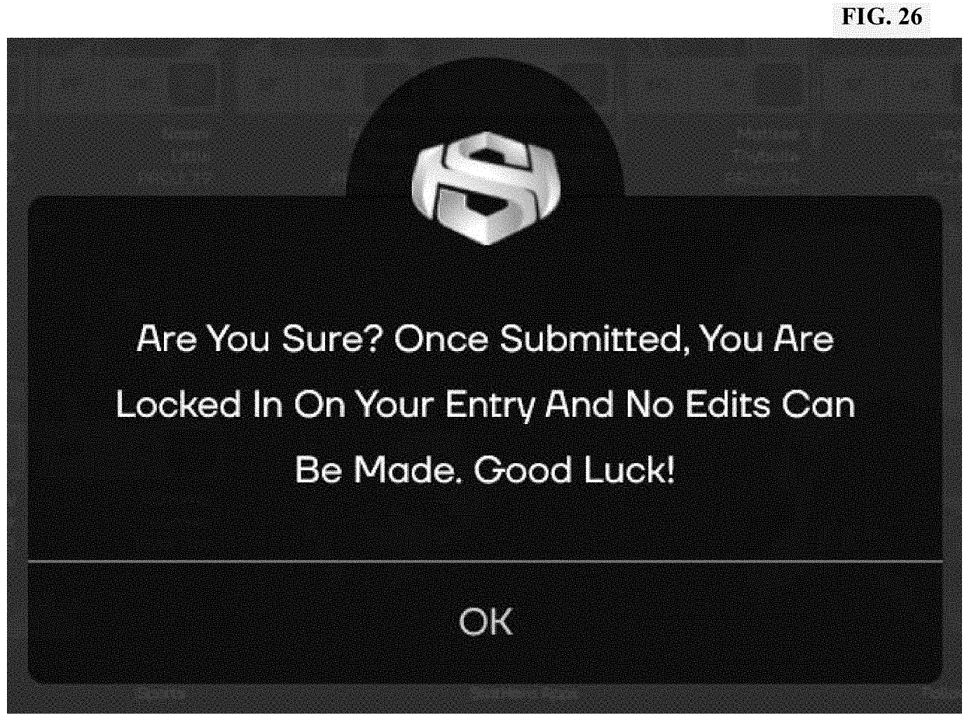

FIG. 24 illustrates a screenshot depicting contestant required competitor selections, in this case for including one MVP, a Center, a Guard, a Forward, and two (2) flex players.

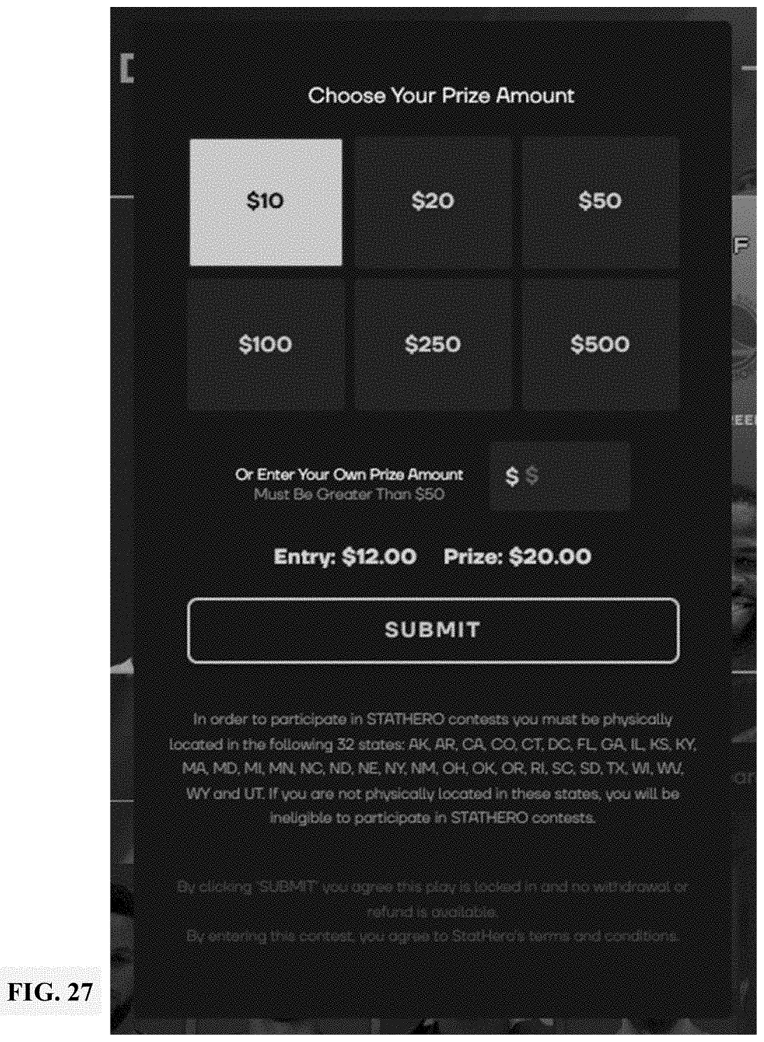

FIG. 25 illustrates a screenshot depicting selections made based on a salary cap limit. Note that the house lineups may be indicated by a short suggestive name, in this case “Double Technical”.

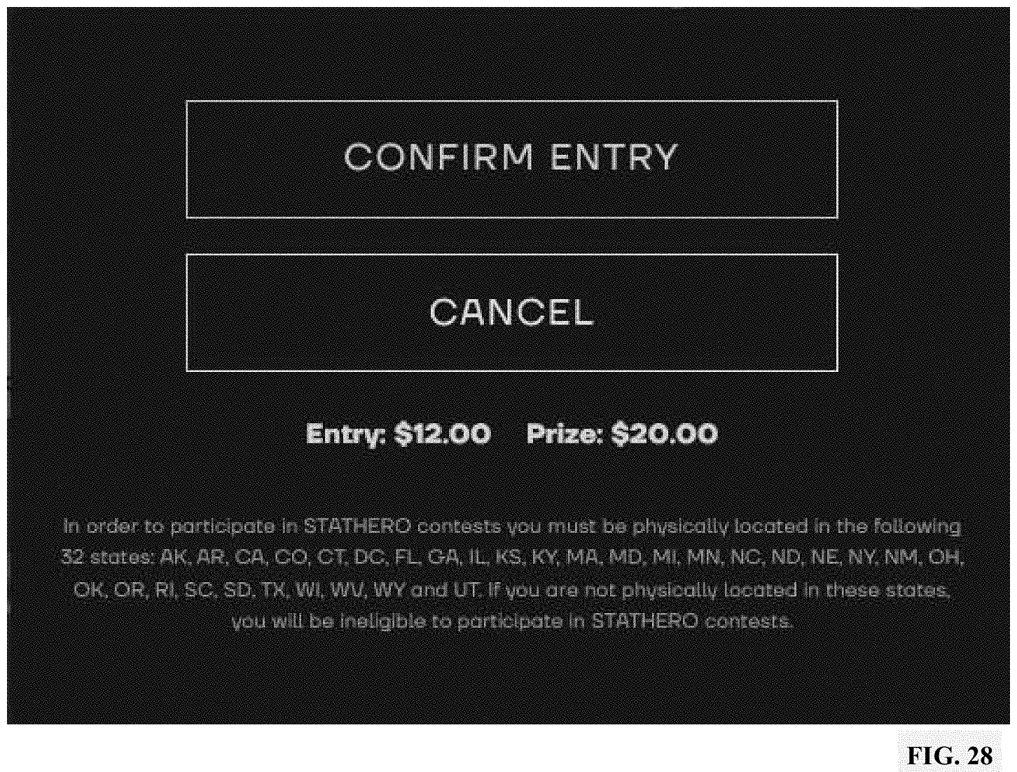

FIG. 26 illustrates a screenshot depicting a competitor selection confirmation function, after which the contestant selected lineup may be locked until the contest is conducted.

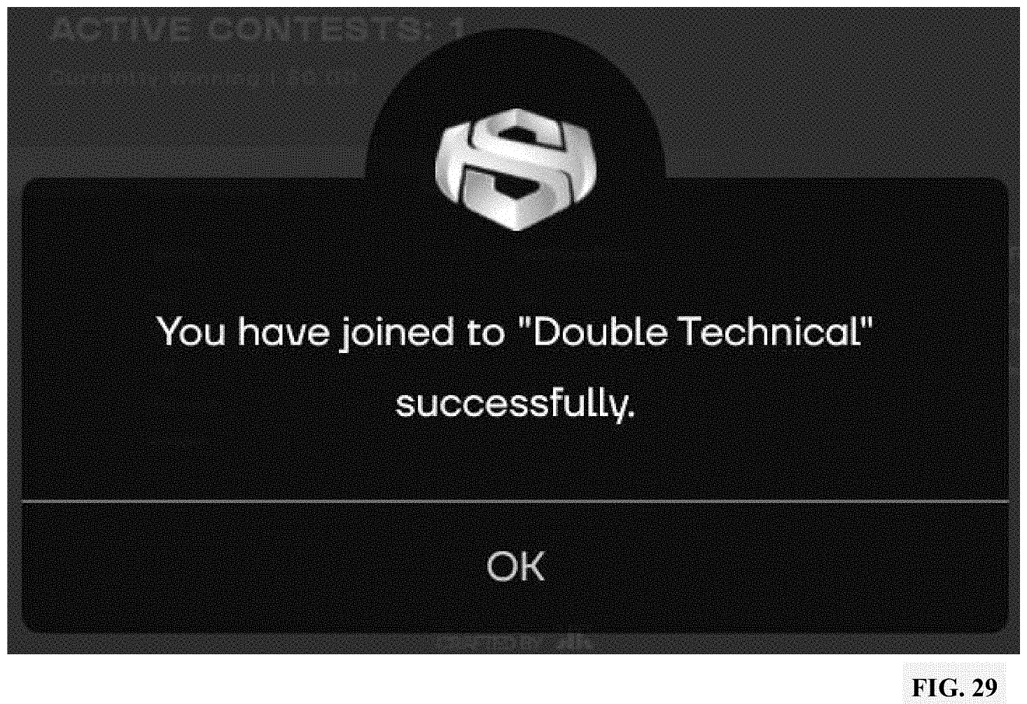

FIG. 27 illustrates a screenshot depicting the selection of a contest Prize and Entry Fee amounts.

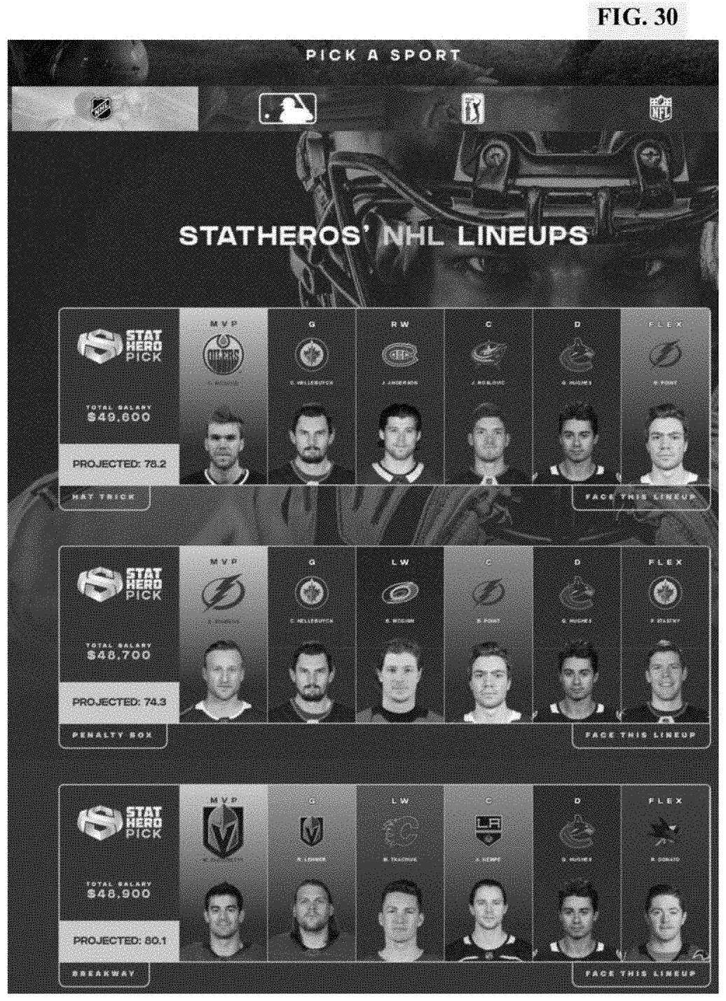

FIG. 28 illustrates a screenshot depicting a prize and entry fee amount confirmation function, after which the prize and entry fee amounts are fixed and the user is entered into the fantasy contest as a contestant.

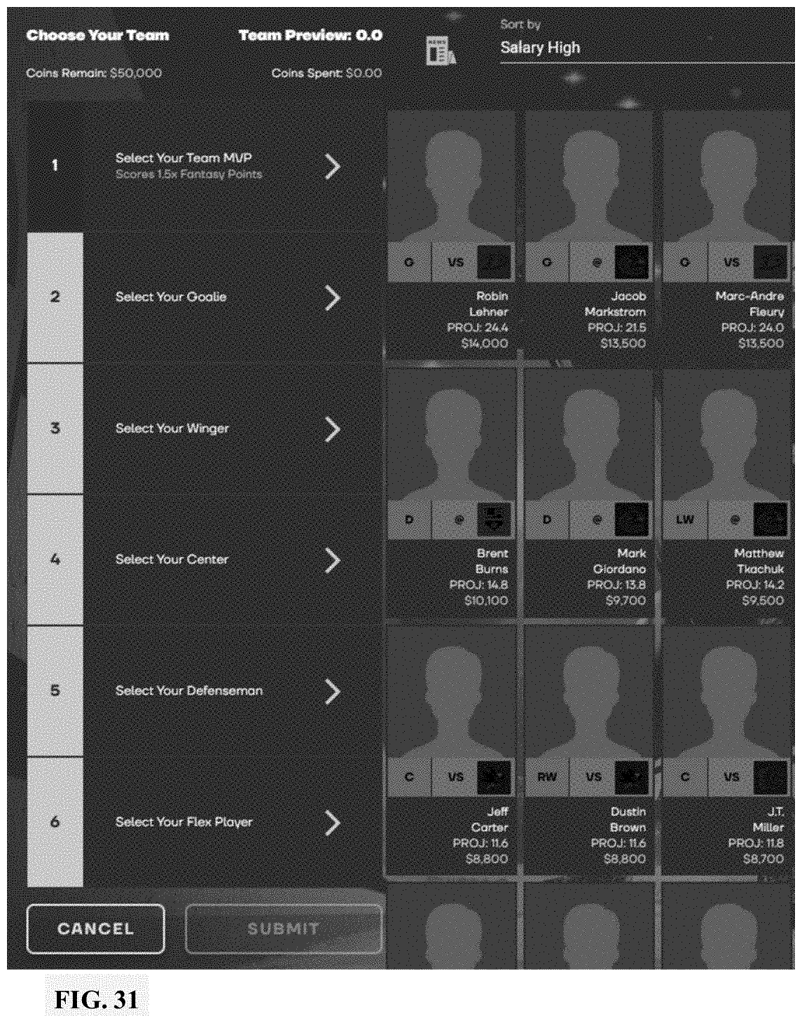

FIG. 29 illustrates a screenshot depicting a confirmation function verifying successful entry of the contestant into the contest.

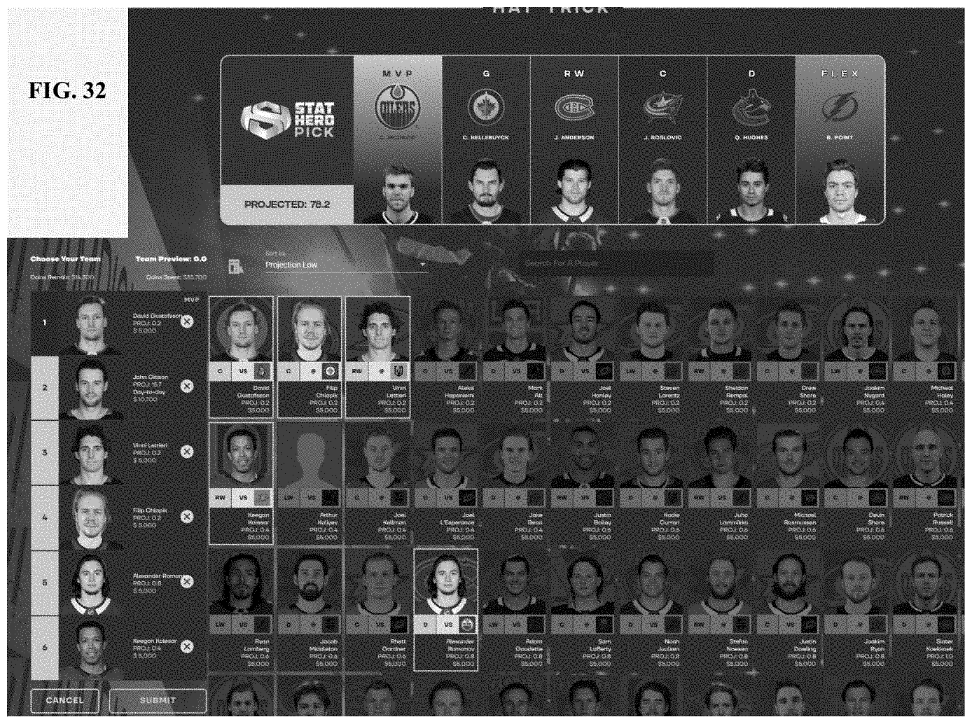

FIG. 30 illustrates a screenshot depicting various house lineup selections offered for contests for a chosen sport, in this case hockey, specifically during regular season play. As shown, the contestant may select to “face this lineup”.

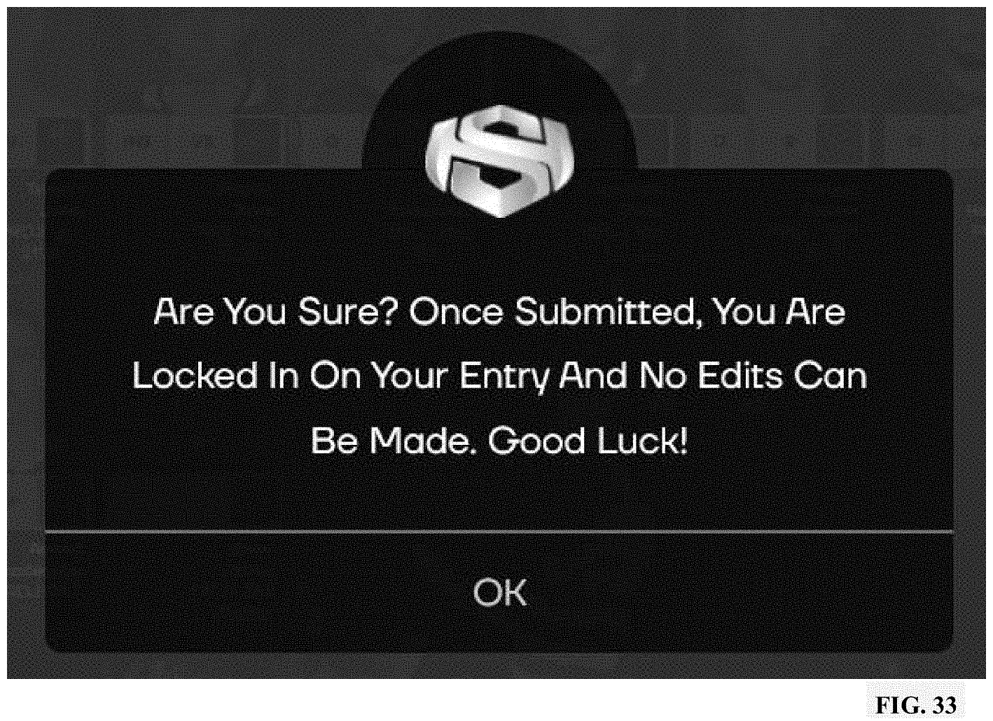

FIG. 31 illustrates a screenshot depicting contestant required competitor selections, in this case for including one MVP, a Goalie, a Winger, a Center, a Defenseman and one (1) flex player.

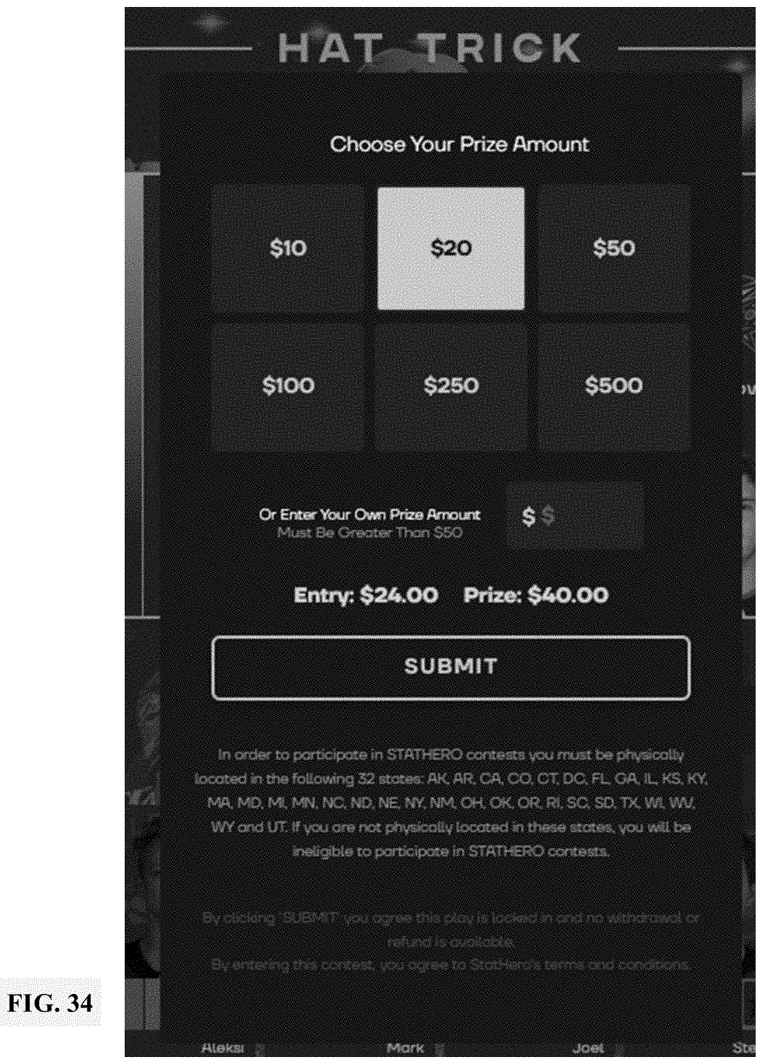

FIG. 32 illustrates a screenshot depicting selections made based on a salary cap limit. Note that the house lineups may be indicated by a short suggestive name, in this case “Double Technical”.

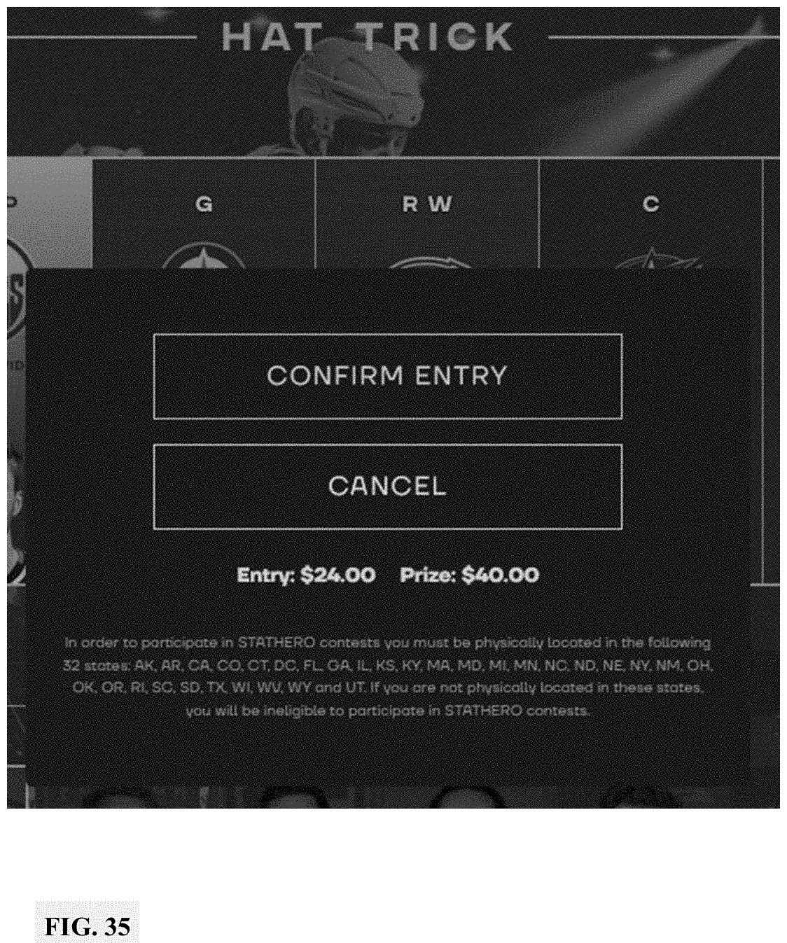

FIG. 33 illustrates a screenshot depicting a competitor selection confirmation function, after which the contestant selected lineup may be locked until the contest is conducted.

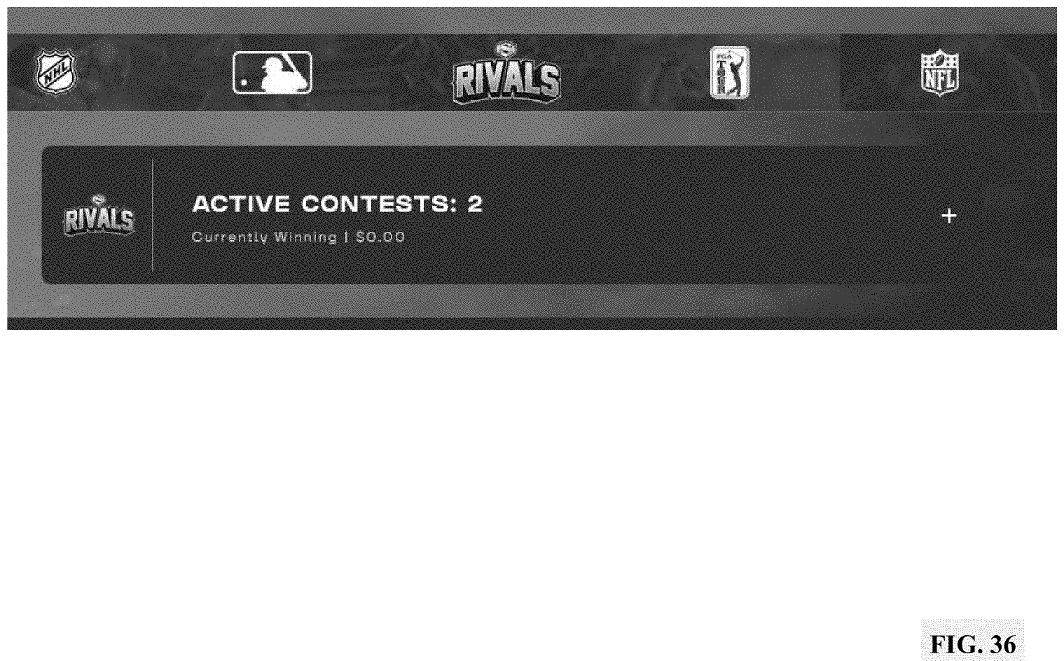

FIG. 34 illustrates a screenshot depicting the selection of a contest Prize and Entry Fee amounts.

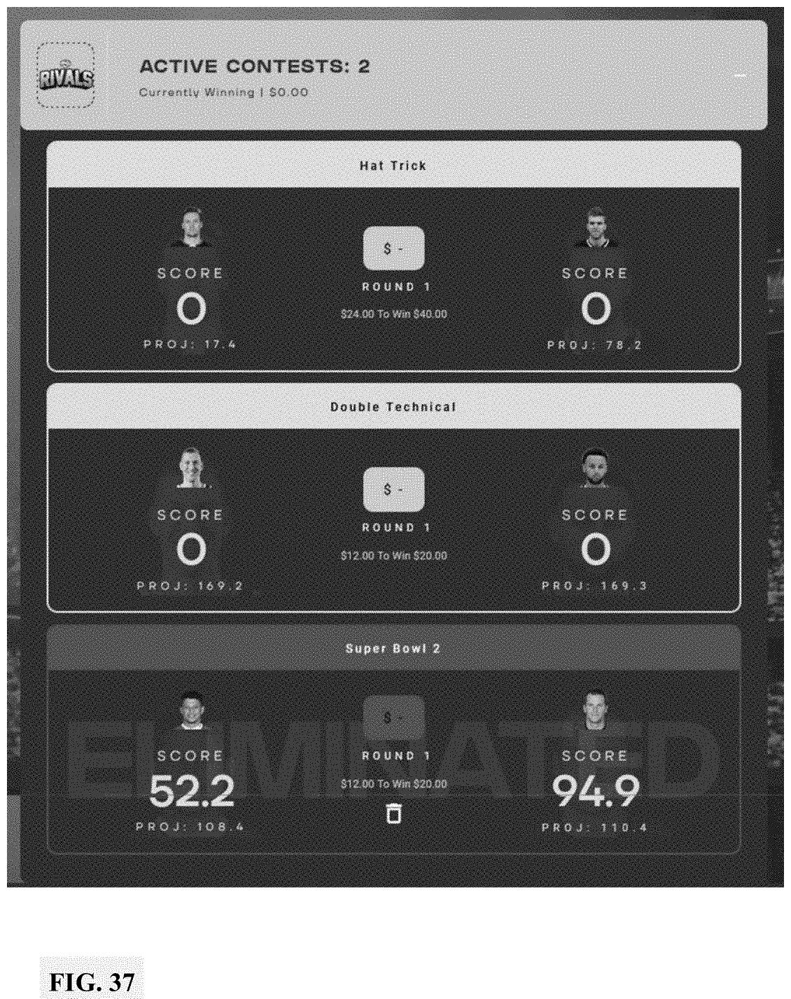

FIG. 35 illustrates a screenshot depicting a prize and entry fee amount confirmation function, after which the prize and entry fee amounts are fixed and the user is entered into the fantasy contest as a contestant.

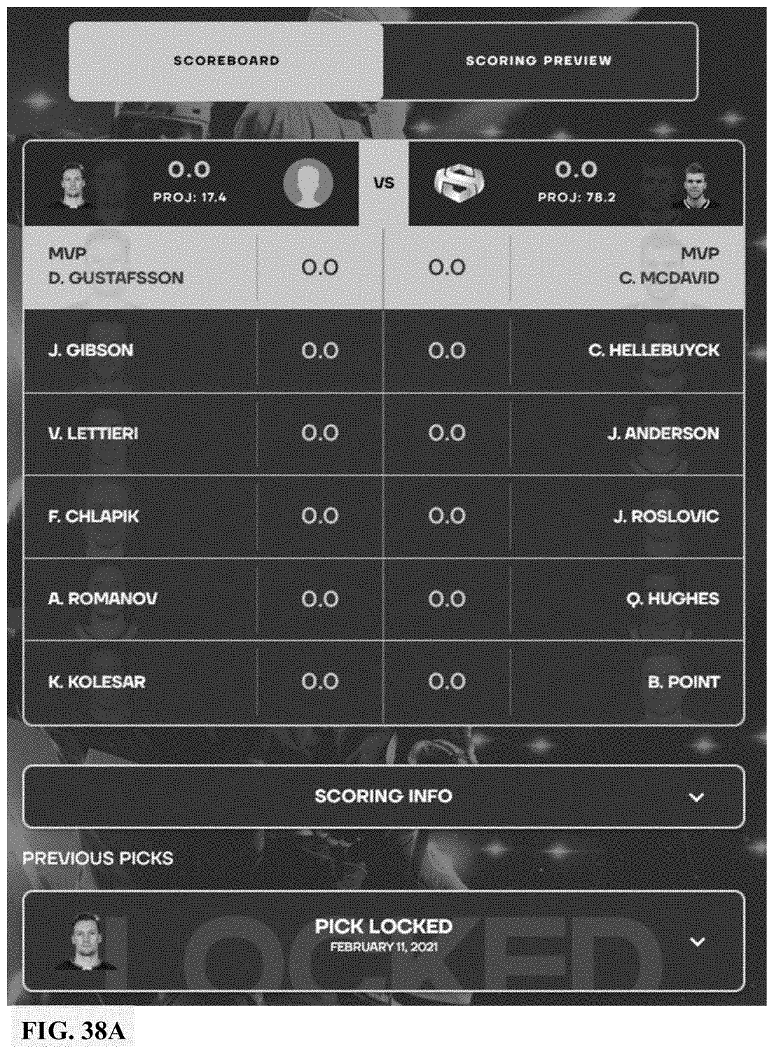

FIG. 36 illustrates a screenshot depicting a navigation page enabling the user to select the ability to view one or more active contests in which they are contestants.

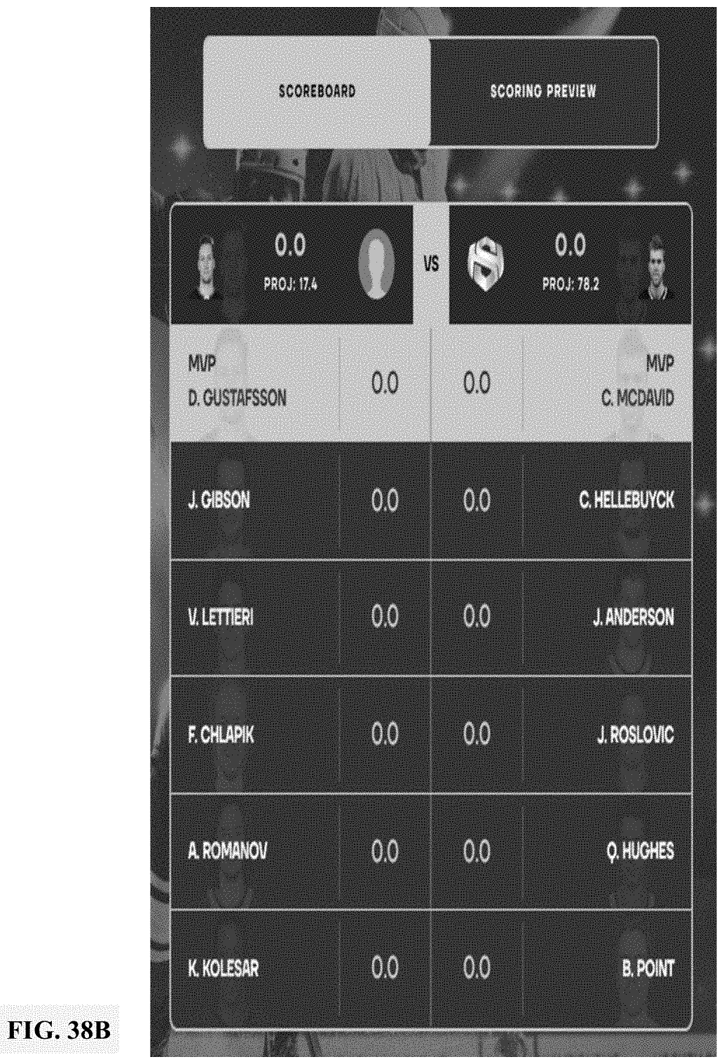

FIG. 37 illustrates a screenshot depicting a navigation page enabling the user to select from among active and previously concluded contests in which they are or were contestants to view the performance statistics associated with each contest.

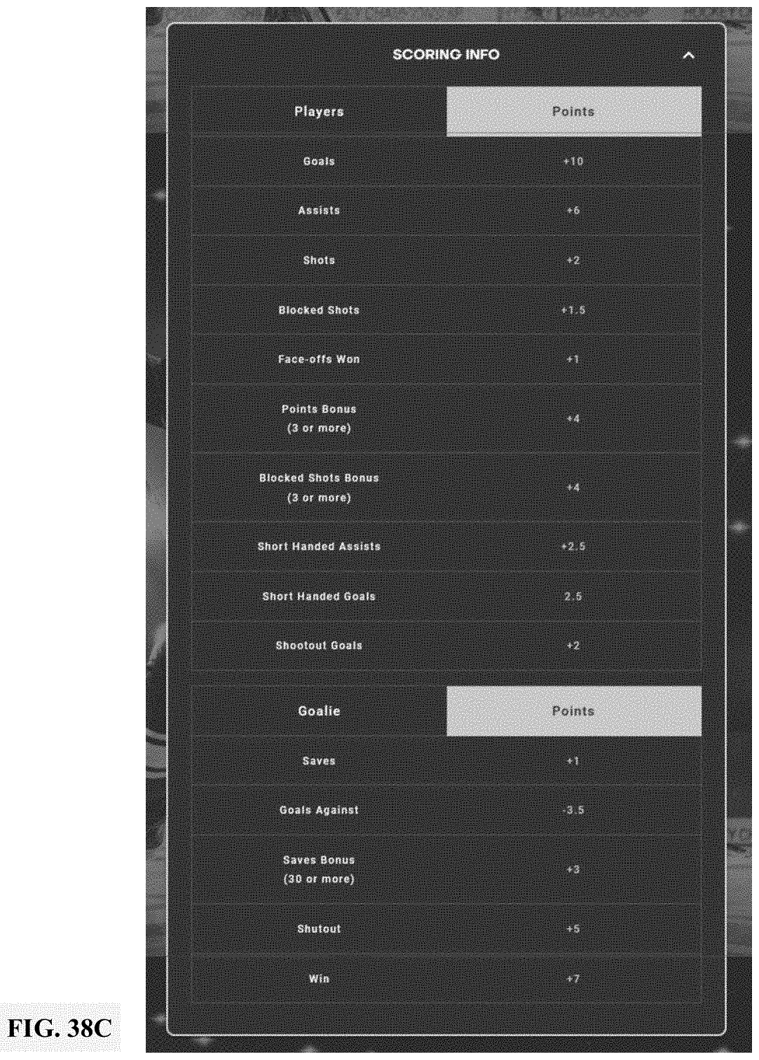

FIG. 38A-38C illustrate screenshots depicting a scoreboard showing detailed performance statistics associated with an active contest and with each real-world competitor associated with the contest. In this case the contest is not yet underway, so no scores are shown.

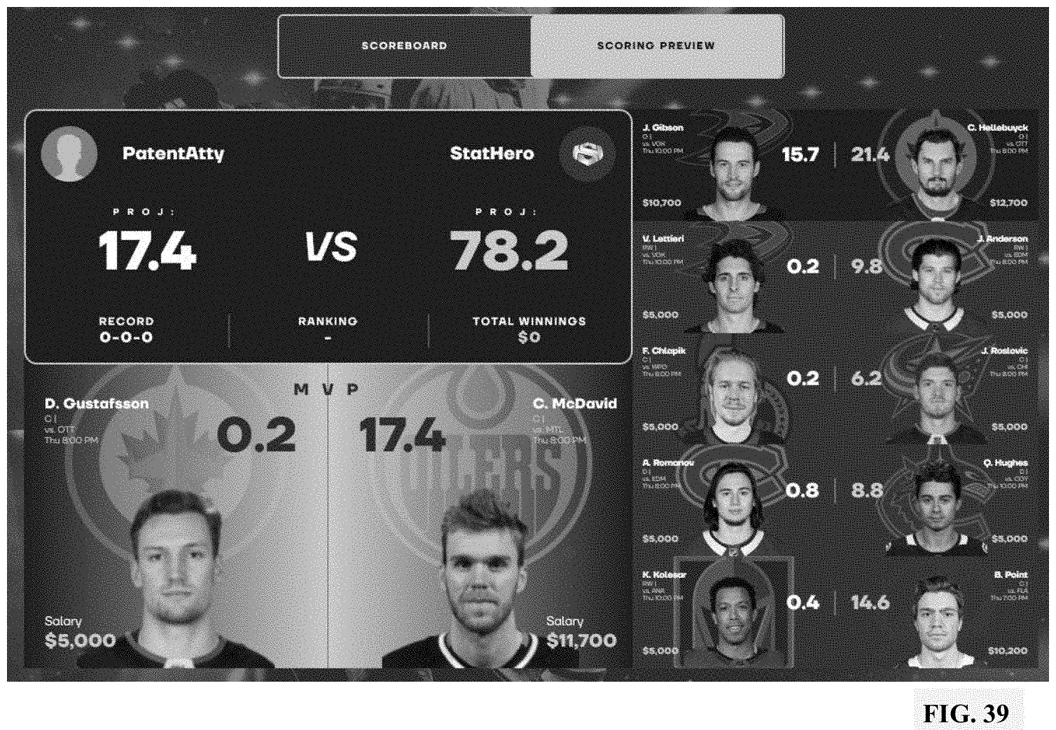

FIG. 39 illustrates a screenshot depicting a scoring preview for an upcoming contest.

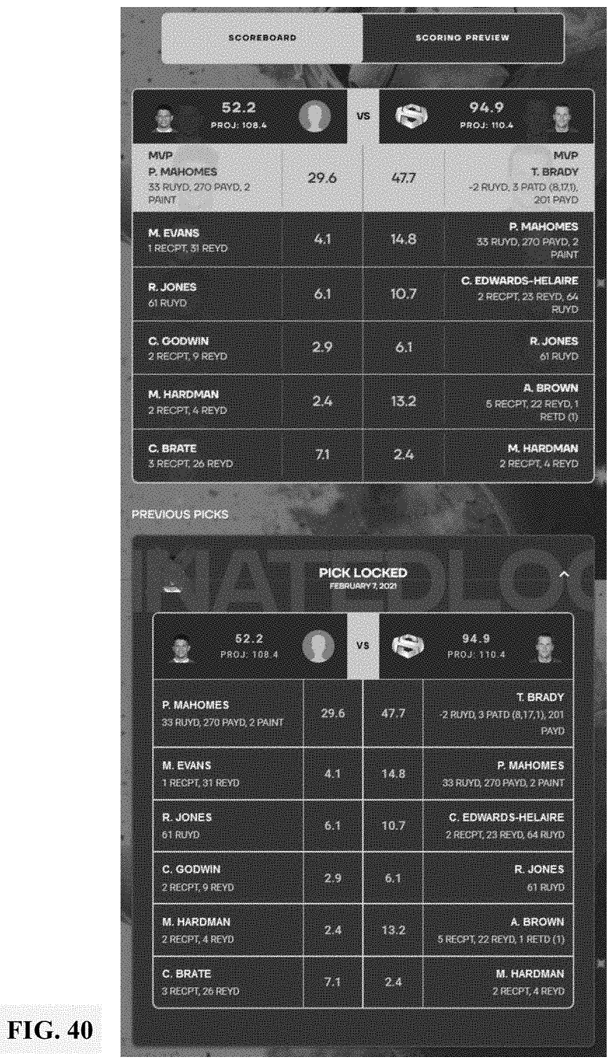

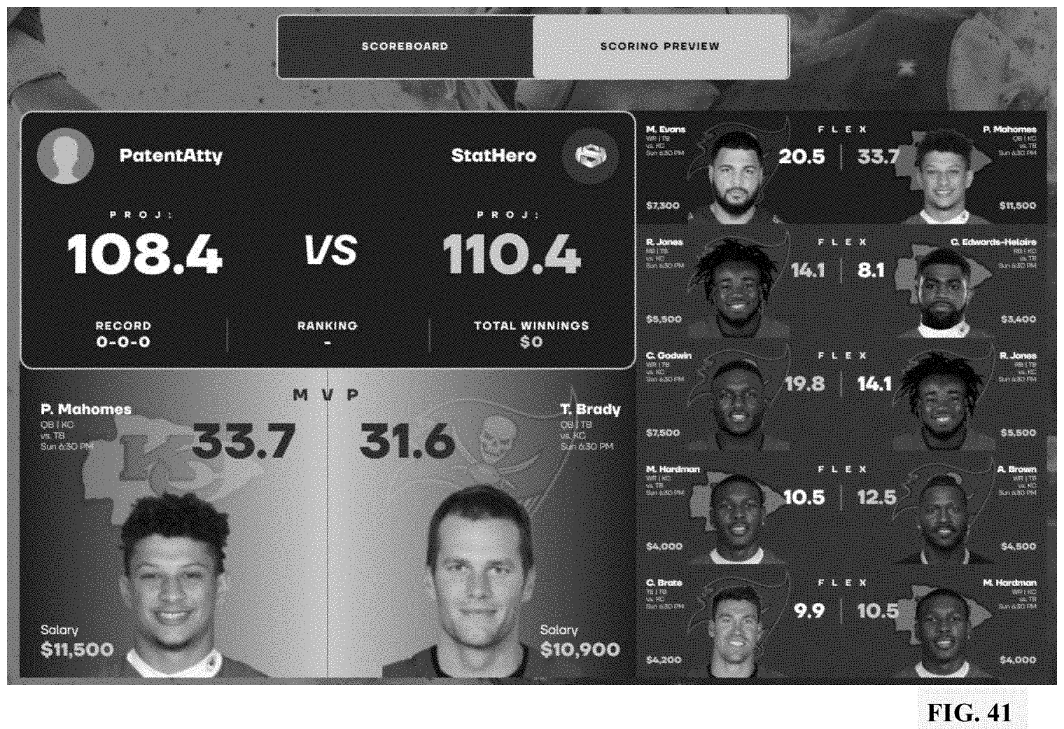

FIG. 40 illustrates a screenshot depicting a scoreboard for a contest that has been completed, and FIG. 41 illustrates a screenshot depicting a scoring preview for a contest that has been completed.

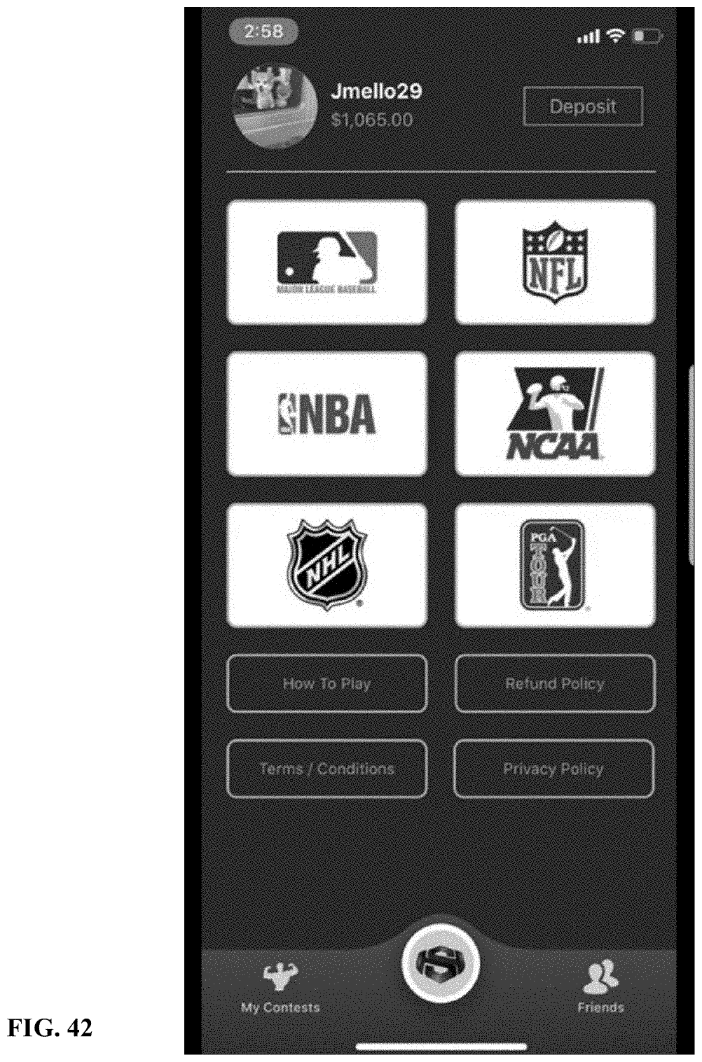

FIG. 42 illustrates an exemplary home screen or navigation page enabling the contestant to select from among different sports for the fantasy contest. Different sports selections may implicate different types of contests, as described above, with respect to FIGS. 8-10.

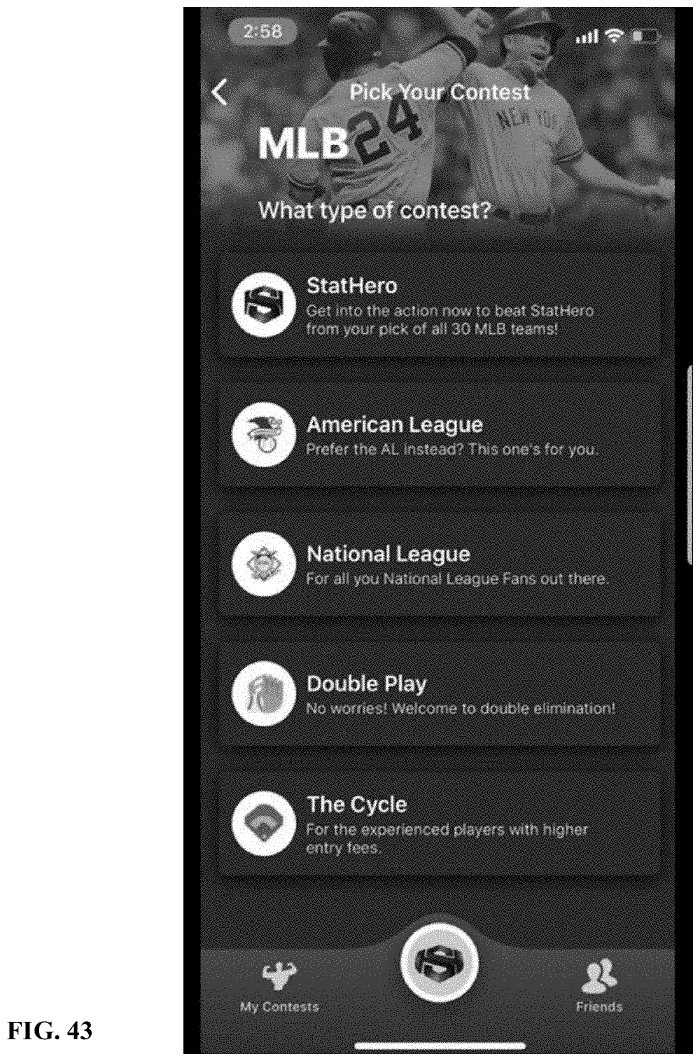

FIG. 43 illustrates an exemplary navigation screen enabling the contestant to select a contest type. Different types of contests may include single round or multiple round fantasy contests.

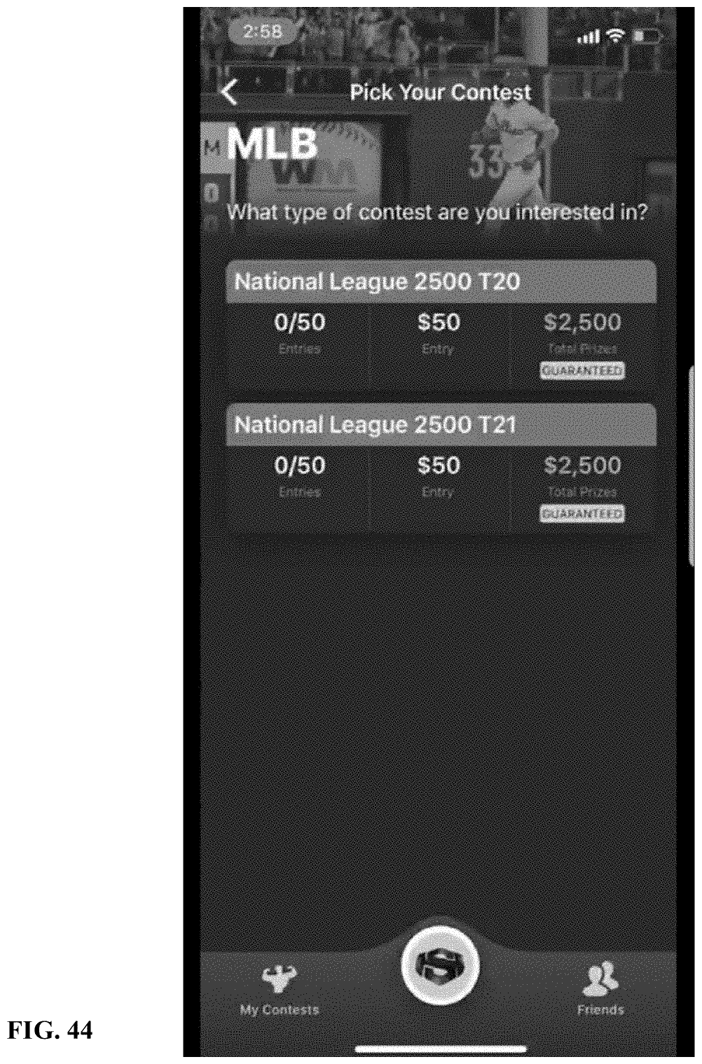

FIG. 44 illustrates an exemplary navigation screen enabling the contestant to select a specific contest. Once a specific contest is selected, the contestant/user must pay an entry fee and select one or more sports players to compete against the fantasy contest house selections.

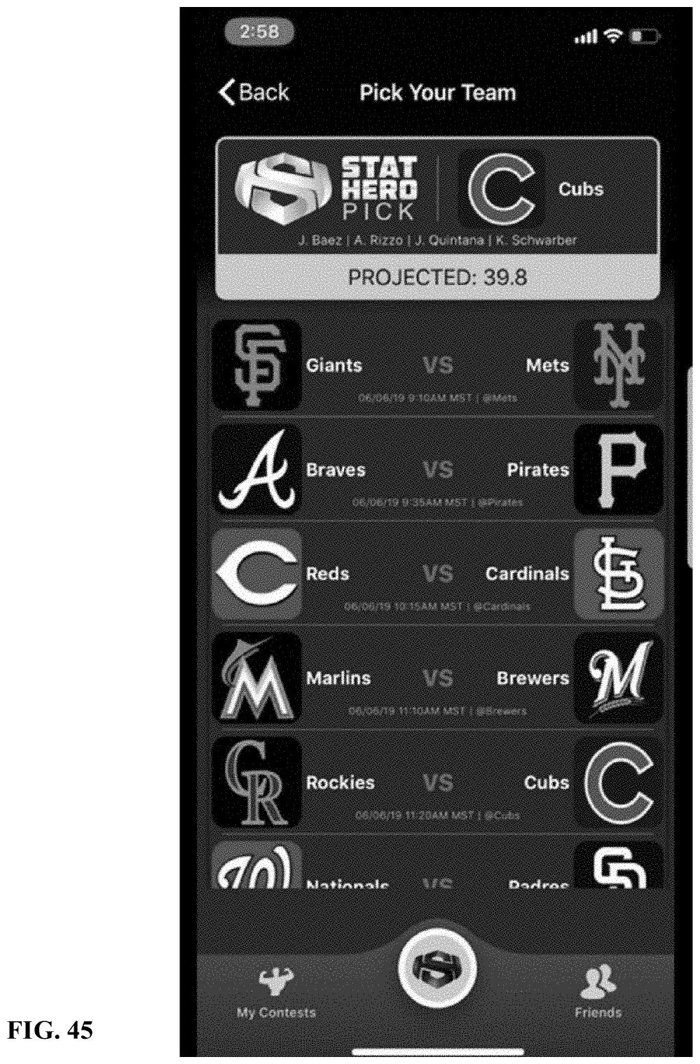

FIG. 45 illustrates an exemplary navigation screen enabling the contestant to select a specific team. In some fantasy contests, a sports team selection is required, from which team specific sports players will ultimately be selected.

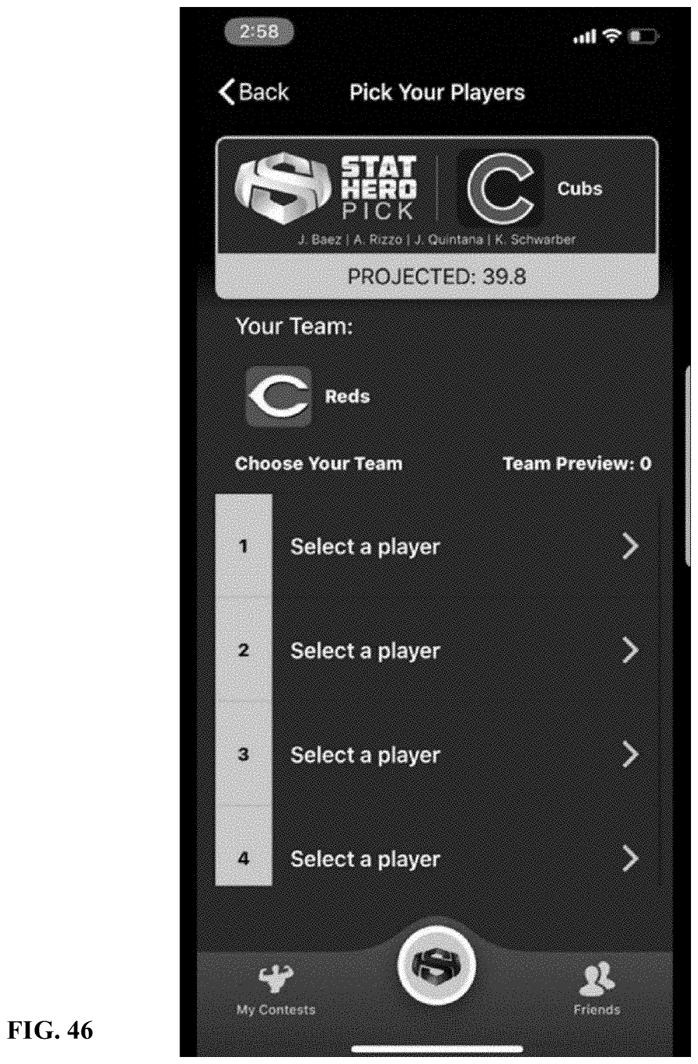

FIG. 46 illustrates an exemplary fantasy sports team roster navigation screen enabling the contestant to build and submit a fantasy team roster for the fantasy contest.

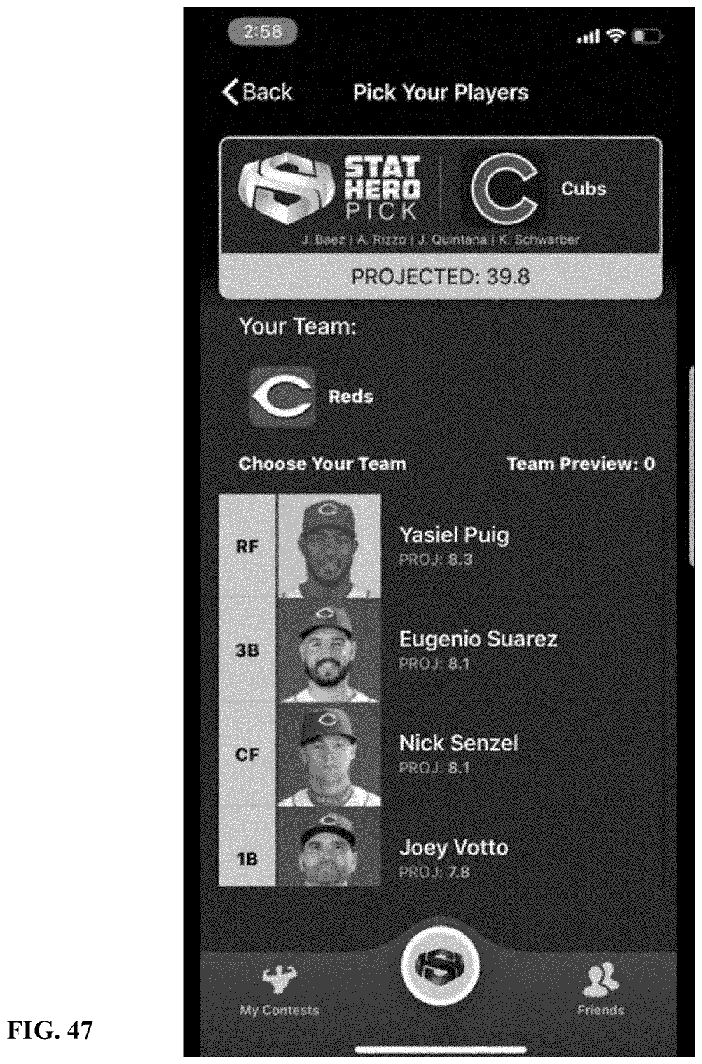

FIG. 47 illustrates an exemplary sports player selection navigation screen enabling the contestant to select specific players from the roster of a sports team or other list of sports players.

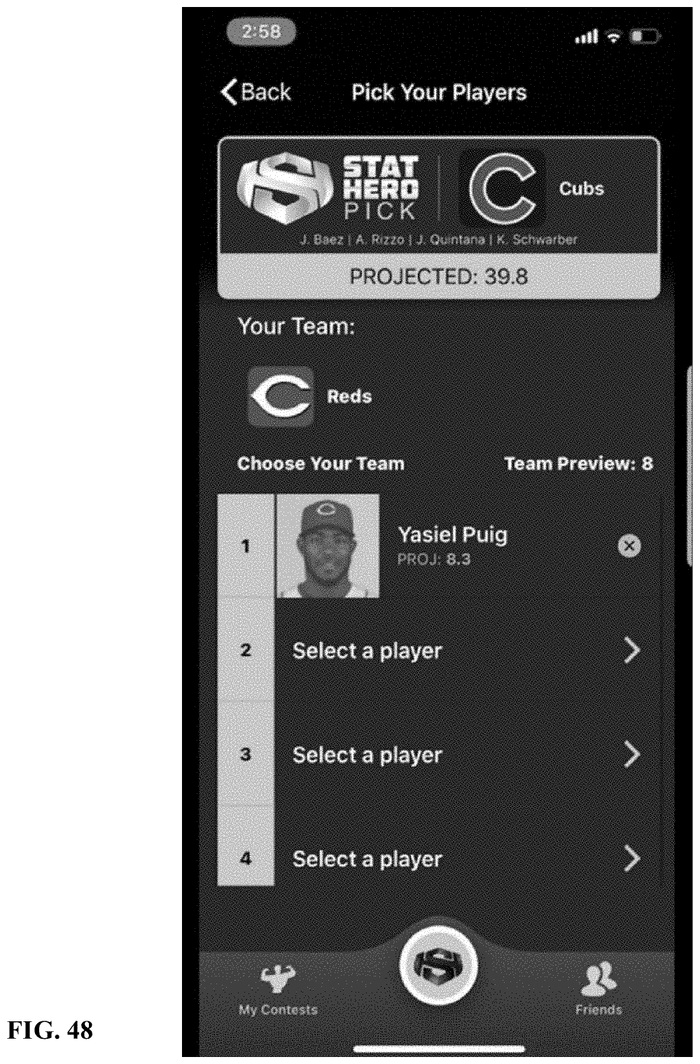

FIG. 48 illustrates a first player selection as shown on the fantasy sports team roster navigation screen.

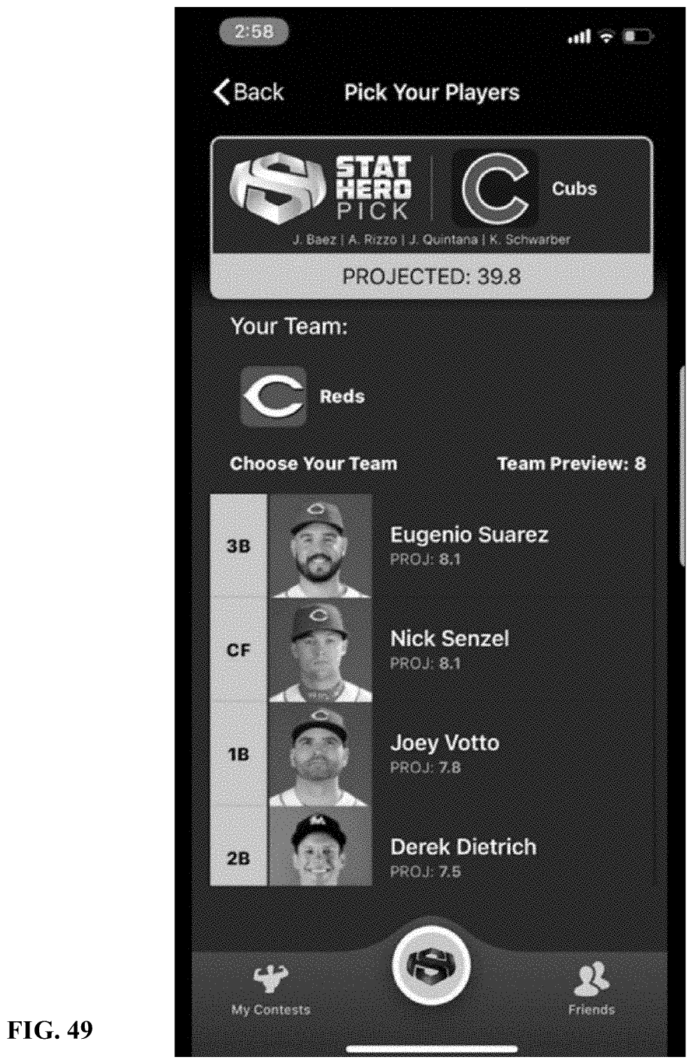

FIG. 49 illustrates an exemplary updated sports player selection navigation screen depicting an updated list of sports players that does not include the sports player(s) already selected. From this screen the contestant is enabled to select additional sports players for the fantasy sports team roster.

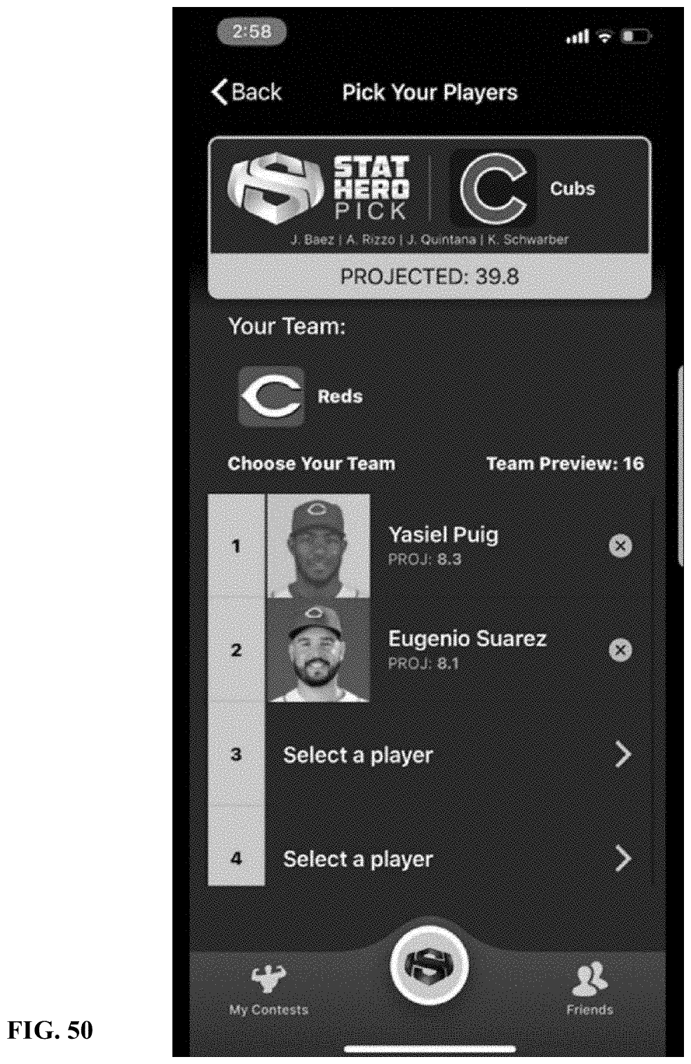

FIG. 50 illustrates an updated fantasy sports team player roster selection as shown on the fantasy sports team roster navigation screen.

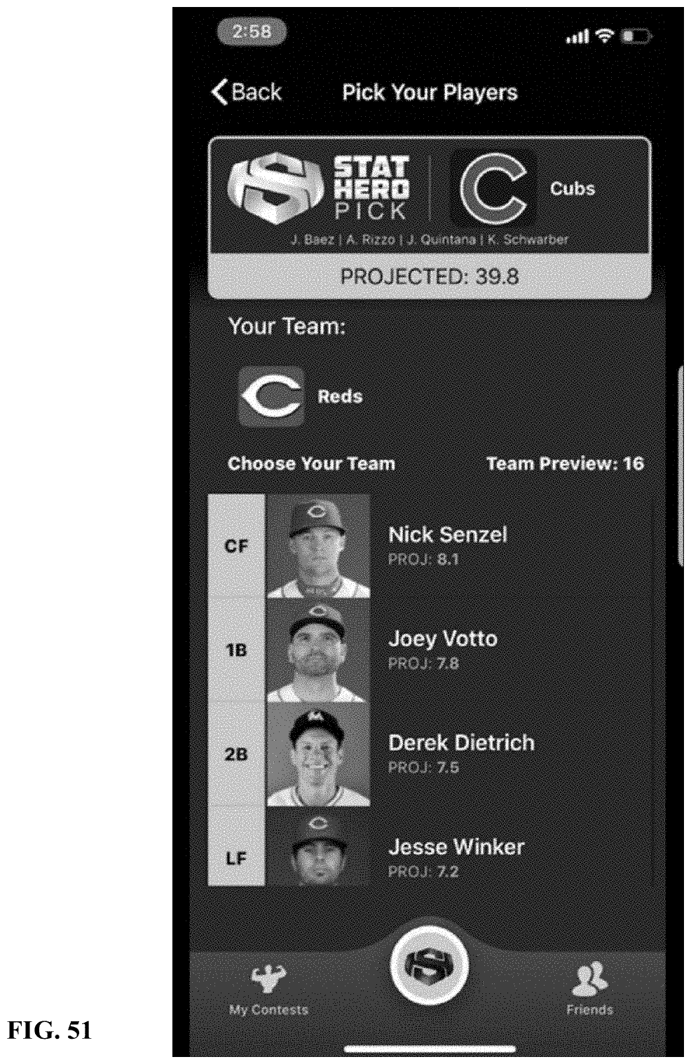

FIG. 51 illustrates a further exemplary updated sports player selection navigation screen depicting an updated list of sports players that does not include the sports player(s) already selected. From this screen the contestant is enabled to select additional sports players for the fantasy sports team roster.

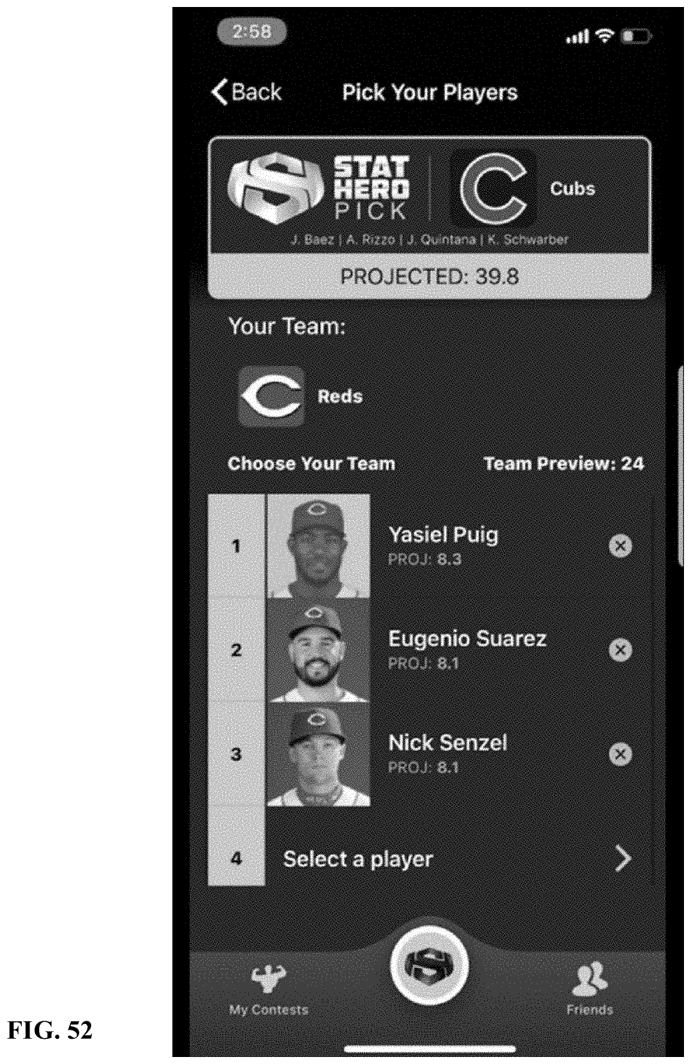

FIG. 52 illustrates a further updated fantasy sports team player roster selection as shown on the fantasy sports team roster navigation screen.

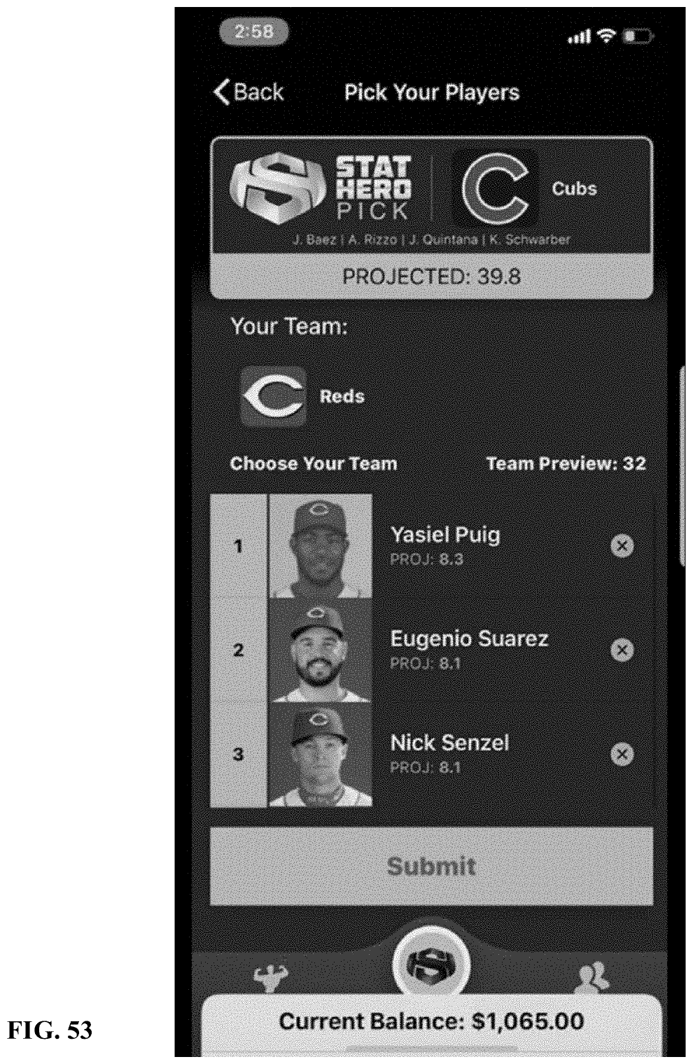

FIG. 53 illustrates screenshot depicting a contestant lineup submission confirmation screen.

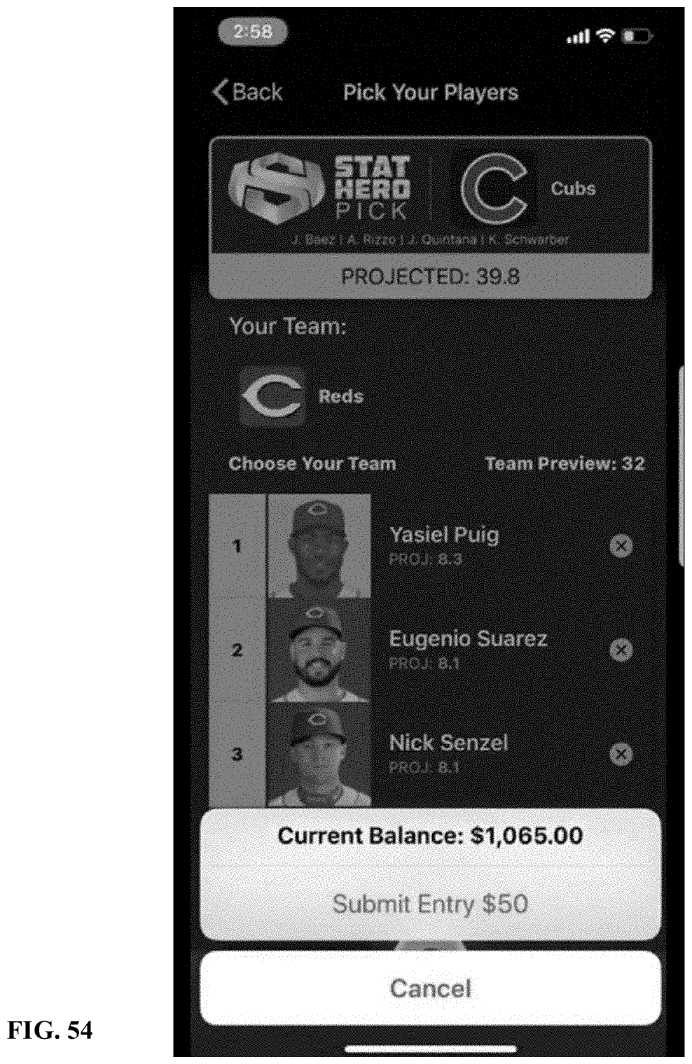

FIG. 54 illustrates a screenshot depicting an entry fee submission screen.

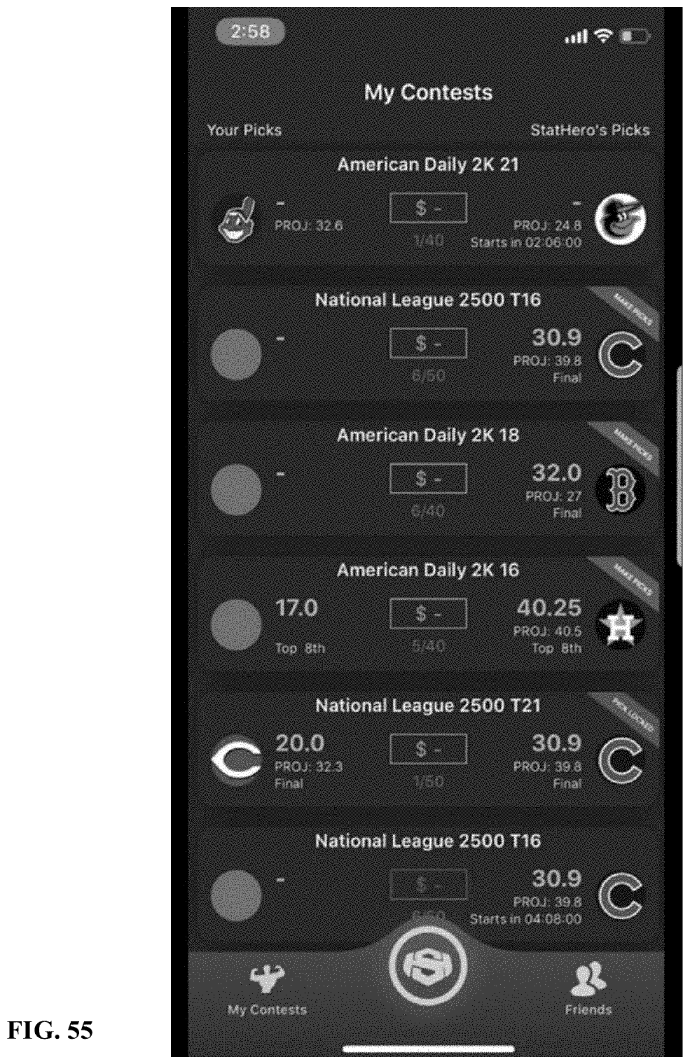

FIG. 55 illustrates an exemplary user contests navigation screen enabling the contestant to view the various contests in which they are participating or in which they have participated. The contestant may select from among the various contests to get status updates on any contest entries the contestant has logged in these contests.

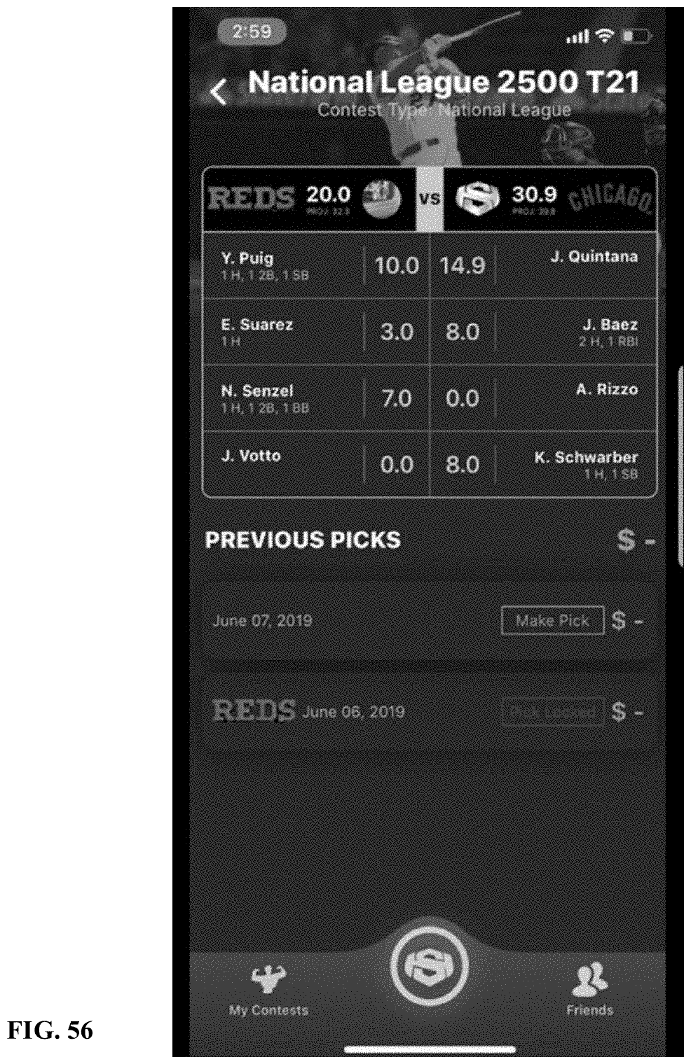

FIG. 56 illustrates an exemplary contest status navigation screen enabling the contestant to view the status of a specific contest. The contest status navigation screen may show performance metrics and fantasy points accrued to each of the one or more selected sports players, as well as aggregated performance metrics for the sports players on the fantasy sports team roster and a total fantasy score achieved by all of the sports player on the fantasy sports team roster.

It should be understood that, although specific embodiments have just been described, the claimed subject matter is not intended to be limited in scope to any particular embodiment or implementation. For instance, many of the embodiments described were in reference to or in conjunction with bat-and-ball games. However, it should be understood that many of these features, elements and limitations may also be applied to many of the other types of competitive events intended to be covered by and included in the present invention, such as Chess, Go, e-sports, political events, social events, reality television contests, etc.

In the preceding description, various aspects of claimed subject matter may have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill in the art were omitted or simplified so as not to obscure claimed subject matter.

While certain features have been illustrated or described herein, many modifications, substitutions, or equivalents may not occur to those skilled in the art. It is, therefore, to be understood that the appended claims are intended to cover all such modifications or changes as fall within the true spirit of the claimed subject matter. Thus, it will be apparent from the foregoing that, while particular forms of the invention have been illustrated and described, various modifications can be made without parting from the spirit and scope of the invention.

What is claimed is:

1. A non-transitory computer-readable medium comprising a computer software implemented system configured to establish and operate a fantasy contest application and platform designed to provide to one or more users an ability to enter and participate in one or more fantasy contests as contestants against the platform, wherein the computer software is executed on a plurality of computers, including a user interface, in conjunction with processors, memory, bus elements and a network connection, the computer software comprising:
code establishing a fantasy contest system configured to form, operate and maintain one or more fantasy contests, where each fantasy contest occurs between one or more contestants and a the fantasy contest platform house, and one or more contest rounds, each contest round associated with a plurality of real-world competitors scheduled to compete in a set of real-world competition events, one or more contestant round winners per fantasy contest round, and one or more contestant winners per fantasy contest, wherein the fantasy contest system further comprises:
a contest management module, configured to establish, or create and initialize, the one or more fantasy contests, inclusive of specifying and setting one or more fantasy contest parameters, including type of contest, number of contestants, number of contest rounds, required lineup or roster structures, including any required salary caps, positions, wild card or MVP selections, house selections of the one or more competitors for house lineups or rosters;
a contestant management module, configured to enter users into their respective selected fantasy contests as contestants and manage contestant user profiles, preferences and default settings, and wherein the contestant management module is also configured to collect, receive and enter contestant selections of and contestant changes to selections of the one or more competitors selected for contestant fantasy contest lineup or roster in a given fantasy contest by the one or more contestants;
a user account module, configured to establish, or create and initialize, and associate each of a plurality of user accounts with each contestant entry into the one or more fantasy contests, and further configured to manage the plurality of user accounts, including maintenance of account balances, crediting and deducting amounts from the user account balances based at least on contest entry fees, round winners, and contest winners determined for a fantasy contest;
a contest entry fee module, configured to set the amount of, collect, receive and manage the contest entry fees for the plurality of fantasy contests offered by the house, and prize payout structures for the fantasy contest and any individual contest rounds;
a contest entry fee pot module, configured to form an entry fee pot for a given fantasy contest, wherein the entry fee pot comprises contestants' entry fees, less some percent retained by the house;
a competitor performance module, configured to obtain a set of performance metrics results for the plurality of selected competitors; and
a contest outcome module, configured to identify a set of one or more of one or more round winners and one or more fantasy contest winners, upon conclusion of a respective round or fantasy contest, by comparing sets of performance metrics, provided by the competitor performance module, and one or more associated fantasy scores to determine one or more sets of contestant winners, based on the contestant winners having a contestant fantasy score higher than the house fantasy score for the given round or fantasy contest.

2. The non-transitory computer-readable medium comprising computer software of claim 1, wherein the contestant management module is further configured to collect, receive and manage contestant selections of and changes to contestant selections of one or more sports teams, from which the contestant must select one or more competitors to be included in the contestant's fantasy contest lineup or roster.

3. The non-transitory computer-readable medium comprising computer software of claim 2, wherein the contestant management module is further configured to collect receive and manage contestant selections of and changes to selections of one or more team captain, wild card or MVP roles for one or more of the plurality of selected competitors, which multiplies a fantasy points tally contributed by the one or more team captain, wild card or MVP competitors by factor of two or more.

4. The non-transitory computer-readable medium comprising computer software of claim 2, wherein the contestant management module is further configured to collect receive and manage contestant selections of and changes to selections of one or more competitor selections for the fantasy contest lineup or roster.

5. The non-transitory computer-readable medium comprising computer software of claim 4, wherein the contestant fantasy contest lineup or roster immediately upon receipt of confirmation of the lineup or roster competitor selections from the contestant.

6. The non-transitory computer-readable medium comprising computer software of claim 1, wherein the contest entry fee module is further configured to process a payment of one or more of money, credits or points from a user account in order to allow entry of the user into the contest as a contestant.

7. The non-transitory computer-readable medium comprising computer software of claim 1, wherein the competitor performance module is further configured to obtain a set of performance metrics results for the plurality of selected competitors from two or more independent sources of competitor performance metrics information.

8. The non-transitory computer-readable medium comprising computer software of claim 1, wherein the contest management module further monitors a total amount of entry fees submitted against any individual house lineup or roster and retires any lineup that exceeds a set threshold.

9. The non-transitory computer-readable medium comprising computer software of claim 8, wherein the contest management module further automatically generates a new house lineup to replace a retired house lineup.

10. The non-transitory computer-readable medium comprising computer software of claim 1, wherein the contest management module sets the number of contestants to be one and the number of contest rounds to be one.

11. A method, implemented by computer software, for establishing and operating a fantasy sports fantasy contest application and platform, the software application comprised of computer readable instructions, wherein the computer readable instructions, when executed on one or more computer processors, in conjunction with one or more non-transitory computer-readable media storage memories, bus elements, network connections and user interfaces, cause the software application to perform the process, comprising the steps of:
establishing, operating and maintaining one or more fantasy contests, where each fantasy contest includes one or more contestants, one or more contests, each associated with a plurality of real-world competitors scheduled to compete in a set of real-world competition events, and up to one or more contestant winners of the one or more contests, wherein contestant winners have a fantasy score that beats the fantasy score of the house in a given contest;
establishing, or creating and initializing, the one or more fantasy contests, inclusive of specifying and setting one or more fantasy contest parameters, such as competition category, number of contest rounds, and amount of contest entry fee;
entering contestants into the one or more fantasy contests and managing contestant profiles, preferences and default settings;
establishing, or creating and initializing, a plurality of contestant user accounts and associating one user account with each contestant of the plurality of contestants;
managing the plurality of user accounts associated with contestants in one or more fantasy contests, including maintaining account balances for all user accounts associated with the plurality of contestants, and crediting and deducting amounts from the user account balances based on wagers and contest winners determined for a fantasy contest;
collecting, receiving and managing the contest wager or entry fee and contestant selection of and changes to selections of one or more competitors selected for a given fantasy contest by each of the plurality of contestants, and wherein once the set of real-world competition events begins, the competitor selections made by the plurality of contestants are locked;
obtaining a set of performance metrics results for the plurality of selected competitors from sources of competitor performance metrics information; and
identifying sets of one or more contestant contest winners upon conclusion of a respective contest, by reviewing and comparing sets of performance metrics results provided the plurality of selected competitors, and determining one or more sets of contestant winners based on the contestant winners having a fantasy score higher than the house fantasy score for the given contest; and
paying out on wagers to one or more contestants of the plurality of contestants comprising contestant contest winners.

12. The method of claim 11, further performing the step of collecting, receiving and managing contestant selection of and changes to selection of one or more sports teams, from which the contestant selects one or more competitors to be included in a contestant fantasy sports team roster.

13. The method claim 12, further performing the step of collecting, receiving and managing contestant selections of and changes to selections of one or more team captain, wild card or MVP roles for one or more of the plurality of selected competitors, which multiplies a fantasy points tally contributed by the one or more team captain, wild card or MVP competitors by factor of two or more.

14. The method of claim 12, further performing the step of collecting, receiving and managing contestant selection of and changes to selection of one or more competitor selections for the fantasy contest lineup or roster.

15. The method of claim 14, further performing the step of locking the contestant fantasy contest lineup or roster immediately upon receipt of confirmation of the lineup or roster competitor selections from the contestant.

16. The method of claim 11, further performing the step of processing a payment of one or more of money, credits or points from a user account via the entry fee module in order to allow entry of the user into the contest as a contestant.

17. The method of claim 11, further performing the step of obtaining a set of performance metrics results for the plurality of selected competitors from two or more independent sources of competitor performance metrics information via the performance metrics module.

18. The method of claim 11, further performs the steps of monitoring a total amount of entry fees submitted against any individual house lineup or roster and retiring any lineup that exceeds a set threshold.

19. The method of claim 18, further performing the step of automatically generating a new house lineup to replace a retired house lineup.

20. The method of claim 11, further performing the step of setting the number of contestants at one and setting the number of contest rounds at one via the contest management module.
